(19) United States
(12) Patent Application Publication
(10) Pub. No.: US 2011/0037246 A1
(43) Pub. Date: Feb. 17, 2011

(54) Devices and Methods for Supporting Printed Matter

(76) Inventors: Rania Nabil El-Sorrogy, Barrington, IL (US); Joshua Lee Harker, Chicago, IL (US)

Correspondence Address: MOAZZAM & ASSOCIATES, LLC, 7601 LEWINSVILLE ROAD, SUITE 304, MCLEAN, VA, 22102, US

(21) Appl. No.: 12/893,947

(22) Filed: Sep. 29, 2010

Related U.S. Application Data
(63) Continuation-in-part of application No. 12/255,582, filed on Oct. 21, 2008.
Application No. 12/255,582 is a continuation-in-part of application No. 12/255,593, filed on Oct. 21, 2008.
Application No. 12/255,593 is a continuation-in-part of application No. 11/797,100, filed on Apr. 30, 2007, now Pat. No. 7,744,128.
Application No. 12/255,582 is a continuation-in-part of application No. 11/797,100, filed on Apr. 30, 2007, now Pat. No. 7,744,128.
(60) Provisional application No. 61/247,382, filed on Sep. 30, 2009.
(60) Provisional application No. 60/796,167, filed on Apr. 28, 2006.

(51) Int. Cl. B42D 1/06; B42C 11/04; B42C 99/00

(52) U.S. Cl. 281/21.1; 412/33; 412/6

(57) ABSTRACT

A book block and/or set of print matter is contemplated to be bound in individual sections through various techniques. These sections will be unbound or stitched to section covers or glued to section covers. These sections will then be augmented with attachment members to allow sections to be secured to each other or a book cover. These attachment members may be secured to the sections through a permanent or non-permanent manner, ranging including tension and/or clamping and/or crimping and/or sewing/stitching and/or gluing. The user of the book will then be allowed to select and detach individual sections of the book block or set of print matter without destroying the integrity of the entire book block or set of print matter. Likewise, publishers of the book are now able to update and/or replace sections of an entire book block and/or print matter without needing to reprint and republish the whole book or set of print matter.

This U.S. patent application claims priority to U.S. Provisional Patent Application Ser. No. 61/247,382, filed Sep. 30, 2009; and is a continuation-in-part of U.S. patent application Ser. No. 12/255,582, filed Oct. 21, 2008; and is a continuation-in-part of U.S. patent application Ser. No. 12/255,593, filed Oct. 21, 2008; both of which are continuations-in-part of U.S. patent application Ser. No. 11,797,100, now U.S. Pat. No. 7,744,128, which claims priority to U.S. Provisional Patent Application Ser. No. 60/796,167, filed Apr. 28, 2006; the contents of all of which are hereby incorporated by reference herein in their entirety into this disclosure.

### BACKGROUND OF THE INVENTION

1. Field of the Invention

The present invention relates to supporting of printed matter. In particular, the present invention relates to the support of various reading and/or viewing printed material including books, brochures, catalogs and the like.

2. Background of the Invention

As the volume of literature increases, additional costs are associated with the manufacture of printed material, including books, brochures, catalogs, magazines, and the like. Some of this printed matter becomes very large or heavy, particularly because of their tremendous volume or size. Despite the advancement of literature and information, conventional methods of manufacture in the art of bookbinding have been relatively constant and have essentially been limited to (i) case binding and (ii) perfect binding. Traditional Smyth sewn books require a series of arranging, sewing, and gluing steps to adhere signatures (sections of the entire book) to the cover spine. Typically, textbooks and other large-mass books employ the Smyth sewn binding technique.

Perfect bound books mainly require an adhesive binding between the book block and the cover. After the technological booms following World War II, perfect binding became an economical option for many publishers, making it a common practice in contemporary times. Nearly all paperback books, telephone books, and other small-mass books are bound using the perfect binding technique.

Large-mass books are typically perfect bound or bound using the Smyth sewn technique. Many of these large-mass books are published in the form of textbooks or trade books for school students. Such large and heavy books take their toll on those who have to carry these books on a daily or regular basis, typically students. The American Chiropractic Association (ACA) and the American Occupational Therapy Association (AOTA) states that children should not carry more than 10% of their bodyweight. Researchers have found, however, that children are carrying 22% of their bodyweight in studies conducted in the United States.

The National Safety Council states that according to the US Consumer Product Safety Commission there were more than 21,000 backpack related injuries that ended up being treated in emergency rooms, clinics and doctors' offices in 2003. The range of these injuries was widespread from contusions, to sprains, and even fractures.

The American Chiropractic Association states in an August 2010 article that children have the same rate of back pain as full grown adults by the time they have reached just 14 years of age. This can cause chronic and long-term injury to the current and future generations of school children.

Some subject matters require new versions of texts in order to account for changes that took place after the initial publication of the book. Using bookbinding methods of the art, the entire text is replaced when revisions are made to a sufficient number of sections. Some fields, such as legal texts, use “pocket parts,” which are smaller independent sections showing only the changes; but the main body of text is unchanged, and both the main body of text and the pocket part must be referenced in order to read the actual updated text. Using existing techniques of the art, there is no other way to replace merely a section of the book.

Thus, there is a need in the art for a more effective technique for manufacturing printed matter such that portions of the printed matter may be carried independently of the other portions, and allowed to be changed, revised or replaced without having to do so for the entire volume in which such portion is a part. The technique should be simple to understand, use and manufacture so that it provides an efficient and less costly alternative to constant volume changes and/or provides an efficient method of carrying just one portion of a large size or volume printed matter.

### SUMMARY OF THE INVENTION

The present invention provides a unique technique of assembling, organizing and/or manufacturing bound or unbound print matter such that such matter may be easily taken apart into defined portions and each portion carried or reviewed independently of the other. Though examples throughout this application may focus on particular types of printed matter for sake of simplicity, it should be known that the techniques disclosed here are applicable to all types of matter having multiple portions as would be evident to one having ordinary skill in the art after consideration of the present disclosure. Each such portion can also be independently updated or revised without affecting the other portions of the matter that have not been changed. The present invention overcomes many disadvantages associated with conventional bookbinding and manufacturing techniques by using a novel and simple technique of combining interlocking components that comprise sections of a reading material, such as a book. Book users need not transport the entirety of a book when they only desire to focus on one chapter or section of the book. With the present invention, the book user can select the portion(s) of the book she would like to carry with her. Likewise, book publishers need not reprint the entirety of a book when they desire to alter select chapters or sections of the book. With the present invention, the book publisher can select portion(s) of the book that it would like to update, reprint, and sell. Such technique is more advantageous to the publisher, because only certain portions of a, for example, textbook are revised and the cost of printing is limited to those particular portions, such as a chapter. That individual portion can then be sold at a substantially reduced rate than having to reprint and sell the entire textbook. Such high costs of having to re-publish an entire book also prevent many buyers from purchasing new versions because of the lack of substantial difference from older versions of the same textbook. Thus, with the present technique, the publishers can realize higher sales of relevant portions of a textbook because consumers are more apt to purchase those portions of a textbook that are updated rather than an entirely reprinted new textbook.

Using techniques presented herein and according to the present invention, portions or sections of a book will be individually bound, such as, but not limited to, a perfect binding method. These smaller sections of the whole textbook could be gathered under a book cover. The force used for attraction between the sections and the book cover would be strong enough to keep the entire book block together, when this is the desired use. The sections can also be detached from the book cover and carried separately. A few examples of forces used for attaching the detachable sections include magnetic and mechanical techniques.

For sake of simplicity, exemplary techniques that may be used in conjunction with the present invention have been presented in various groups of embodiments. Also, for sake of simplicity, the various embodiments are presented with use of a “book” for sake of simplicity. However, the present invention and techniques are equally applicable to other forms of printed and bound and unbound matter, including but not limited to, magazines, directories, newspapers, brochures, photographic albums, reports, and the like. In a non-limiting example of unbound material, techniques disclosed in the present invention may be used to assemble previously unbound materials into a cohesive unit, as well as serving as binding for different sections of the unbound printed matter. One of ordinary skill in the art would be cognizant of these and other type of printed or photographic matter that could be used by the techniques presented in the present disclosure. All such uses are within the scope of the present invention.

The mechanical embodiments explained in the present invention provide mechanical methods of fastening the sections to the book cover or fastening the book sections to one another. Examples of mechanically-attaching mechanisms include but are not limited to a series of interlocking male and female elements, such as a hook-and-slot mechanism. Many other mechanical binding devices may be used and such other devices are apparent to one having ordinary skill in the art and thereby within the scope of the present invention.

The sections (or chapters) of a sectional book constructed using the mechanical method can be mechanically-adhered to the book cover or each other, so that each section may be independently separated from the entire book block. Thus, sections of the book can be individually bound, and the book cover and/or section covers can include at least one mechanically-attaching member.

The present invention has many uses and advantages as would be apparent to one having ordinary skill in the art after consideration of the present disclosure. Exemplary non-limiting uses and advantages over conventional techniques include, but are not limited to: providing a convenient way for users to select which portions of a book to carry with them; providing a reduction in overall weight carried by the user in the forms of books; providing a way for reducing back-related injuries due to carrying heavy books; providing book publishers a way to update portions of the book without need to reprint the entire book; providing book publishers a way to reduce their overall cost of production for new and/or updated versions of books.

### BRIEF DESCRIPTION OF THE DRAWINGS

FIG. 1A shows a perspective view of hook-and-slot mechanism between section members, with at least one flexible hook element along the section member's spine and at least one complimentary durable slotted rod element along another section member, according to an exemplary embodiment of the present invention.

FIG. 1B shows a close-up view of the attachment mechanism in FIG. 1A.

FIG. 1C shows a close-up on a section member's spine region augmented with a hook-rail and a slot-rail.

FIG. 1D shows an end view of FIG. 1A.

FIG. 2A shows an enlarged view of a modular hook-and-slot mechanism, according to an exemplary embodiment of the present invention.

FIG. 2B shows an end view of FIG. 2A.

FIG. 3A shows an enlarged view of an alternative hook-and-slot mechanism, according to an exemplary embodiment of the present invention.

FIG. 3B shows an end view of FIG. 3A.

FIG. 4A shows an enlarged view of an alternative modular hook-and-slot mechanism, according to an exemplary embodiment of the present invention.

FIG. 4B shows an end view of FIG. 4A.

FIG. 5A shows an enlarged view of an alternative hook-and-slot mechanism, according to an exemplary embodiment of the present invention.

FIG. 5B shows an end view of FIG. 5A.

FIG. 6A shows an enlarged view of an alternative modular hook-and-slot mechanism, according to an exemplary embodiment of the present invention.

FIG. 6B shows an end view of FIG. 6A.

FIG. 7A shows an enlarged view of an alternative hook-and-slot mechanism, according to an exemplary embodiment of the present invention.

FIG. 7B shows an end view of FIG. 7A.

FIG. 8A shows a modular hook-and-slot mechanism, according to an exemplary embodiment of the present invention.

FIG. 8B shows an end view of FIG. 8A.

FIG. 9A shows a perspective view of sliding hook-and-slot mechanism between section members, with at least one flexible hook element along the section member's spine and at least one complimentary durable slotted rod element along another section member, according to an exemplary embodiment of the present invention.

FIG. 9B shows a close-up view of the attachment mechanism in FIG. 9A.

FIG. 9C shows a close-up on a section member's spine region augmented with a sliding hook-rail and a slot-rail.

FIG. 9D shows an end view of FIG. 9A.

FIG. 10A shows an enlarged view of an alternative modular sliding hook-and-slot mechanism, according to an exemplary embodiment of the present invention.

FIG. 10B shows an end view of FIG. 10A.

FIG. 11A shows an enlarged view of an alternative sliding hook-and-slot mechanism, according to an exemplary embodiment of the present invention.

FIG. 11B shows an end view of FIG. 11A.

FIG. 12A shows an enlarged view of a modular sliding hook-and-slot mechanism, according to an exemplary embodiment of the present invention.

FIG. 12B shows an end view of FIG. 12A.

FIG. 13A shows an enlarged view of an alternative sliding hook-and-slot mechanism with a stopper element, according to an exemplary embodiment of the present invention.

FIG. 13B shows an end view of FIG. 13A.

FIG. 13C shows a top view of FIG. 13A.

FIG. 14A shows an enlarged view of an alternative modular sliding hook-and-slot mechanism with a stopper element, according to an exemplary embodiment of the present invention.

FIG. 14B shows an end view of FIG. 14A.

FIG. 14C shows a top view of FIG. 14A.

FIG. 15A shows an enlarged view of an alternative sliding hook-and-slot mechanism with a stopper element, according to an exemplary embodiment of the present invention.

FIG. 15B shows an end view of FIG. 15A.

FIG. 15C shows a top view of FIG. 15A.

FIG. 16A shows an enlarged view of an alternative modular sliding hook-and-slot mechanism with a stopper element, according to an exemplary embodiment of the present invention.

FIG. 16B shows an end view of FIG. 16A.

FIG. 16C shows a top view of FIG. 16A.

FIG. 17A shows a perspective view of a hook-and-slot mechanism between a section member and book cover, with at least one hook-like element along the section member's spine and at least one complimentary slotted element along the book cover, according to an exemplary embodiment of the present invention.

FIG. 17B depicts enlarged view of FIG. 17A, with a focus on the connecting mechanism between section member and book cover.

FIG. 17C shows an end view of FIG. 17A.

FIG. 18A shows a perspective view of an alternative hook-and-slot mechanism between a section member and book cover, with at least one hook-like element along the section member's spine and at least one complimentary slotted element along the book cover, according to an exemplary embodiment of the present invention.

FIG. 18B shows and end view of FIG. 18A.

FIG. 19A shows an enlarged perspective view of a hook-and-slot mechanism with stopper element between a section member and book cover, with at least one hook-like element along the section member's spine and at least one complimentary slotted element along the book cover, according to an exemplary embodiment of the present invention.

FIG. 19B shows an end view of FIG. 19A.

FIG. 19C shows a top view of FIG. 19A.

FIG. 20A shows an enlarged perspective view of an alternative hook-and-slot mechanism with stopper element between a section member and book cover, with at least one hook-like element along the section member's spine and at least one complimentary slotted element along the book cover, according to an exemplary embodiment of the present invention.

FIG. 20B shows an end view of FIG. 20A.

FIG. 20C shows a top view of FIG. 20A.

FIG. 21A shows a perspective view of a hook-and-slot mechanism between a booklet member and book cover, with at least one hook-like element along the booklet member's spine and at least one complimentary slotted element along the book cover, according to an exemplary embodiment of the present invention.

FIG. 21B depicts enlarged view of FIG. 21A, with a focus on the connecting mechanism between section member and book cover, according to an exemplary embodiment of the present invention.

FIG. 21C shows an enlarged perspective view of FIG. 21A.

FIG. 21D shows an enlarged perspective view of FIG. 21B, with a focus on the attaching elements.

FIG. 21E shows an end view of FIG. 21A.

FIG. 21F shows a top view of FIG. 21A.

FIG. 22A shows an enlarged perspective view of an alternative hook-and-slot mechanism between booklet member and book cover, with a focus on the attaching mechanism, according to an exemplary embodiment of the present invention.

FIG. 22B shows an end view of FIG. 22A.

FIG. 22C shows a top view of FIG. 22A.

FIG. 23A shows an enlarged perspective view of an alternative sliding hook-and-slot mechanism with stopper element between booklet member and book cover, with a focus on the attaching mechanism, according to an exemplary embodiment of the present invention.

FIG. 23B shows an end view of FIG. 23A.

FIG. 23C shows a top view of FIG. 23A.

FIG. 24A shows an enlarged perspective view of an alternative sliding hook-and-slot mechanism with stopper element between booklet member and book cover, with a focus on the attaching elements, according to an exemplary embodiment of the present invention.

FIG. 24B shows an end view of FIG. 24A.

FIG. 24C shows a top view of FIG. 24A.

FIG. 25A shows a perspective view of a hook-and-slot mechanism between spiral- or stitch-bound members, with at least one hook-like element along the stitch-bound member's spine region and at least one complimentary slotted element along another stitch-bound member's spine region, according to an exemplary embodiment of the present invention.

FIG. 25B depicts enlarged view of FIG. 25A, with a focus on the connecting mechanism between section member and book cover.

FIG. 25C shows an enlarged perspective view of FIG. 25A, with a focus on the attaching elements.

FIG. 25D shows an end view of FIG. 25A.

FIG. 25E shows a top view of FIG. 25A.

FIG. 26A shows an enlarged view of an alternative hook-and-slot mechanism between stitch-bound members, with a focus on the attaching elements, according to an exemplary embodiment of the present invention.

FIG. 26B shows an end view of FIG. 26A.

FIG. 26C shows a top view of FIG. 26A.

FIG. 27A shows an enlarged view of an alternative sliding hook-and-slot mechanism between stitch-bound members, with a focus on the attaching elements, according to an exemplary embodiment of the present invention.

FIG. 27B shows an end view of FIG. 27A.

FIG. 27C shows a top view of FIG. 27A.

FIG. 28A shows an enlarged view of an alternative sliding hook-and-slot mechanism with stopper element between stitch-bound members, with a focus on the attaching elements, according to an exemplary embodiment of the present invention.

FIG. 28B shows an end view of FIG. 28A.

FIG. 28C shows a top view of FIG. 28A.

FIG. 29A shows a perspective view of a hook-and-slot mechanism between unbound print members, with at least one hook-like element along a set of unbound print member's spine region and at least one complimentary slotted element along another unbound print member's spine region, according to an exemplary embodiment of the present invention.

FIG. 29B depicts enlarged view of FIG. 29A, with a focus on the connecting mechanism between section member and book cover, according to an exemplary embodiment of the present invention.

FIG. 29C shows an enlarged perspective view of FIG. 29A, with a focus on the attaching elements.

FIG. 29D shows an end view of FIG. 29A.

FIG. 30A shows an enlarged view of an alternative hook-and-slot mechanism between unbound print members, with a focus on the attaching elements, according to an exemplary embodiment of the present invention.

FIG. 30B shows an end view of FIG. 30A.

FIG. 31A shows an enlarged perspective view of an alternative sliding hook-and-slot mechanism between unbound print members, with a focus on the attaching mechanism, according to an exemplary embodiment of the present invention.

FIG. 31B shows an enlarged view of an alternative hook-and-slot mechanism between unbound print members, with a focus on the attaching elements. In this embodiment, the hooks are facing an alternative direction.

FIG. 31C shows an end view of FIG. 31A.

FIG. 32A shows an enlarged view of an alternative sliding hook-and-slot mechanism with stopper element between unbound print members, with a focus on the attaching elements, according to an exemplary embodiment of the present invention.

FIG. 32B shows an end view of FIG. 32A.

FIG. 32B shows a top view of FIG. 32A.

FIG. 33A shows a perspective view of a hook-and-slot mechanism with tension hinge between unbound print members, with at least one hook-like element along a set of unbound print member's spine region and at least one complimentary slotted element along another unbound print member's spine region, according to an exemplary embodiment of the present invention.

FIG. 33B shows an end view of FIG. 33A.

FIG. 33C shows an end view of FIG. 33A wherein the attachment member is hinged to an open position.

FIG. 34A shows an enlarged view of an alternative hook-and-slot mechanism with tension hinge between unbound print members, with a focus on the attaching elements, according to an exemplary embodiment of the present invention.

FIG. 34B shows an end view of FIG. 34A.

FIG. 34C shows an end view of FIG. 34A wherein the attachment member is hinged to an open position.

FIG. 35A shows an enlarged view of an alternative sliding hook-and-slot mechanism with tension hinge between unbound print members, with a focus on the attaching elements, according to an exemplary embodiment of the present invention.

FIG. 35B shows an end view of FIG. 35A.

FIG. 35C shows an end view of FIG. 35A wherein the attachment member is hinged to an open position.

FIG. 36A shows an enlarged view of an alternative sliding hook-and-slot mechanism with stopper element and tension hinge between unbound print members, with a focus on the attaching elements, according to an exemplary embodiment of the present invention.

FIG. 36B shows an end view of FIG. 36A.

FIG. 36C shows an end view of FIG. 36A wherein the attachment member is hinged to an open position.

### DETAILED DESCRIPTION OF THE INVENTION

As disclosed in the present description and accompanying drawings, the present invention provides for manufacture, sale, and use of a print and/or paper matter incorporating reversibly detachable sections.

To assist in the consideration of the present disclosure and accompanying drawings, the following labels have been used and are generally presented here and described in more detail below:
10A: Book cover
11A: Cover of book cover
12A: Alternative cover of book cover
15A: Spine region of book cover
30 A, B: Section member
31 A, B: Cover of section member
32 A, B: Alternative cover of section member
35 A, B: Spine region of section member
40A: Booklet member
41 A, B: Cover of booklet member
42 A, B: Alternative cover of booklet member
45 A, B: Spine region of booklet member
46 A, B: Cylindrical rod element
47 A, B: Complimentary capturing element for cylindrical rod element
48 A, B: Attaching hinge between cylindrical rod element and attaching member
50A, B: Stitch-bound member
51 A, B: Cover of stitch-bound member
52 A, B: Alternative cover of stitch-bound print member
55 A, B: Spine region of stitch-bound member
56 A, B: Cylindrical rod element
57 A, B: Complimentary capturing element for cylindrical rod element
58 A, B: Stitches of stitch-bound members
59 A, B: Attaching hinge between cylindrical rod element and attaching member
60A, B: Unbound print member
61 A, B: Cover of unbound print member
62 A, B: Alternative cover of unbound print member
65 A, B: Spine region of unbound print member
70A, B: Tension hinge
71 A, B: Wing of tension hinge
300 A, B: Slotted-rod rail member
301 A, B: Spine-facing support leg for slotted-rod rail member
303 A, B: Protruding, rod-like element of slotted rod rail member
304 A, B: Slots along slotted rod rail member
306 A, B: Cylindrical end element of slotted rod rail member
400 A, B: Hooked rail member
401 A, B: Spine-facing support leg for hooked rail member
404 A, B: Hooks (upward facing) along hooked rail member
310 A, B: Modular slotted rod rail member
311 A, B: Spine-facing support leg for slotted rod rail member
313 A, B: Protruding, rod-like element of modular slotted rod rail member
314 A, B: Slots along modular slotted rod rail member
315 A, B: Breaks along modular slotted rail for reattaching and/or detaching part of rail from the whole
316 A, B: Cylindrical end element of modular slotted rod rail member
410 A, B: Modular hooked rail member
411 A, B: Spine-facing support leg for modular hooked rail member
414 A, B: Hooks (upward facing) along modular hooked rail member
415 A, B: Breaks along modular hooked rail for reattaching and/or detaching part of rail from the whole
320 A, B: Alternative slotted rod rail member
321 A, B: Spine-facing support leg for alternative slotted rod rail member
322 A, B: Cover-facing support leg for alternative slotted rod rail member
323 A, B: Protruding, rod-like element of alternative slotted rod rail member
324 A, B: Slots along alternative slotted rod rail member
326 A, B: Cylindrical end element of alternative slotted rod rail member
420 A, B: Hooked rail member
421 A, B: Support leg for alternative hooked rail member
422 A, B: Cover-facing support leg for alternative hooked rail member
424 A, B: Hooks (upward facing) along alternative hooked rail member
330 A, B: Alternative modular slotted rod rail member
331 A, B: Spine-facing support leg for alternative modular slotted rod rail member
321 A, B: Cover-facing support leg for alternative modular slotted rod rail member
333 A, B: Protruding, rod-like element of alternative modular slotted rod rail member
334 A, B: Slots along alternative modular slotted rod rail member
335 A, B: Breaks along alternative modular slotted rail for reattaching and/or detaching part of rail from the whole
336 A, B: Cylindrical end element of alternative modular slotted rod rail member
430 A, B: Alternative modular hooked rail member
431 A, B: Spine-facing support leg for modular hooked rail member
422 A, B: Cover-facing support leg for alternative modular hooked rail member
434 A, B: Hooks (upward facing) along alternative modular hooked rail member
435 A, B: Breaks along modular hooked rail for reattaching and/or detaching part of rail from the whole
340 A, B: Alternative slotted rod rail member
341 A, B: Spine-facing support leg for alternative slotted rod rail member
343 A, B: Protruding, rod-like element of slotted rod rail member
344 A, B: Slots along alternative slotted rod rail member
346 A, B: Cylindrical end element of alternative slotted rod rail member
440 A, B: Alternative hooked rail member
441 A, B: Spine-facing support leg for alternative hooked rail member
444 A, B: Hooks (downward facing) along hooked rail member
340 A, B: Alternative modular slotted rod rail member
341 A, B: Spine-facing support leg for alternative modular slotted rod rail member
353 A, B: Protruding, rod-like element of alternative modular slotted rod rail member
354 A, B: Slots along alternative modular slotted rod rail member
355 A, B: Breaks along alternative modular slotted rail for reattaching and/or detaching part of rail from the whole
356 A, B: Cylindrical end element of alternative modular slotted rod rail member
450 A, B: Alternative modular hooked rail member
451 A, B: Spine-facing support leg for alternative modular hooked rail member
454 A, B: Hooks (downward facing) along alternative modular hooked rail member
455 A, B: Breaks along alternative modular hooked rail for reattaching and/or detaching part of rail from the whole
360 A, B: Alternative slotted rod rail member
361 A, B: Spine-facing support leg for alternative slotted rod rail member
362 A, B: Cover-facing support leg for alternative slotted rod rail member
363 A, B: Protruding, rod-like element of alternative slotted rod rail member
364 A, B: Slots along alternative slotted rod rail member
366 A, B: Cylindrical end element of alternative slotted rod rail member
460 A, B: Hooked rail member
461 A, B: Support leg for alternative hooked rail member
462 A, B: Cover-facing support leg for alternative hooked rail member
464 A, B: Hooks (downward facing) along alternative hooked rail member
370 A, B: Alternative modular slotted rod rail member
371 A, B: Spine-facing support leg for alternative modular slotted rod rail member
371 A, B: Cover-facing support leg for alternative modular slotted rod rail member
373 A, B: Protruding, rod-like element of alternative modular slotted rod rail member
374 A, B: Slots along alternative modular slotted rod rail member
375 A, B: Breaks along alternative modular slotted rail for reattaching and/or detaching part of rail from the whole
376 A, B: Cylindrical end element of alternative modular slotted rod rail member
470 A, B: Alternative modular hooked rail member
471 A, B: Spine-facing support leg for modular hooked rail member
472 A, B: Cover-facing support leg for alternative modular hooked rail member
474 A, B: Hooks (downward facing) along alternative modular hooked rail member
475 A, B: Breaks along modular hooked rail for reattaching and/or detaching part of rail from the whole
380 A, B: Alternative slotted rod rail member
381 A, B: Spine-facing support leg for alternative slotted rod rail member
383 A, B: Protruding, rod-like element of slotted rod rail member
384 A, B: Slots along alternative slotted rod rail member
386 A, B: Cylindrical end element of alternative slotted rod rail member
480 A, B: Alternative hooked rail member
481 A, B: Spine-facing support leg for alternative hooked rail member
484 A, B: Hooks (extended and downward facing) along hooked rail member
390 A, B: Alternative modular slotted rod rail member
391 A, B: Spine-facing support leg for alternative modular slotted rod rail member
393 A, B: Protruding, rod-like element of alternative modular slotted rod rail member
394 A, B: Slots along alternative modular slotted rod rail member
395 A, B: Breaks along alternative modular slotted rail for reattaching and/or detaching part of rail from the whole
396 A, B: Cylindrical end element of alternative modular slotted rod rail member
490 A, B: Alternative modular hooked rail member
491 A, B: Spine-facing support leg for alternative modular hooked rail member
494 A, B: Hooks (extended and downward facing) along alternative modular hooked rail member
495 A, B: Breaks along alternative modular hooked rail for reattaching and/or detaching part of rail from the whole
500 A, B: Alternative slotted rod rail member
501 A, B: Spine-facing support leg for alternative slotted rod rail member
502 A, B: Cover-facing support leg for alternative slotted rod rail member
503 A, B: Protruding, rod-like element of alternative slotted rod rail member
504 A, B: Slots along alternative slotted rod rail member
506 A, B: Cylindrical end element of alternative slotted rod rail member
600 A, B: Hooked rail member
601 A, B: Support leg for alternative hooked rail member
602 A, B: Cover-facing support leg for alternative hooked rail member
604 A, B: Hooks (extended and downward facing) along alternative hooked rail member
510 A, B: Alternative modular slotted rod rail member
511 A, B: Spine-facing support leg for alternative modular slotted rod rail member
511 A, B: Cover-facing support leg for alternative modular slotted rod rail member
513 A, B: Protruding, rod-like element of alternative modular slotted rod rail member
514 A, B: Slots along alternative modular slotted rod rail member
515 A, B: Breaks along alternative modular slotted rail for reattaching and/or detaching part of rail from the whole
516 A, B: Cylindrical end element of alternative modular slotted rod rail member
610 A, B: Alternative modular hooked rail member
611 A, B: Spine-facing support leg for modular hooked rail member
612 A, B: Cover-facing support leg for alternative modular hooked rail member
614 A, B: Hooks (extended and downward facing) along alternative modular hooked rail member
615 A, B: Breaks along alternative modular hooked rail for reattaching and/or detaching part of rail from the whole
520 A, B: Alternative slotted rod rail member
521 A, B: Spine-facing support leg for alternative slotted rod rail member
523 A, B: Protruding, rod-like element of slotted rod rail member
524 A, B: Slots along alternative slotted rod rail member
526 A, B: Cylindrical end element of alternative slotted rod rail member
528 A, B: Ball-like element along cylindrical end element of alternative slotted rod rail member
620 A, B: Alternative hooked rail member
621 A, B: Spine-facing support leg for alternative hooked rail member
624 A, B: Hooks (extended downward facing) along hooked rail member
628 A, B: Tension hook element along hooked rail member
530 A, B: Alternative modular slotted rod rail member
531 A, B: Spine-facing support leg for alternative modular slotted rod rail member
533 A, B: Protruding, rod-like element of alternative modular slotted rod rail member
534 A, B: Slots along alternative modular slotted rod rail member
535 A, B: Breaks along alternative modular slotted rail for reattaching and/or detaching part of rail from the whole
536 A, B: Cylindrical end element of alternative modular slotted rod rail member
538 A, B: Ball-like element along cylindrical end element of alternative slotted rod rail member
630 A, B: Alternative modular hooked rail member
631 A, B: Spine-facing support leg for alternative modular hooked rail member
634 A, B: Hooks (extended downward facing) along alternative modular hooked rail member
635 A, B: Breaks along alternative modular hooked rail for reattaching and/or detaching part of rail from the whole
638 A, B: Tension hook element along hooked rail member
540 A, B: Alternative slotted rod rail member
541 A, B: Spine-facing support leg for alternative slotted rod rail member
542 A, B: Cover-facing support leg for alternative slotted rod rail member
543 A, B: Protruding, rod-like element of alternative slotted rod rail member
544 A, B: Slots along alternative slotted rod rail member
546 A, B: Cylindrical end element of alternative slotted rod rail member
548 A, B: Ball-like element along cylindrical end element of alternative slotted rod rail member
640 A, B: Hooked rail member
641 A, B: Support leg for alternative hooked rail member
642 A, B: Cover-facing support leg for alternative hooked rail member
644 A, B: Hooks (extended and downward facing) along alternative hooked rail member
648 A, B: Tension hook element along hooked rail member
550 A, B: Alternative modular slotted rod rail member
551 A, B: Spine-facing support leg for alternative modular slotted rod rail member
552 A, B: Cover-facing support leg for alternative modular slotted rod rail member
553 A, B: Protruding, rod-like element of alternative modular slotted rod rail member
554 A, B: Slots along alternative modular slotted rod rail member
555 A, B: Breaks along alternative modular slotted rail for reattaching and/or detaching part of rail from the whole
556 A, B: Cylindrical end element of alternative modular slotted rod rail member
558 A, B: Ball-like element along cylindrical end element of alternative slotted rod rail member
650 A, B: Alternative modular hooked rail member
651 A, B: Spine-facing support leg for modular hooked rail member
652 A, B: Cover-facing support leg for alternative modular hooked rail member
654 A, B: Hooks (extended and downward facing) along alternative modular hooked rail member
655 A, B: Breaks along alternative modular hooked rail for reattaching and/or detaching part of rail from the whole
658 A, B: Tension hook element along hooked rail member
560 A, B: Alternative slotted rod rail member
563 A, B: Protruding, rod-like element of alternative slotted rod rail member
564 A, B: Slots along alternative slotted rod rail member
566 A, B: Cylindrical end element of alternative slotted rod rail member
660 A, B: Hooked rail member
661 A, B: Support leg for alternative hooked rail member
664 A, B: Hooks along alternative hooked rail member
570 A, B: Alternative slotted rod rail member
571 A, B: Support leg for alternative slotted rod rail member
573 A, B: Protruding, rod-like element of alternative slotted rod rail member
574 A, B: Slots along alternative slotted rod rail member
576 A, B: Cylindrical end element of alternative slotted rod rail member
670 A, B: Hooked rail member
674 A, B: Hooks along alternative hooked rail member
580 A, B: Alternative slotted rod rail member
583 A, B: Protruding, rod-like element of alternative slotted rod rail member
584 A, B: Slots along alternative slotted rod rail member
586 A, B: Cylindrical end element of alternative slotted rod rail member
588 A, B: Ball-like element along cylindrical end element of alternative slotted rod rail member
680 A, B: Hooked rail member
681 A, B: Support leg for alternative hooked rail member
684 A, B: Hooks along alternative hooked rail member
688 A, B: Tension hook element along hooked rail member
590 A, B: Alternative slotted rod rail member
591 A, B: Support leg for alternative slotted rod rail member
593 A, B: Protruding, rod-like element of alternative slotted rod rail member
594 A, B: Slots along alternative slotted rod rail member
596 A, B: Cylindrical end element of alternative slotted rod rail member
598 A, B: Ball-like element along cylindrical end element of alternative slotted rod rail member
690 A, B: Hooked rail member
694 A, B: Hooks along alternative hooked rail member
698 A, B: Tension hook element along hooked rail member
700 A, B: Alternative slotted rod rail member
703 A, B: Protruding, rod-like element of alternative slotted rod rail member
704 A, B: Slots along alternative slotted rod rail member
706 A, B: Cylindrical end element of alternative slotted rod rail member
800 A, B: Hooked rail member
801 A, B: Support leg for alternative hooked rail member
804 A, B: Hooks along alternative hooked rail member
710 A, B: Alternative slotted rod rail member
711 A, B: Support leg for alternative slotted rod rail member
713 A, B: Protruding, rod-like element of alternative slotted rod rail member
714 A, B: Slots along alternative slotted rod rail member
716 A, B: Cylindrical end element of alternative slotted rod rail member
810 A, B: Hooked rail member
814 A, B: Hooks along alternative hooked rail member
810 A, B: Alternative slotted rod rail member
723 A, B: Protruding, rod-like element of alternative slotted rod rail member
724 A, B: Slots along alternative slotted rod rail member
726 A, B: Cylindrical end element of alternative slotted rod rail member
728 A, B: Ball-like element along cylindrical end element of alternative slotted rod rail member
820 A, B: Hooked rail member
821 A, B: Support leg for alternative hooked rail member
824 A, B: Hooks along alternative hooked rail member
828 A, B: Tension hook element along hooked rail member
730 A, B: Alternative slotted rod rail member
731 A, B: Support leg for alternative slotted rod rail member
733 A, B: Protruding, rod-like element of alternative slotted rod rail member
734 A, B: Slots along alternative slotted rod rail member
736 A, B: Cylindrical end element of alternative slotted rod rail member
738 A, B: Ball-like element along cylindrical end element of alternative slotted rod rail member
830 A, B: Hooked rail member
834 A, B: Hooks along alternative hooked rail member
838 A, B: Tension hook element along hooked rail member
742 A, B: Spine-facing support leg for slotted-rod rail member
743 A, B: Protruding, rod-like element of slotted rod rail member
744 A, B: Slots along slotted rod rail member
746 A, B: Cylindrical end element of slotted rod rail member
841 A, B: Spine-facing support leg for three-walled sleeve
842 A, B: Spine-facing support leg for hooked rail member
844 A, B: Hooks (upward facing) along hooked rail member
752 A, B: Spine-facing support leg for slotted-rod rail member
75 A, B: Protruding, rod-like element of slotted rod rail member
754 A, B: Slots along slotted rod rail member
756 A, B: Cylindrical end element of slotted rod rail member
851 A, B: Spine-facing support leg for three-walled sleeve
852 A, B: Spine-facing support leg for hooked rail member
854 A, B: Hooks (downward facing) along hooked rail member
762 A, B: Spine-facing support leg for slotted-rod rail member
763 A, B: Protruding, rod-like element of slotted rod rail member
764 A, B: Slots along slotted rod rail member
766 A, B: Cylindrical end element of slotted rod rail member
861 A, B: Spine-facing support leg for three-walled sleeve
862 A, B: Spine-facing support leg for hooked rail member
864 A, B: Hooks (extended and downward facing) along hooked rail member
772 A, B: Spine-facing support leg for slotted-rod rail member
773 A, B: Protruding, rod-like element of slotted rod rail member
774 A, B: Slots along slotted rod rail member
776 A, B: Cylindrical end element of slotted rod rail member
778 A, B: Ball-like element along cylindrical end element of alternative slotted rod rail member
871 A, B: Spine-facing support leg for three-walled sleeve
872 A, B: Spine-facing support leg for hooked rail member
874 A, B: Hooks (extended and downward facing) along hooked rail member
878 A, B: Tension hook element along hooked rail member
782 A, B: Spine-facing support leg for slotted-rod rail member
783 A, B: Protruding, rod-like element of slotted rod rail member
784 A, B: Slots along slotted rod rail member
786 A, B: Cylindrical end element of slotted rod rail member
881 A, B: Spine-facing support leg for tension sleeve
882 A, B: Spine-facing support leg for hooked rail member
884 A, B: Hooks (upward facing) along hooked rail member
792 A, B: Spine-facing support leg for slotted-rod rail member
793 A, B: Protruding, rod-like element of slotted rod rail member
794 A, B: Slots along slotted rod rail member
796 A, B: Cylindrical end element of slotted rod rail member
891 A, B: Spine-facing support leg for tension sleeve
892 A, B: Spine-facing support leg for hooked rail member
894 A, B: Hooks (downward facing) along hooked rail member
902 A, B: Spine-facing support leg for slotted-rod rail member
903 A, B: Protruding, rod-like element of slotted rod rail member
904 A, B: Slots along slotted rod rail member
906 A, B: Cylindrical end element of slotted rod rail member
1001 A, B: Spine-facing support leg for tension sleeve
1002 A, B: Spine-facing support leg for hooked rail member
1004 A, B: Hooks (extended and downward facing) along hooked rail member
912 A, B: Spine-facing support leg for slotted-rod rail member
913 A, B: Protruding, rod-like element of slotted rod rail member
914 A, B: Slots along slotted rod rail member
916 A, B: Cylindrical end element of slotted rod rail member
918 A, B: Ball-like element along cylindrical end element of alternative slotted rod rail member
1011 A, B: Spine-facing support leg for tension sleeve
1012 A, B: Spine-facing support leg for hooked rail member
1014 A, B: Hooks (extended and downward facing) along hooked rail member
1018 A, B: Tension hook element along hooked rail member
922 A, B: Spine-facing support leg for slotted-rod rail member
923 A, B: Protruding, rod-like element of slotted rod rail member
924 A, B: Slots along slotted rod rail member
926 A, B: Cylindrical end element of slotted rod rail member
1021 A, B: Spine-facing support leg for hinged tension sleeve
1022 A, B: Spine-facing support leg for hooked rail member
1024 A, B: Hooks (upward facing) along hooked rail member
922 A, B: Spine-facing support leg for slotted-rod rail member
933 A, B: Protruding, rod-like element of slotted rod rail member
934 A, B: Slots along slotted rod rail member
936 A, B: Cylindrical end element of slotted rod rail member
1031 A, B: Spine-facing support leg for hinged tension sleeve
1032 A, B: Spine-facing support leg for hooked rail member
1034 A, B: Hooks (downward facing) along hooked rail member
942 A, B: Spine-facing support leg for slotted-rod rail member
943 A, B: Protruding, rod-like element of slotted rod rail member
944 A, B: Slots along slotted rod rail member
946 A, B: Cylindrical end element of slotted rod rail member
1041 A, B: Spine-facing support leg for hinged tension sleeve
1042 A, B: Spine-facing support leg for hooked rail member
1044 A, B: Hooks (extended and downward facing) along hooked rail member
952 A, B: Spine-facing support leg for slotted-rod rail member
953 A, B: Protruding, rod-like element of slotted rod rail member
954 A, B: Slots along slotted rod rail member
956 A, B: Cylindrical end element of slotted rod rail member
958 A, B: Ball-like element along cylindrical end element of alternative slotted rod rail member
1051 A, B: Spine-facing support leg for hinged tension sleeve
1052 A, B: Spine-facing support leg for hooked rail member
1054 A, B: Hooks (extended and downward facing) along hooked rail member
1058 A, B: Tension hook element along hooked rail member

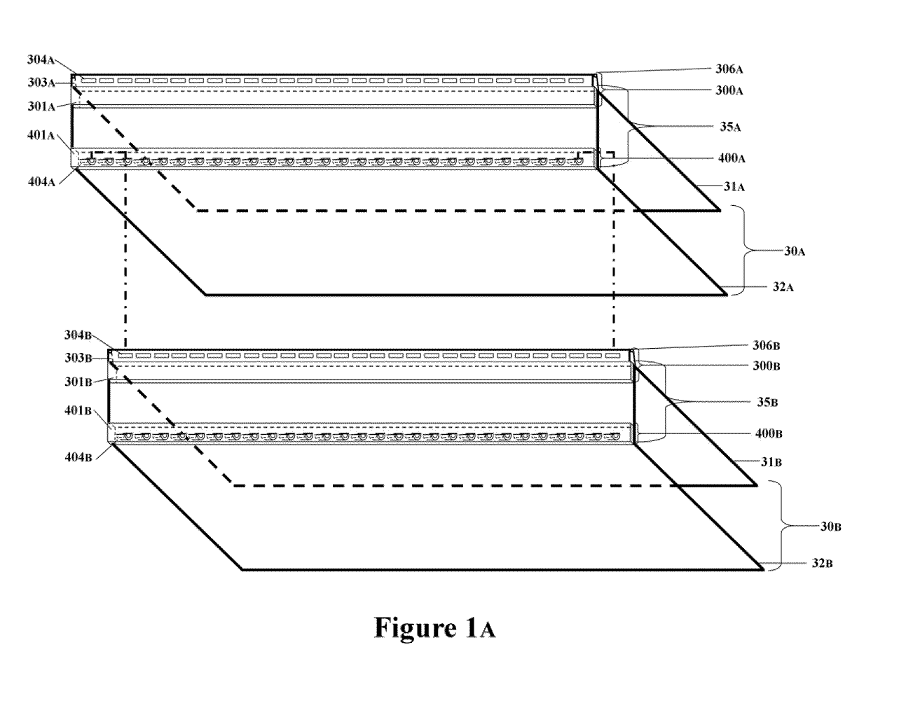

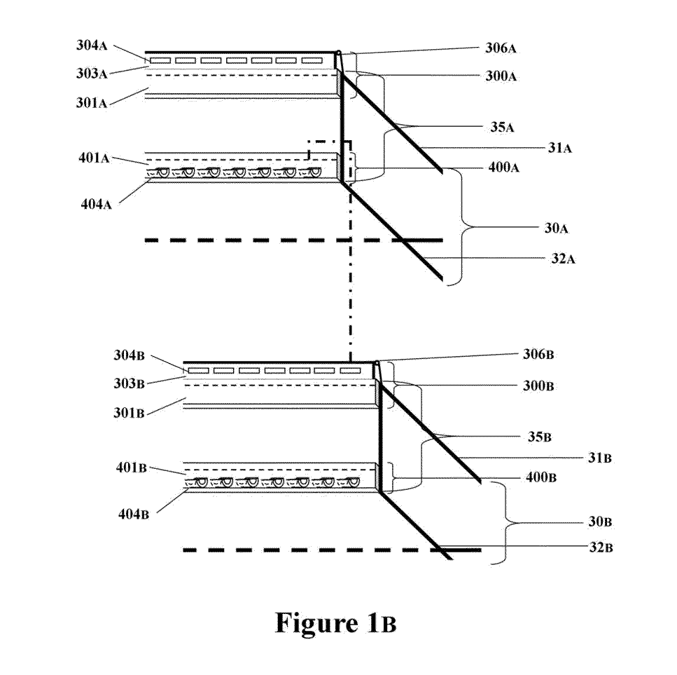

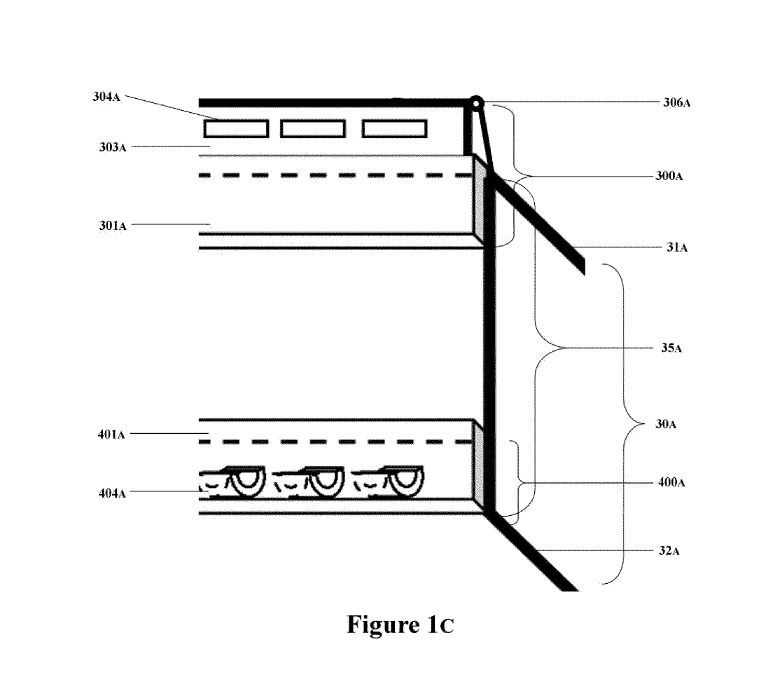

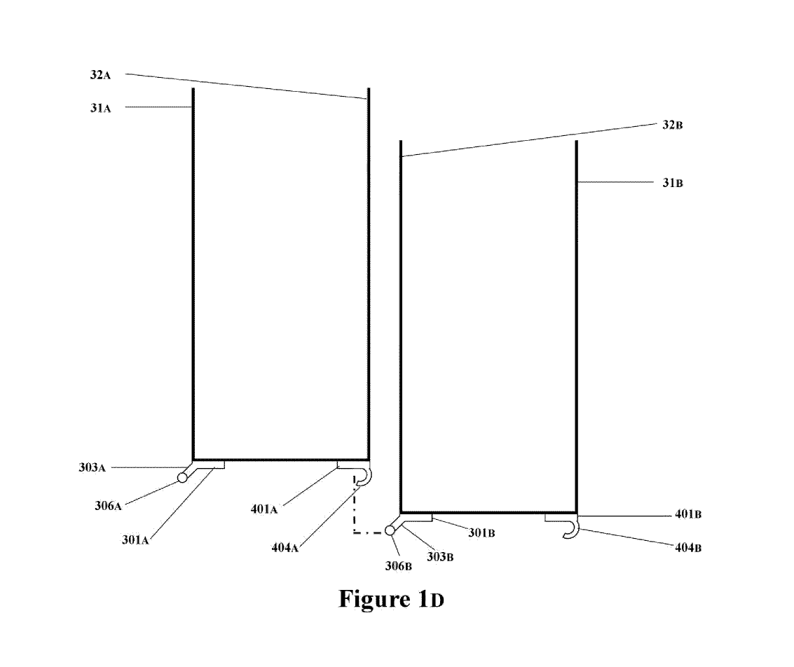

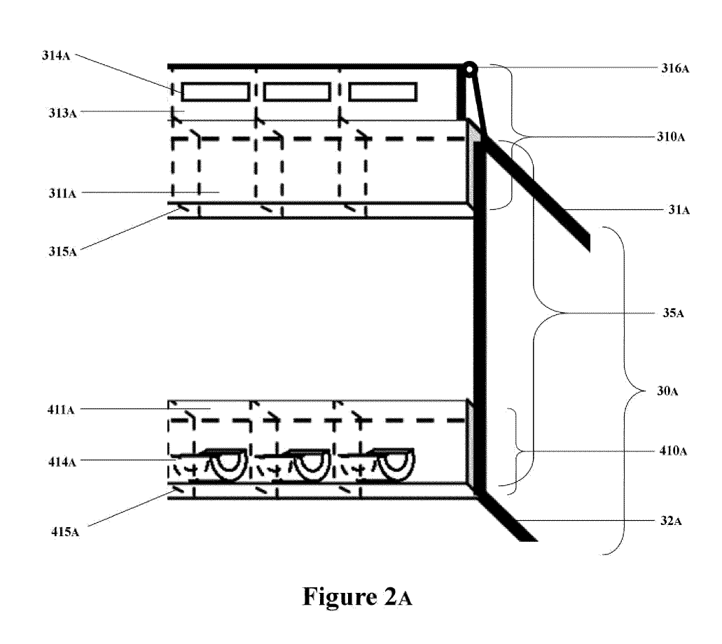

The following is a non-limiting list of exemplary mechanical embodiments of the present invention. For the purpose of this disclosure, the term “module member” includes section member(s), booklet member(s), stitch-bound member(s), and unbound print member(s). Section members 30A and 30B can be attached to the book cover 10 through adjoining members. Section members 30A and 30B can also be attached to each other. For sake of simplicity, many of the drawings present a combination of section members, e.g., 30A and 30B, while only showing section member 30A. It is to be understood in these drawings that a section member 30B may be attached to section member 30A, similar to what is shown and described in FIGS. 1A-1D. Additionally, it is to be understood that the components of section member 30B, such as a spine region 35B of section member 30B, are also present as a complement to those of section member 30A. Further, the description of many of the drawings discusses, for instance, a slot element of section member 30B corresponding to a hook element of section member 30A. Such a slot element is understood to act similar to a slot element shown of section member 30A in receiving a hook element. Additionally, in order to show commonalities between drawings, many of the drawing label features are not specifically discussed with respect to the drawing. These features are commonly numbered as they represent an equivalent feature. One having ordinary skill in the art would recognize and understand each embodiment shown and presented in view of the description presented for other embodiments. Booklet member 40A can be attached to the book cover 10 through adjoining members or any other member with complimentary hook-and-slot elements. Stitch-bound members 50A and 50B can be attached to each other through adjoining members or any other member with complimentary hook and/or slot elements. Unbound print members 60A and 60B can be attached to each other through adjoining members or any other member with complimentary hook and/or slot elements.

Combinations of attaching the section member(s) 30A and/or 30B, booklet member(s) 40A, stitch-bound member(s) 50A and/or 50B, and unbound print member(s) 60A and/or 60B to each other and/or to cover 10 by adjoining members include but are not limited to (i) hook-and-slot, (ii) slot-and-hook, (iii) sliding hook-and-slot, (iv) sliding slot-and-hook, (v) interlocking sliding hook-and-slot, and (vi) interlocking slot-and-hook.

The attaching members of these embodiments are made of flexible and durable materials (such as plastic and/or rubber and/or metal), which would be affixed to the book cover and/or section member(s) and/or booklet member(s) and/or stitch member(s) and/or unbound print member(s). These members may be affixed in a variety of permanent or non-permanent ways, such as gluing, taping, sewing, clasping, crimping, or interlocking. Thus, the attaching mechanism may be reversible or irreversible, depending on the desire of the manufacturer and/or user. The most likely method for affixing members described in embodiments attaching section member(s) 30A and/or 30B to each other or to book cover 10 is gluing. On the other hand, the embodiments section member(s) 30A and/or 30B, booklet member 40A, stitch-bound member(s) 50A and/or 50B, and unbound print member(s) 60A and/or 60B to each other and/or to cover 10 may require additional strength by employing additional clamping and/or sewing and/or crimping. The composition base of the adhesive used to affix attaching members to the book cover 10 and/or section member(s) 30A and/or 30B and/or booklet member 40A, and/or stitch bound member(s) 50A and/or 50B, and unbound print member(s) 60A and/or 60B may include but is not limited to a polyvinyl acetate (PVA), Polyurethane (PUR), plastic resin, ground animal, ground hide, liquid hide, or caoutchouc (raw rubber).

Attachment members described in the present invention may be manufactured for a specific width and/or height of print matter. It is envisioned, however, that while most attachment members can accommodate a variety of widths of print matter, the height of the attachment member may be predetermined or created for modularity after initial fabrication.

FIGS. 1A, 1B, 1C, and 1D depict a hook-and-slot mechanism between section members 30A and 30B, according to an exemplary embodiment of the present invention. In this embodiment, there is a support leg 401A containing upward-facing hook elements 404A along the exterior of the spine region 35A of the section member 30A. A complimentary slot element located along the support leg 301B contains a protruding curved element 303B containing slot elements 304B along the exterior of the spine region 35B of the section member 30B. This arrangement of complimentary hooks and slots will allow the section member 30A to attach and be retained by section member 30B by inserting and/or sliding unique protruding element 303B into the complimentary unique hook elements 404A until properly aligned to allow slot elements 304B to mate with the hook elements 404A. Once in this position, section members 30A and 30B can hinge open and closed, rotating upon the common axis created where hooked rail 400A and slotted rail 300B join together.

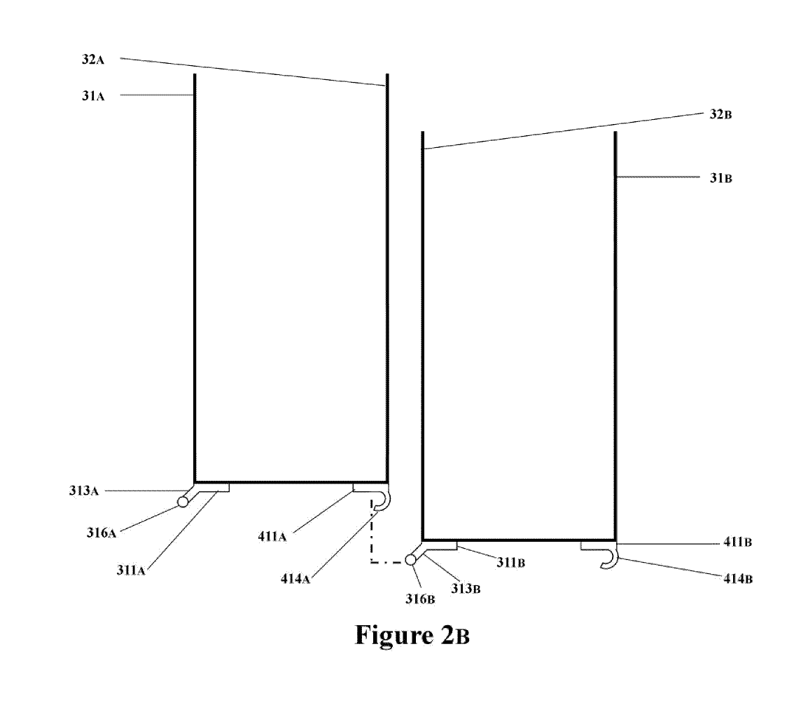

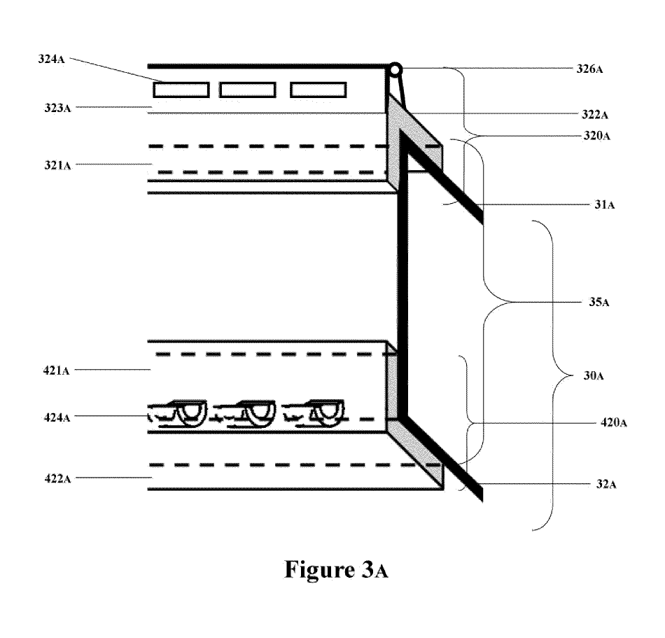

FIGS. 2A and 2B depict a modular hook-and-slot mechanism between section members 30A and 30B, according to an exemplary embodiment of the present invention. In this embodiment, there is a modular support leg 411A containing upward-facing hook elements 414A along the exterior of the spine region 35A of the section member 30A. A complimentary slot element located along the modular support leg 311B contains a protruding curved element 313B with slot elements along the exterior of the spine region 35B of the section member 30B, similar to 314A. The modular support legs 311A,B, and 411A,B, are also composed of breaks 315A,B, and 415A,B that allow portions of the support legs for slotted rail 310A,B, and 410A,B to be reattached and or detached from the whole. This arrangement of complimentary hooks and slots will allow the section member 30A to attach and be retained by section member 30B by inserting and/or sliding unique protruding element 313B into the complimentary unique hook elements 414A until properly aligned to allow slot elements of section member 30B to mate with the hook elements 414A. Once in this position, section members 30A and 30B can hinge open and closed, rotating upon the common axis created where hooked rail 410A and slotted rail of section member 30B join together.

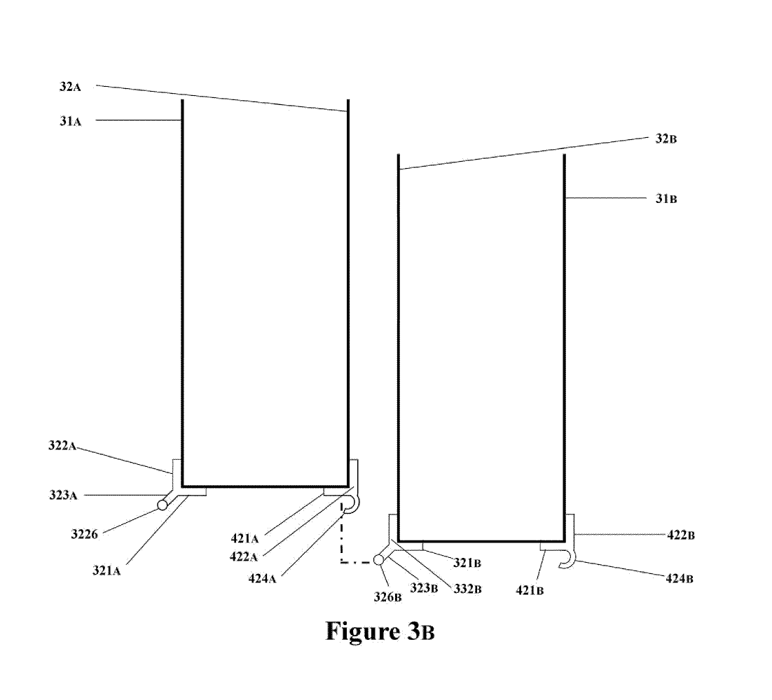

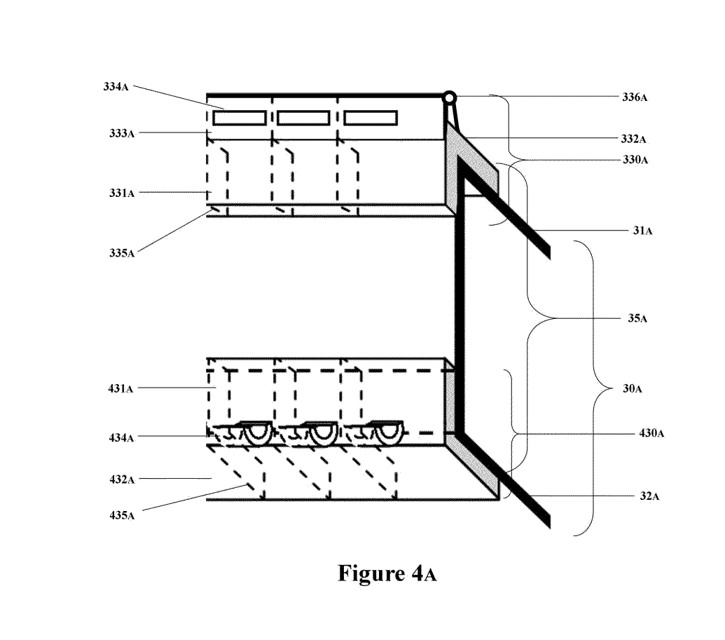

FIGS. 3A and 3B depict an additional hook-and-slot mechanism between section members 30A and 30B, according to an exemplary embodiment of the present invention. In this embodiment, there is a support leg 421A containing upward-facing hook elements 404A along the exterior of the spine region 35A of the section member 30A. Hooked rail element 420A also contains another support leg 422A along the cover 32A of section member 30A. A complimentary slot element located along the support leg 321B contains a protruding curved element 323B containing slot elements along the exterior of the spine region 35B of the section member 30B, similar to 324A. This arrangement of complimentary hooks and slots will allow the section member 30A to attach and be retained by section member 30B by inserting and/or sliding unique protruding element 323B into the complimentary unique hook elements 424A until properly aligned to allow slot elements of section member 30B to mate with the hook elements 424A. Once in this position, section members 30A and 30B can hinge open and closed, rotating upon the common axis created where hooked rail 420A and slotted rail of section member 30B join together.

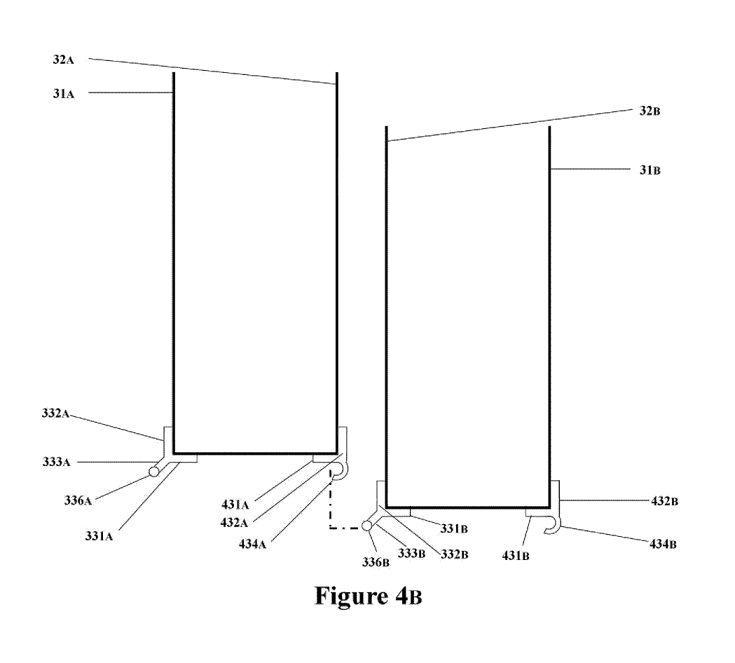

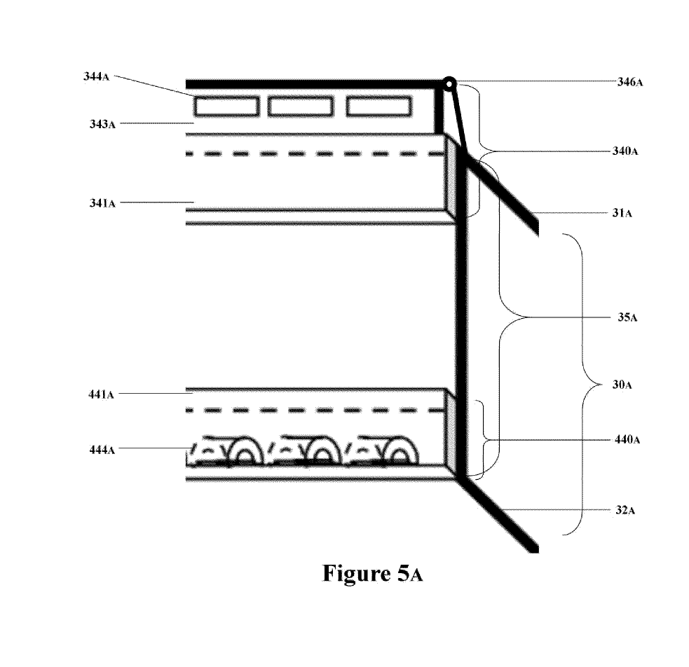

FIGS. 4A and 4B depict a different modular hook-and-slot mechanism between section members 30A and 30B, according to an exemplary embodiment of the present invention. In this embodiment, there is a modular support leg 431A containing upward-facing hook elements 434A along the exterior of the spine region 35A of the section member 30A. Hooked rail element 430A also contains another modular support leg 432A along the cover 32A of section member 30A. A complimentary slot element located along the modular support leg 331B contains a protruding curved element 333B with slot elements along the exterior of the spine region 35B of the section member 30B, similar to 334A. The modular support legs 331A,B, 332 A,B, 431A,B, and 432 A,B are also composed of breaks 335A,B, and 435A,B that allow portions of the support legs for slotted rail 330A,B, and 430A,B to be reattached and or detached from the whole. This arrangement of complimentary hooks and slots will allow the section member 30A to attach and be retained by section member 30B by inserting and/or sliding unique protruding element 333B into the complimentary unique hook elements 434A until properly aligned to allow slot elements of section member 30B to mate with the hook elements 434A. Once in this position, section members 30A and 30B can hinge open and closed, rotating upon the common axis created where hooked rail 430A and slotted rail of section member 30B join together.

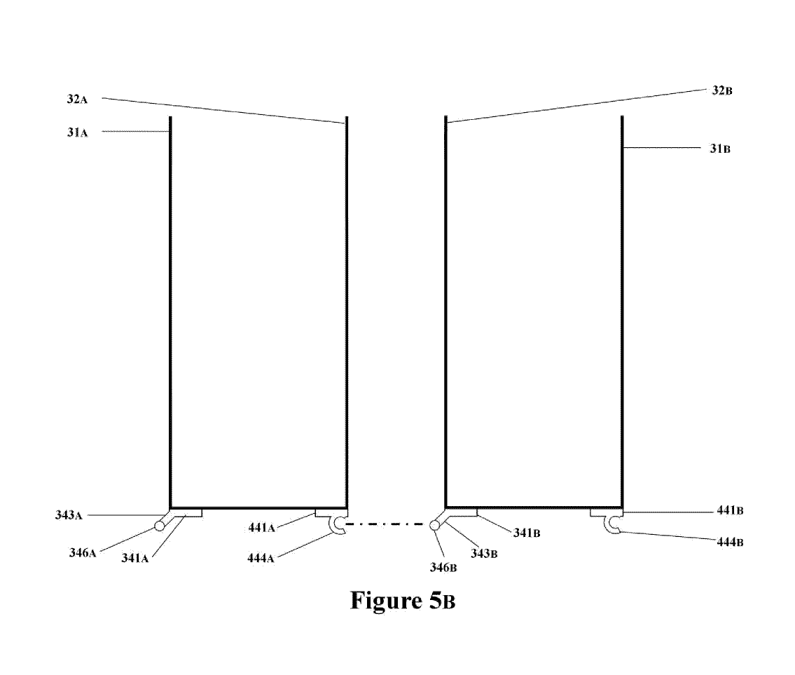

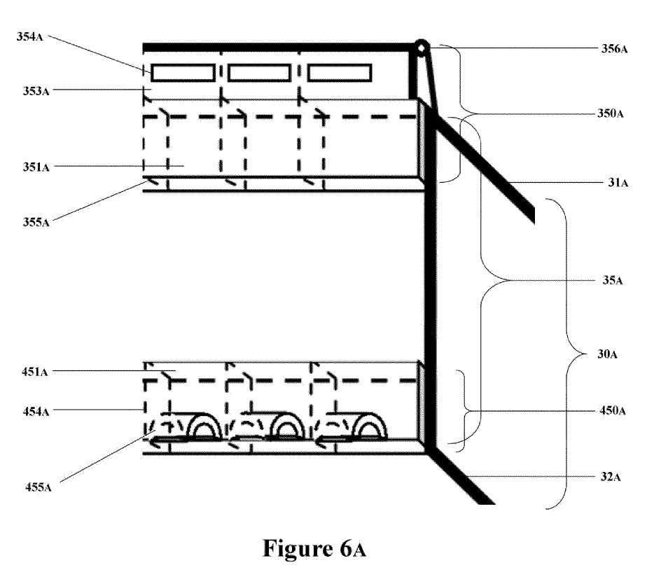

FIGS. 5A and 5B depict an alternative hook-and-slot mechanism between section members 30A and 30B, according to an exemplary embodiment of the present invention. In this embodiment, there is a support leg 441A containing downward-facing hook elements 444A along the exterior of the spine region 35A of the section member 30A. A complimentary slot element located along the support leg 341B contains a protruding curved element 343B containing slot elements along the exterior of the spine region 35B of the section member 30B, similar to 344A. This arrangement of complimentary hooks and slots will allow the section member 30A to attach and be retained by section member 30B by inserting and/or sliding unique protruding element 343B into the complimentary unique hook elements 444A until properly aligned to allow slot elements of section member 30B to mate with the hook elements 444A. Once in this position, section members 30A and 30B can hinge open and closed, rotating upon the common axis created where hooked rail 440A and slotted rail of section member 30B join together.

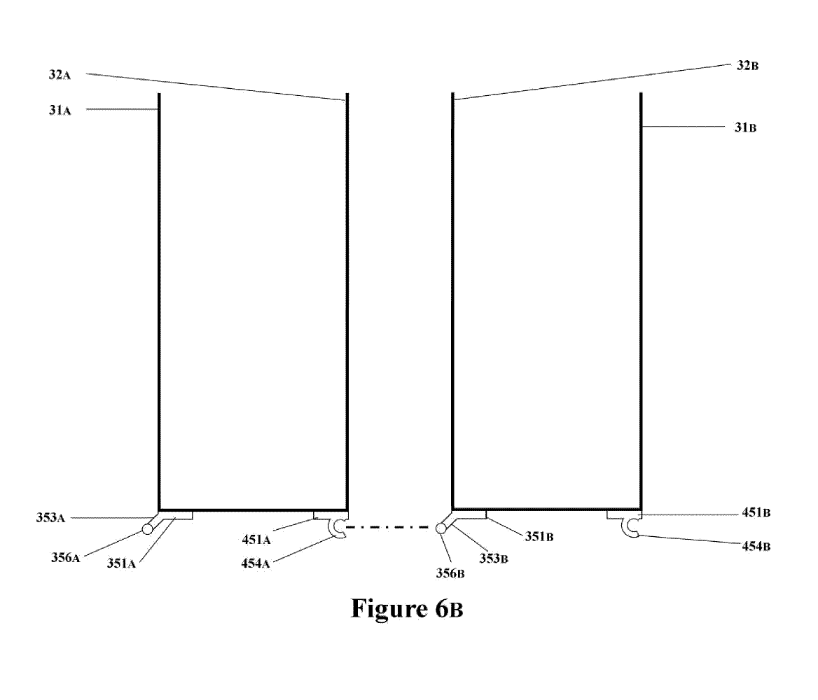

FIGS. 6A and 6B depict another modular hook-and-slot mechanism between section members 30A and 30B, according to an exemplary embodiment of the present invention. In this embodiment, there is a modular support leg 451A containing downward-facing hook elements 454A along the exterior of the spine region 35A of the section member 30A. A complimentary slot element located along the modular support leg 351B contains a protruding curved element 353B with slot elements along the exterior of the spine region 35B of the section member 30B, similar to 354A. The modular support legs 351A,B, and 451A,B, are also composed of breaks 355A,B, and 455A,B that allow portions of the support legs for slotted rail 350A,B, and 450A,B to be reattached and or detached from the whole. This arrangement of complimentary hooks and slots will allow the section member 30A to attach and be retained by section member 30B by inserting and/or sliding unique protruding element 353B into the complimentary unique hook elements 454A until properly aligned to allow slot elements of section member 30B to mate with the hook elements 454A. Once in this position, section members 30A and 30B can hinge open and closed, rotating upon the common axis created where hooked rail 450A and slotted rail of section member 30B join together.

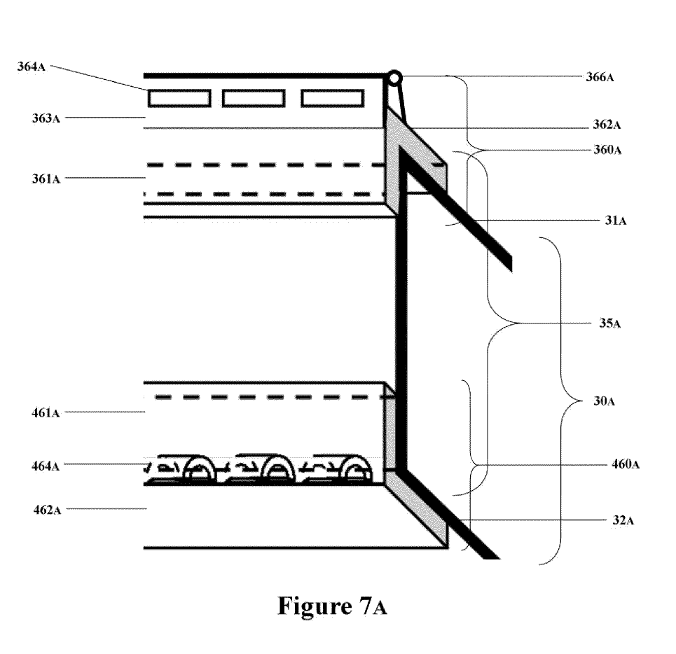

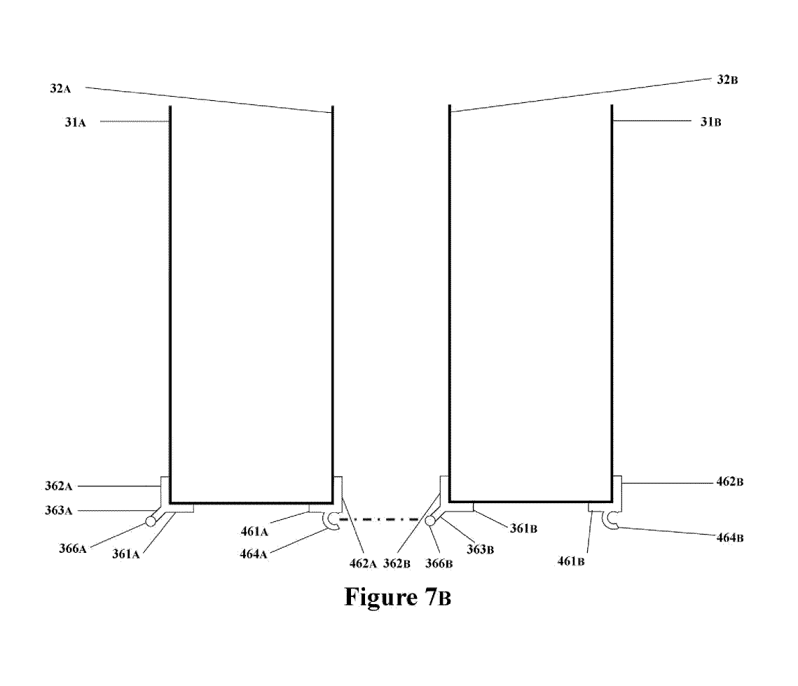

FIGS. 7A and 7B depict a different hook-and-slot mechanism between section members 30A and 30B, according to an exemplary embodiment of the present invention. In this embodiment, there is a support leg 461A containing downward-facing hook elements 464A along the exterior of the spine region 35A of the section member 30A. Hooked rail element 460A also contains another support leg 462A along the cover 32A of section member 30A. A complimentary slot element located along the support leg 361B contains a protruding curved element 363B containing slot elements along the exterior of the spine region 35B of the section member 30B, similar to 364A. This arrangement of complimentary hooks and slots will allow the section member 30A to attach and be retained by section member 30B by inserting and/or sliding unique protruding element 363B into the complimentary unique hook elements 464A until properly aligned to allow slot elements of section member 30B to mate with the hook elements 464A. Once in this position, section members 30A and 30B can hinge open and closed, rotating upon the common axis created where hooked rail 460A and slotted rail of section member 30B join together.

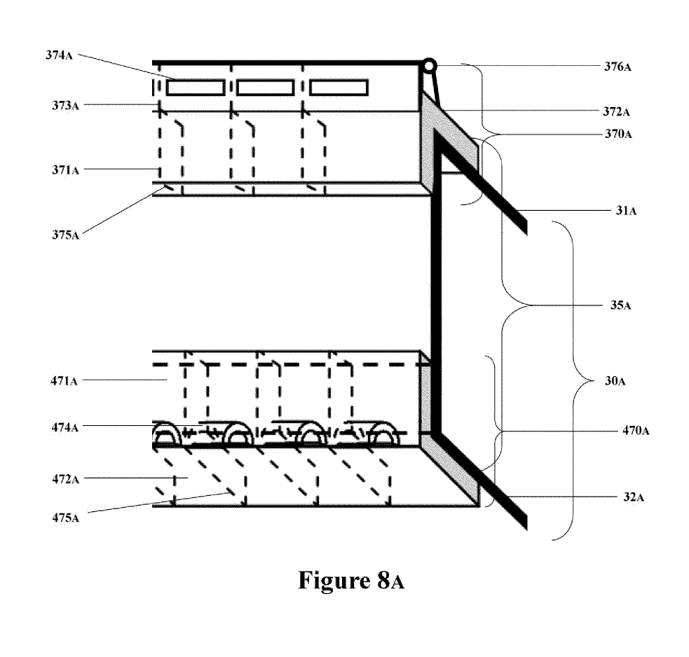

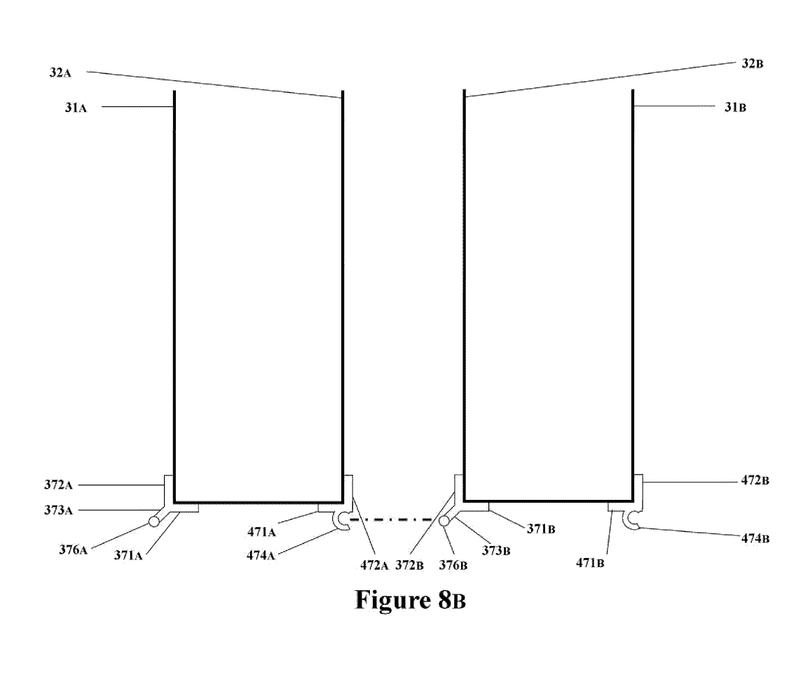

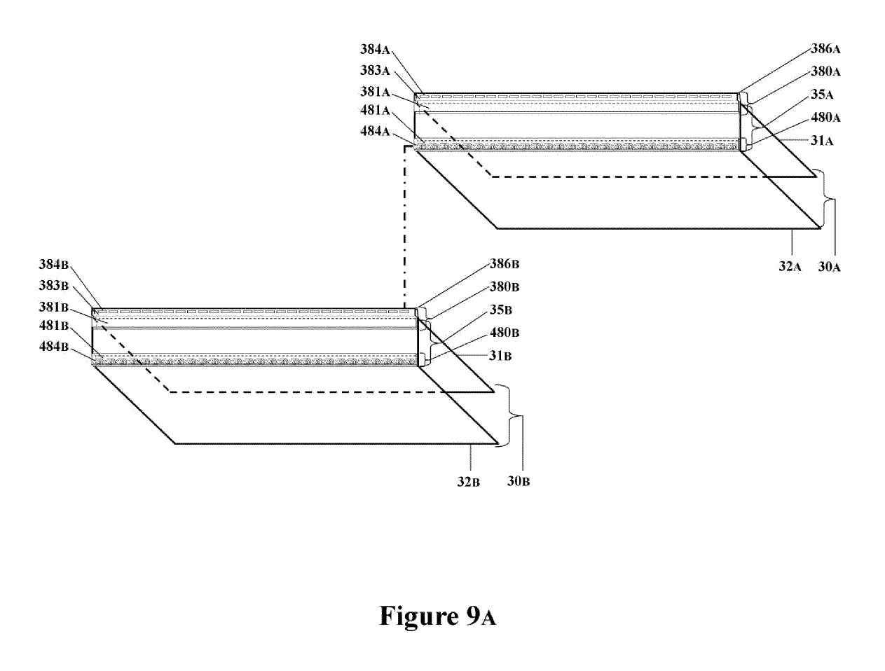

FIGS. 8A and 8B depict yet another modular hook-and-slot mechanism between section members 30A and 30B, according to an exemplary embodiment of the present invention. In this embodiment, there is a modular support leg 471A containing downward-facing hook elements 474A along the exterior of the spine region 35A of the section member 30A. Hooked rail element 470A also contains another modular support leg 472A along the cover 32A of section member 30A. A complimentary slot element located along the modular support leg 371B contains a protruding curved element 373B with slot elements along the exterior of the spine region 35B of the section member 30B, similar to 374A. The modular support legs 371A,B, 372 A,B, 471A,B, and 472 A,B are also composed of breaks 375A,B, and 475A,B that allow portions of the support legs for slotted rail 370A,B, and 470A,B to be reattached and or detached from the whole. This arrangement of complimentary hooks and slots will allow the section member 30A to attach and be retained by section member 30B by inserting and/or sliding unique protruding element 373B into the complimentary unique hook elements 474A until properly aligned to allow slot elements of section member 30B to mate with the hook elements 474A. Once in this position, section members 30A and 30B can hinge open and closed, rotating upon the common axis created where hooked rail 470A and slotted rail of section member 30B join together.

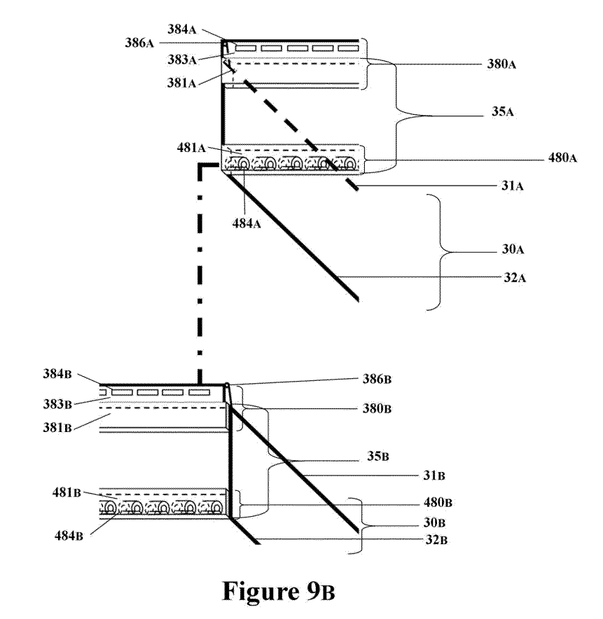

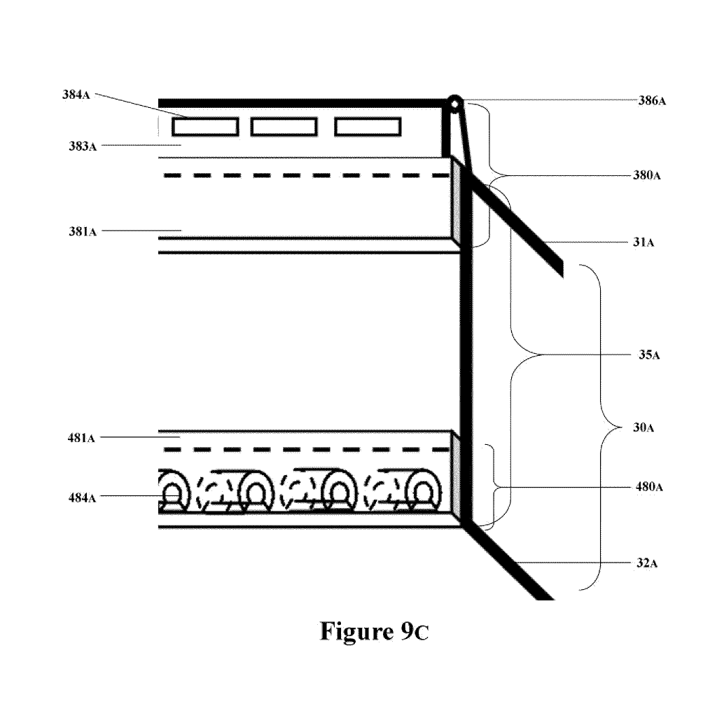

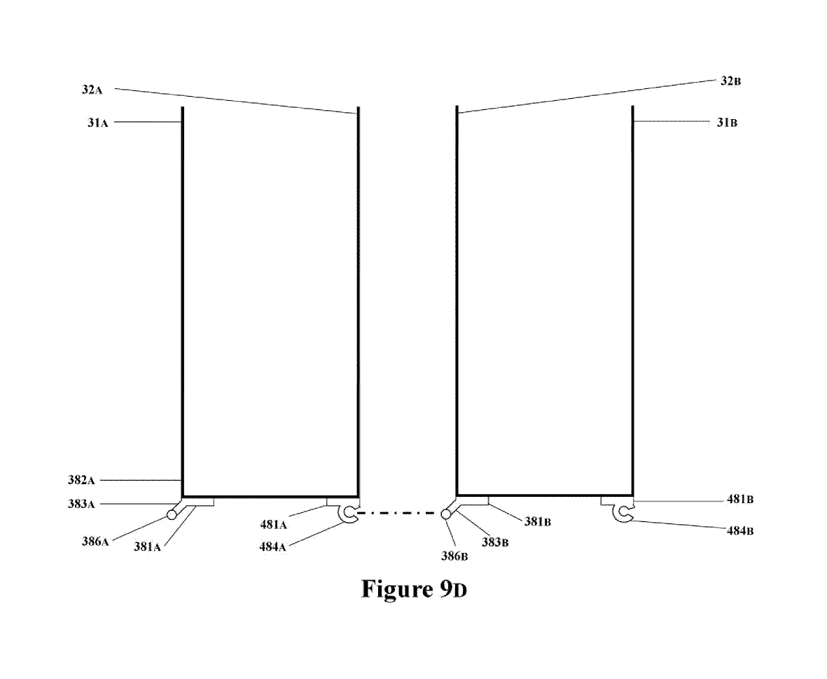

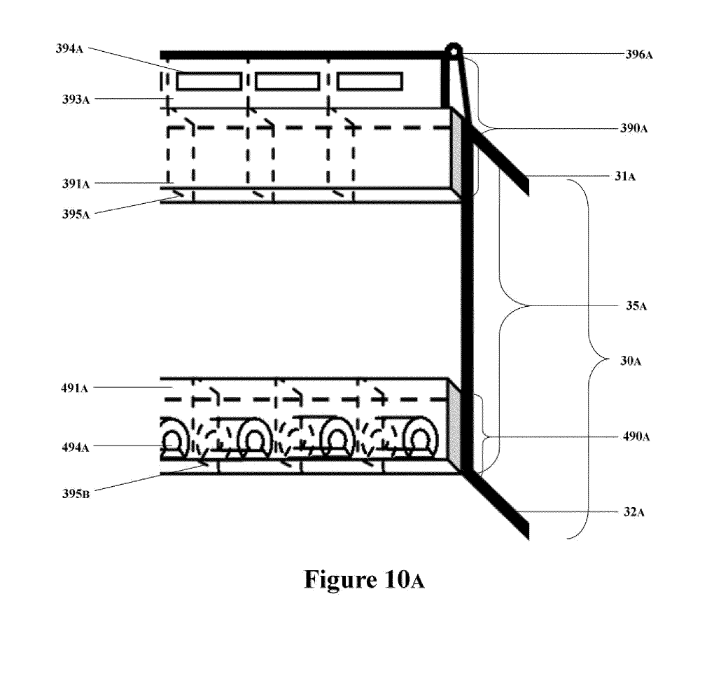

FIGS. 9A, 9B, 9C, and 9D depict a sliding hook-and-slot mechanism between section members 30A and 30B, according to an exemplary embodiment of the present invention. In this iteration, both the hooked and slotted rails have an extended support leg attached to the spine region of the section member. The hooks are also open to an alternative direction in this iteration of the present invention. The hooks also maintain an alternative geometry with a much narrower entrance, creating an easier attachment by sliding the slotted-rail through the hooked-rails cylindrical-like channel down the center of its hooks. In this embodiment, there is a support leg 481A containing extended and downward-facing hook elements 484A along the exterior of the spine region 35A of the section member 30A. The geometry of these extended hook elements 484A make an even more defined channel through which the slotted rail 380B can slide through, aiding in the ease of use and zip-like attachment technique. A complimentary slot element located along the support leg 381B contains a protruding curved element 383B containing slot elements 384B along the exterior of the spine region 35B of the section member 30B. This arrangement of complimentary hooks and slots will allow the section member 30A to attach and be retained by section member 30B by inserting and/or sliding unique protruding element 383B into the complimentary unique hook elements 484A until properly aligned to allow slot elements 384B to mate with the hook elements 484A. Once in this position, section members 30A and 30B can hinge open and closed, rotating upon the common axis created where hooked rail 480A and slotted rail 380B join together.

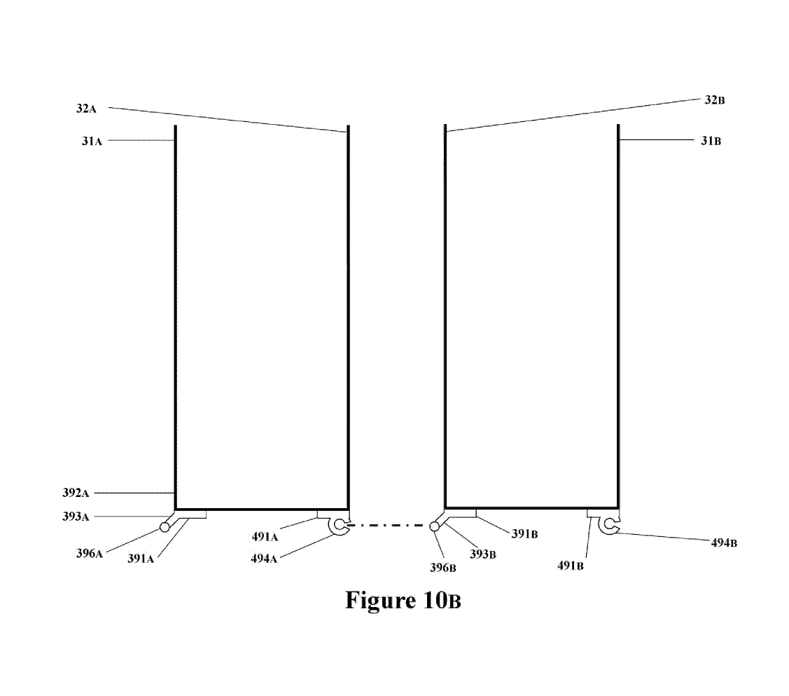

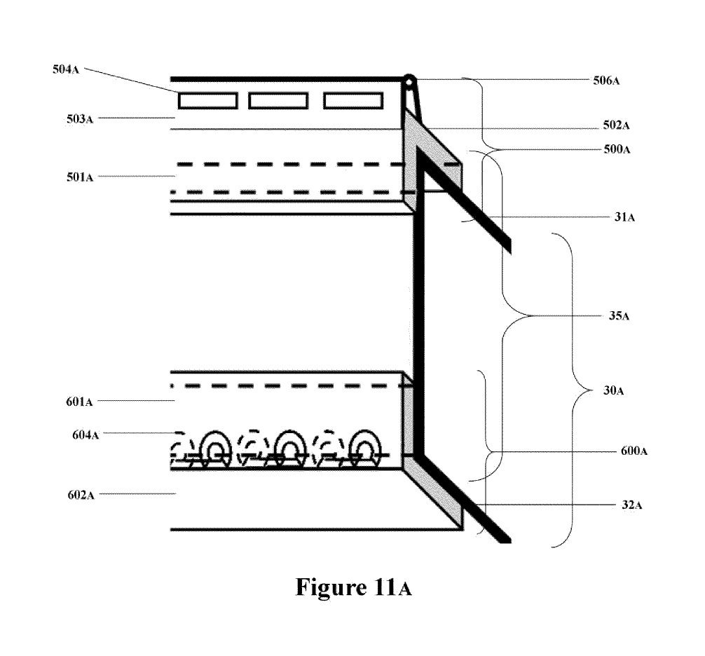

FIGS. 10A and 10B depict a modular sliding hook-and-slot mechanism between section members 30A and 30B, according to an exemplary embodiment of the present invention. In this iteration, both the hooked and slotted rails have an extended support leg attached to the spine region of the section member. The hooks are also open to an alternative direction in this iteration of the present invention. The hooks also maintain an alternative geometry with a much narrower entrance, creating an easier attachment by sliding the slotted-rail through the hooked-rails cylindrical-like channel down the center of its hooks. In this embodiment, there is a modular support leg 491A containing extended and downward-facing hook elements 494A along the exterior of the spine region 35A of the section member 30A. The geometry of these extended hook elements 494A make an even more defined channel through which the slotted rail of section member 30B can slide through, aiding in the ease of use and zip-like attachment technique. A complimentary slot element located along the modular support leg 391B contains a protruding curved element 393B with slot elements along the exterior of the spine region 35B of the section member 30B, similar to 394A. The modular support legs 391A,B, and 491A,B, are also composed of breaks 395A,B, and 495A,B that allow portions of the support legs for slotted rail 390A,B, and 490A,B to be reattached and or detached from the whole. This arrangement of complimentary hooks and slots will allow the section member 30A to attach and be retained by section member 30B by inserting and/or sliding unique protruding element 393B into the complimentary unique hook elements 494A until properly aligned to allow slot elements of section member 30B to mate with the hook elements 494A. Once in this position, section members 30A and 30B can hinge open and closed, rotating upon the common axis created where hooked rail 490A and slotted rail of section member 30B join together.

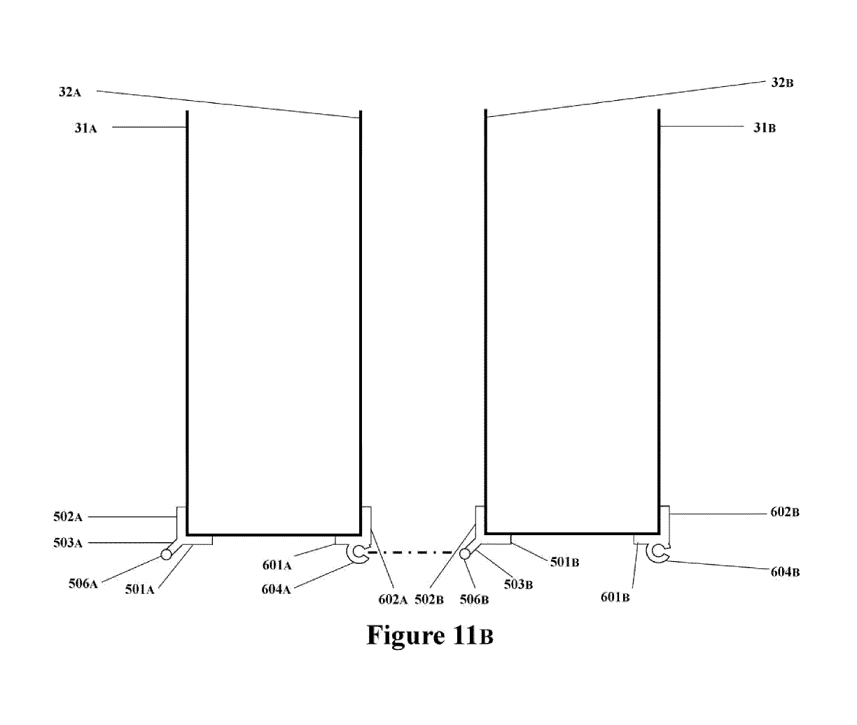

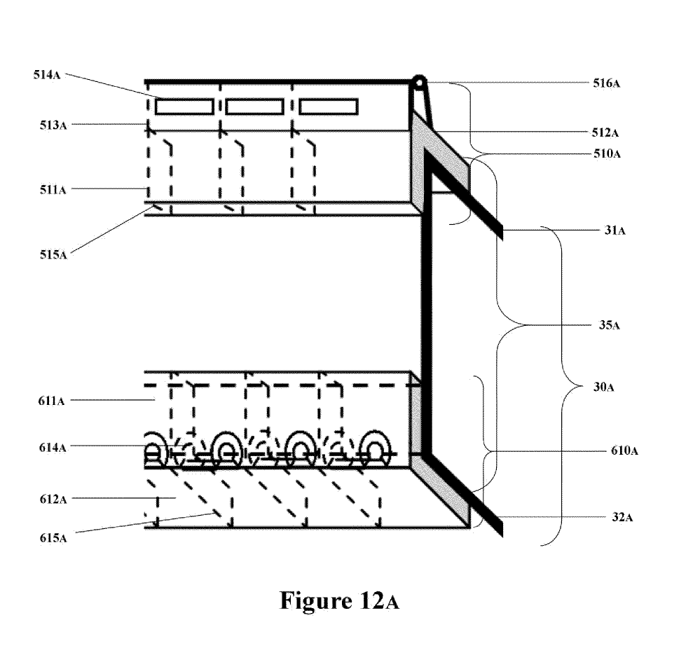

FIGS. 11A and 11B depict an additional sliding hook-and-slot mechanism between section members 30A and 30B, according to an exemplary embodiment of the present invention. In this embodiment, there is a support leg 601A containing extended and downward-facing hook elements 604A along the exterior of the spine region 35A of the section member 30A. Hooked rail element 600A also contains another support leg 602A along the cover 32A of section member 30A. The geometry of these extended hook elements 604A make an even more defined channel through which the slotted rail of section member 30B can slide through, aiding in the ease of use and zip-like attachment technique. A complimentary slot element located along the support leg 501B contains a protruding curved element 503B containing slot elements along the exterior of the spine region 35B of the section member 30B, similar to 504A. This arrangement of complimentary hooks and slots will allow the section member 30A to attach and be retained by section member 30B by inserting and/or sliding unique protruding element 503B into the complimentary unique hook elements 604A until properly aligned to allow slot elements of section member 30B to mate with the hook elements 604A. Once in this position, section members 30A and 30B can hinge open and closed, rotating upon the common axis created where hooked rail 600A and slotted rail of section member 30B join together.

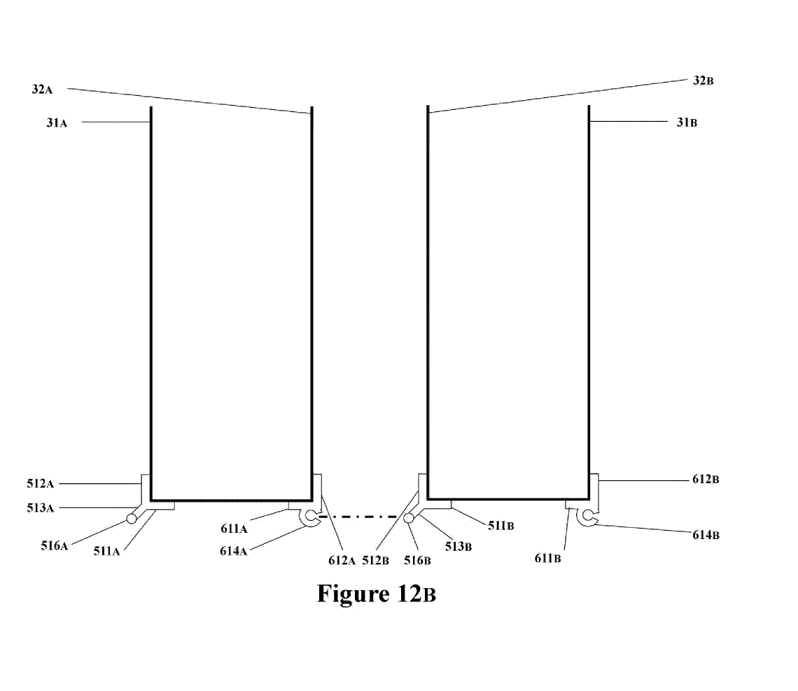

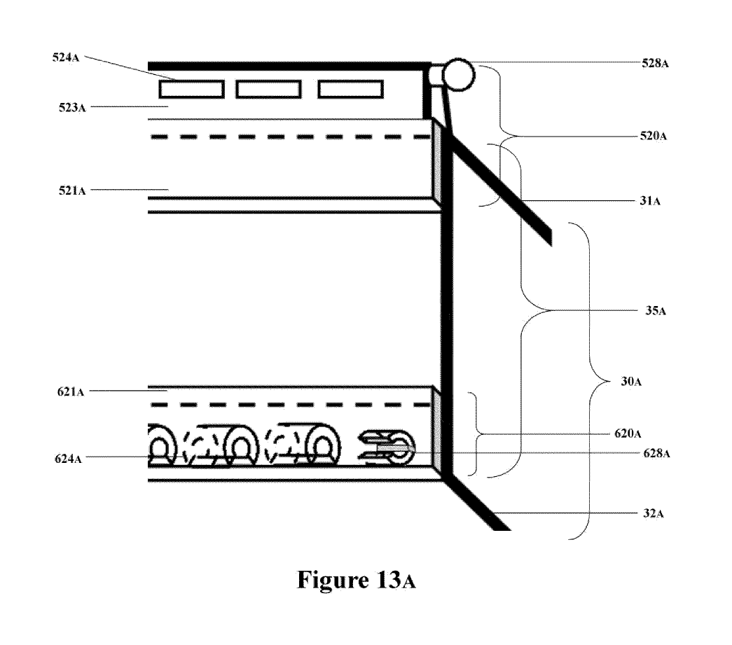

FIGS. 12A and 12B depict a different modular sliding hook-and-slot mechanism between section members 30A and 30B, according to an exemplary embodiment of the present invention. In this embodiment, there is a modular support leg 611A containing extended and downward-facing hook elements 614A along the exterior of the spine region 35A of the section member 30A. Hooked rail element 610A also contains another modular support leg 612A along the cover 32A of section member 30A. The geometry of these extended hook elements 614A make an even more defined channel through which the slotted rail of section member 30B can slide through, aiding in the ease of use and zip-like attachment technique. A complimentary slot element located along the modular support leg 511B contains a protruding curved element 513B with slot elements along the exterior of the spine region 35B of the section member 30B, similar to 514A. The modular support legs 511A,B, 512 A,B, 611A,B, and 612 A,B are also composed of breaks 515A,B, and 615A,B that allow portions of the support legs for slotted rail 510A,B, and 610A,B to be reattached and or detached from the whole. This arrangement of complimentary hooks and slots will allow the section member 30A to attach and be retained by section member 30B by inserting and/or sliding unique protruding element 513B into the complimentary unique hook elements 614A until properly aligned to allow slot elements of section member 30B to mate with the hook elements 614A. Once in this position, section members 30A and 30B can hinge open and closed, rotating upon the common axis created where hooked rail 610A and slotted rail of section member 30B join together.

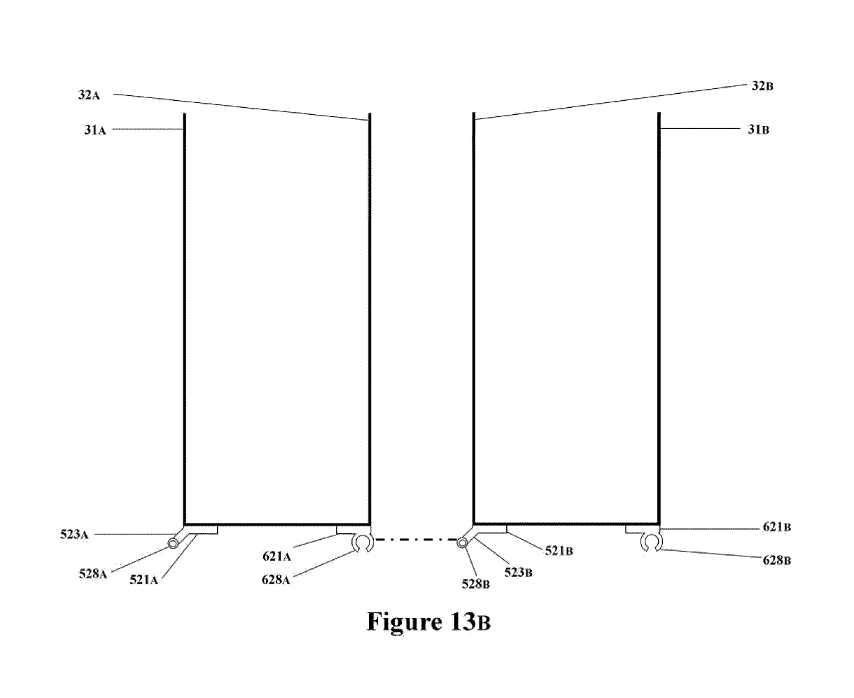

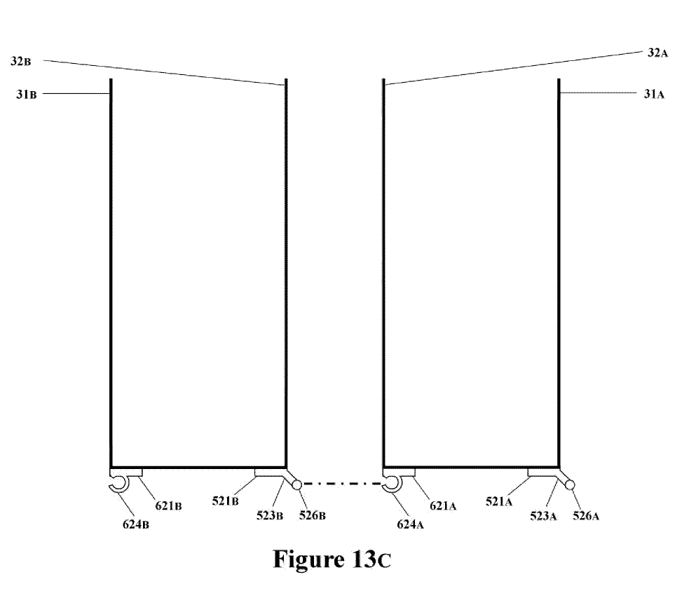

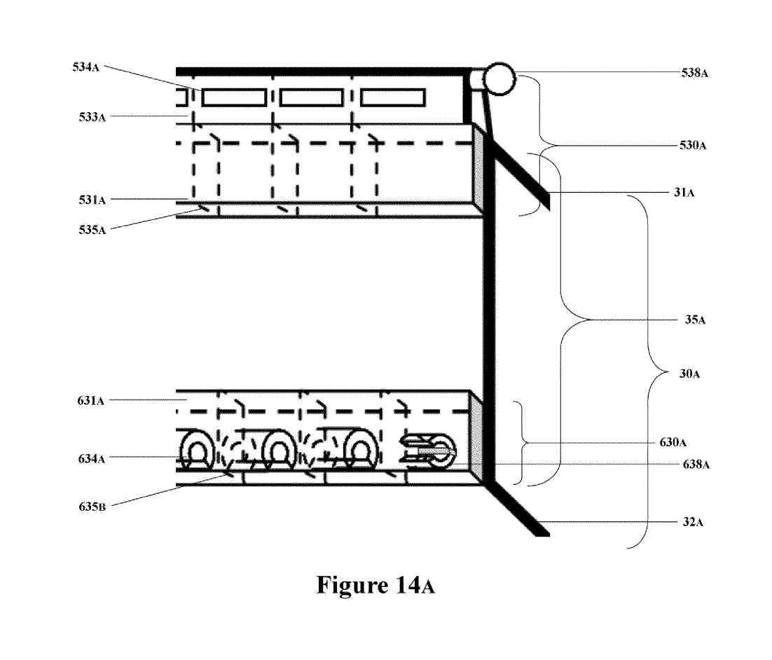

FIGS. 13A, 13B, and 13C depict a sliding hook-and-slot mechanism with stopper elements between section members 30A and 30B, according to an exemplary embodiment of the present invention. In this iteration, both the hooked and slotted rails have an extended support leg attached to the spine region of the section member. The hooks are also open to an alternative direction in this iteration of the present invention. The hooks also maintain an alternative geometry with a much narrower entrance, creating an easier attachment by sliding the slotted-rail through the hooked-rails cylindrical-like channel down the center of its hooks. There is also a unique stopper element that aids the hooked-rail and slotted-rail to correctly nest within each other for proper mating of the elements to ensure the full range of hinging motion. In this embodiment, there is a support leg 621A containing extended and downward-facing hook elements 624A along the exterior of the spine region 35A of the section member 30A. The geometry of these extended hook elements 624A make an even more defined channel through which the slotted rail of section member 30B can slide through, aiding in the ease of use and zip-like attachment technique. A complimentary slot element located along the support leg 521B contains a protruding curved element 523B containing slot elements along the exterior of the spine region 35B of the section member 30B, similar to 524A. This arrangement of complimentary hooks and slots will allow the section member 30A to attach and be retained by section member 30B by inserting and/or sliding unique protruding element 523B into the complimentary unique hook elements 624A until properly aligned to allow slot elements of section member 30B to mate with the hook elements 624A. Stopper elements help align slotted rail 520B correctly with hooked rail 620A. A unique ball-like element 528B is located at an end of the curved protruding element 523B. This ball-like element is captured through a flexible but durable hook-like element 628A, which is located along hooked rail 620A. Once in this position, section members 30A and 30B can hinge open and closed, rotating upon the common axis created where hooked rail 620A and slotted rail of section member 30B join together.

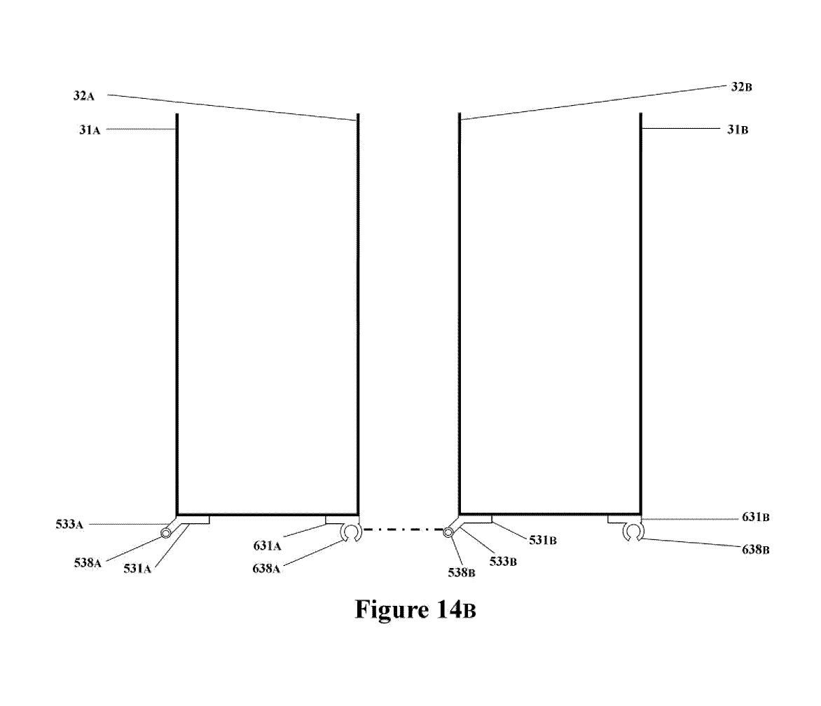

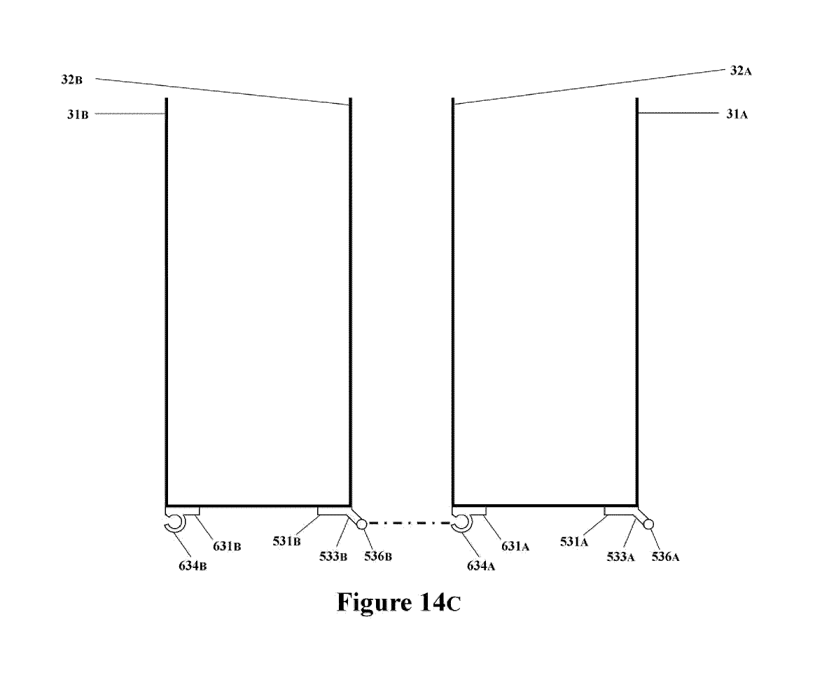

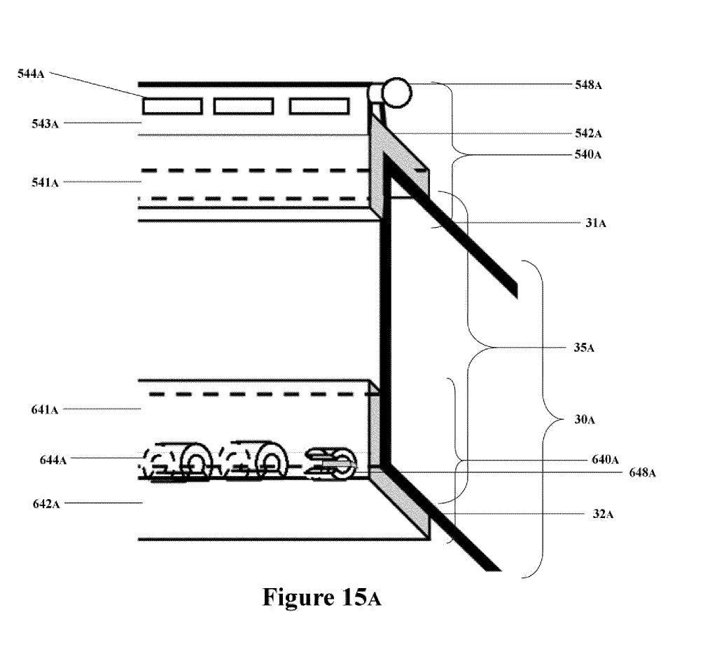

FIGS. 14A, 14B, and 14C depict a modular sliding hook-and-slot mechanism with stopper elements between section members 30A and 30B, according to an exemplary embodiment of the present invention. In this iteration, both the hooked and slotted rails have an extended support leg attached to the spine region of the section member. The hooks are also open to an alternative direction in this iteration of the present invention. The hooks also maintain an alternative geometry with a much narrower entrance, creating an easier attachment by sliding the slotted-rail through the hooked-rails cylindrical-like channel down the center of its hooks. There is also a unique stopper element that aids the hooked-rail and slotted-rail to correctly nest within each other for proper mating of the elements to ensure the full range of hinging motion. In this embodiment, there is a modular support leg 631A containing extended and downward-facing hook elements 634A along the exterior of the spine region 35A of the section member 30A. The geometry of these extended hook elements 634A make an even more defined channel through which the slotted rail of section member 30B can slide through, aiding in the ease of use and zip-like attachment technique. A complimentary slot element located along the modular support leg 531B contains a protruding curved element 533B with slot elements along the exterior of the spine region 35B of the section member 30B, similar to 534A. The modular support legs 531A,B, and 631A,B, are also composed of breaks 535A,B, and 635A,B that allow portions of the support legs for slotted rail 530A,B, and 630A,B to be reattached and or detached from the whole. This arrangement of complimentary hooks and slots will allow the section member 30A to attach and be retained by section member 30B by inserting and/or sliding unique protruding element 533B into the complimentary unique hook elements 634A until properly aligned to allow slot elements of section member 30B to mate with the hook elements 634A. Stopper elements help align slotted rail 530B correctly with hooked rail 630A. A unique ball-like element 538B is located at an end of the curved protruding element 533B. This ball-like element is captured through a flexible but durable hook-like element 638A, which is located along hooked rail 630A. Once in this position, section members 30A and 30B can hinge open and closed, rotating upon the common axis created where hooked rail 530A and slotted rail of section member 30B join together.

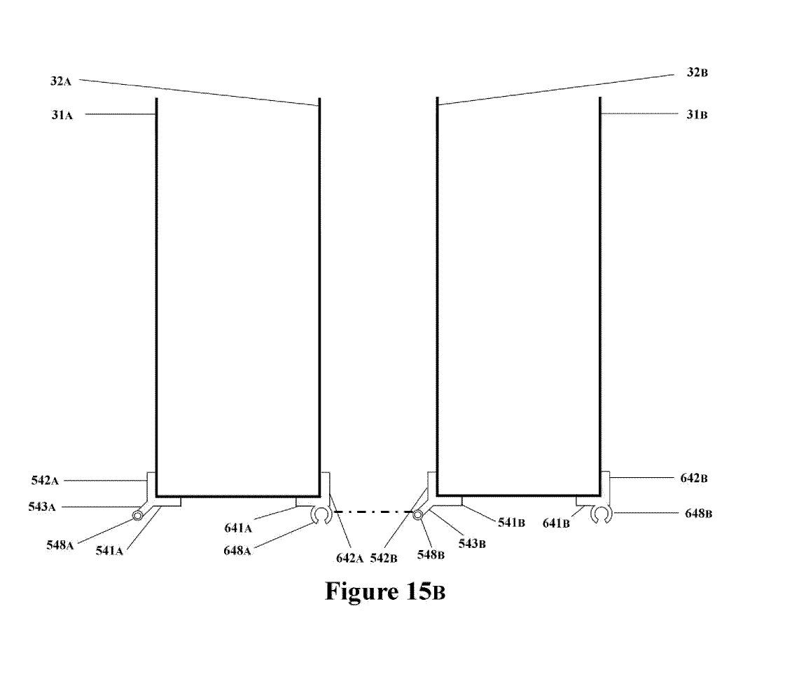

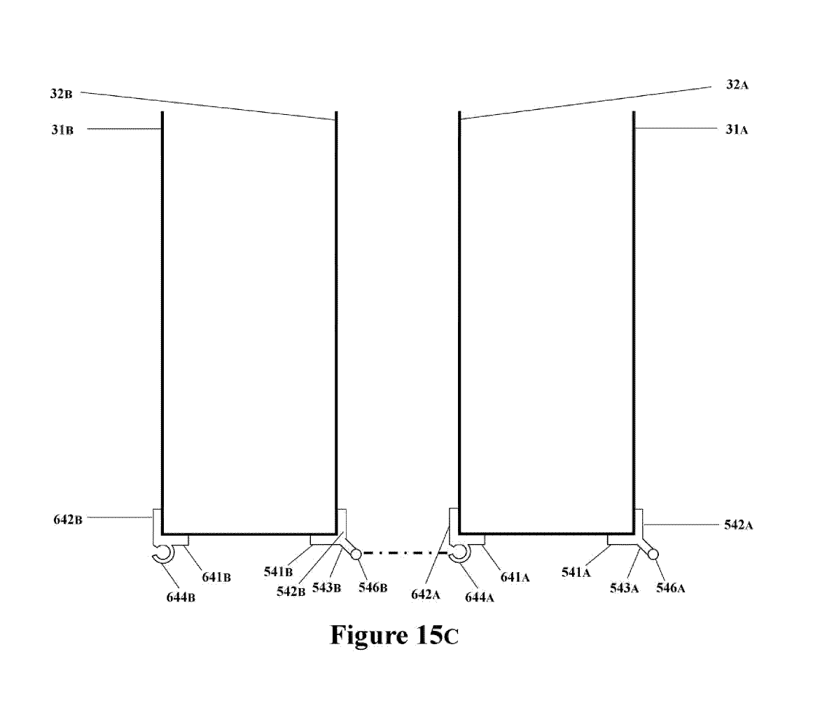

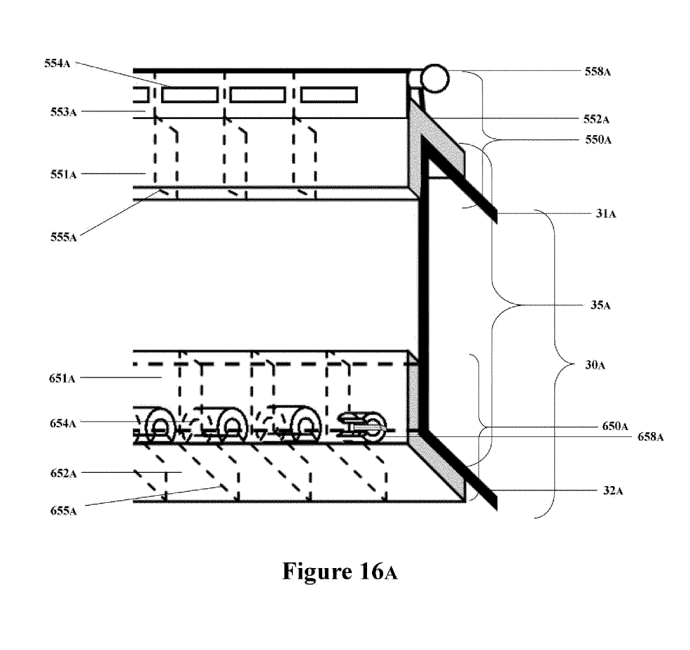

FIGS. 15A, 15B, and 15C depict another sliding hook-and-slot mechanism with stopper elements between section members 30A and 30B, according to an exemplary embodiment of the present invention. In this iteration, both the hooked and slotted rails have two extended support legs, one attached to the spine region of the section member and another attached to the cover of the section member. The hooks are also open to an alternative direction in this iteration of the present invention. The hooks also maintain an alternative geometry with a much narrower entrance, creating an easier attachment by sliding the slotted-rail through the hooked-rails cylindrical-like channel down the center of its hooks. There is also a unique stopper element that aids the hooked-rail and slotted-rail to correctly nest within each other for proper mating of the elements to ensure the full range of hinging motion. In this embodiment, there is a support leg 641A containing extended and downward-facing hook elements 644A along the exterior of the spine region 35A of the section member 30A. Hooked rail element 640A also contains another support leg 642A along the cover 32A of section member 30A. The geometry of these extended hook elements 644A make an even more defined channel through which the slotted rail of section member 30B can slide through, aiding in the ease of use and zip-like attachment technique. A complimentary slot element located along the support leg 541B contains a protruding curved element 543B containing slot elements along the exterior of the spine region 35B of the section member 30B, similar to 544A. This arrangement of complimentary hooks and slots will allow the section member 30A to attach and be retained by section member 30B by inserting and/or sliding unique protruding element 543B into the complimentary unique hook elements 644A until properly aligned to allow slot elements of section member 30B to mate with the hook elements 644A. Stopper elements help align slotted rail 540B correctly with hooked rail 640A. A unique ball-like element 548B is located at an end of the curved protruding element 543B. This ball-like element is captured through a flexible but durable hook-like element 648A, which is located along hooked rail 640A. Once in this position, section members 30A and 30B can hinge open and closed, rotating upon the common axis created where hooked rail 640A and slotted rail of section member 30B join together.

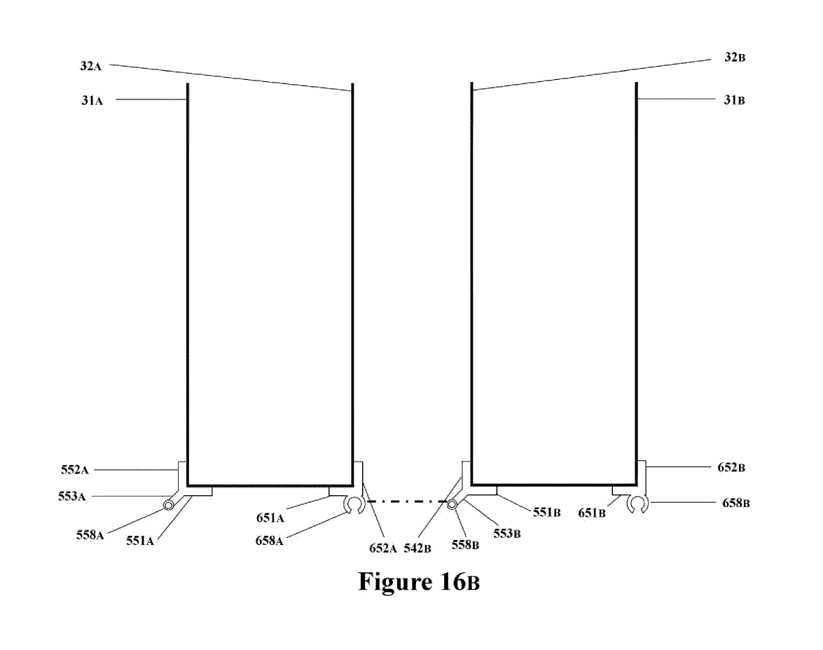

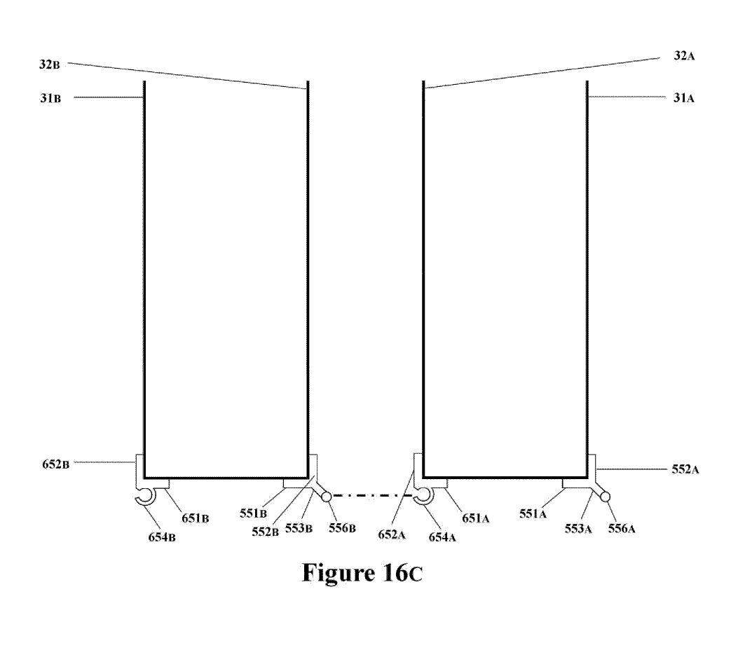

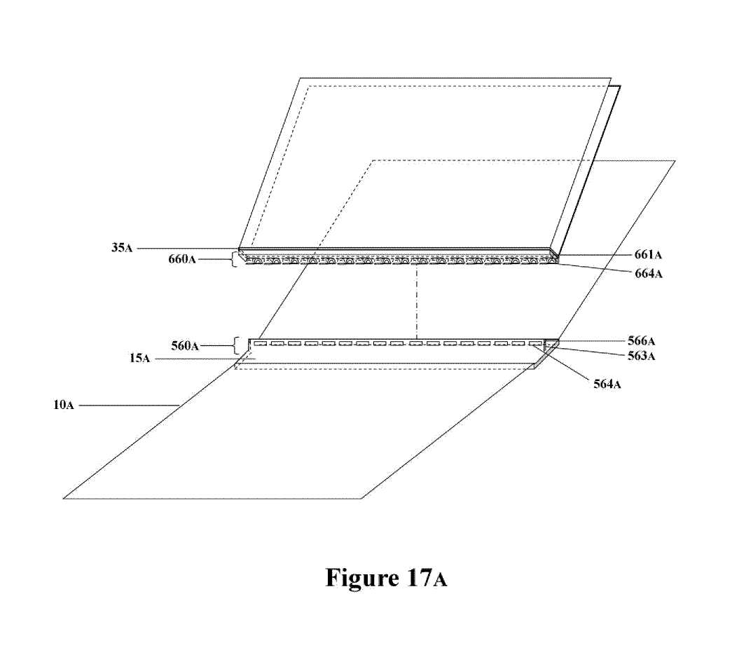

FIGS. 16A, 16B, and 16C depict a different modular sliding hook-and-slot mechanism with stopper elements between section members 30A and 30B, according to an exemplary embodiment of the present invention. In this iteration, both the hooked and slotted rails have two extended support legs, one attached to the spine region of the section member and another attached to the cover of the section member. The hooks are also open to an alternative direction in this iteration of the present invention. The hooks also maintain an alternative geometry with a much narrower entrance, creating an easier attachment by sliding the slotted-rail through the hooked-rails cylindrical-like channel down the center of its hooks. There is also a unique stopper element that aids the hooked-rail and slotted-rail to correctly nest within each other for proper mating of the elements to ensure the full range of hinging motion. In this embodiment, there is a modular support leg 651A containing extended and downward-facing hook elements 654A along the exterior of the spine region 35A of the section member 30A. Hooked rail element 650A also contains another modular support leg 652A along the cover 32A of section member 30A. The geometry of these extended hook elements 654A make an even more defined channel through which the slotted rail of section member 30B can slide through, aiding in the ease of use and zip-like attachment technique. A complimentary slot element located along the modular support leg 551B contains a protruding curved element 553B with slot elements along the exterior of the spine region 35B of the section member 30B, similar to 554A. The modular support legs 551A,B, 552 A,B, 651A,B, and 652 A,B are also composed of breaks 555A,B, and 655A,B that allow portions of the support legs for slotted rail 550A,B, and 650A,B to be reattached and or detached from the whole. This arrangement of complimentary hooks and slots will allow the section member 30A to attach and be retained by section member 30B by inserting and/or sliding unique protruding element 553B into the complimentary unique hook elements 654A until properly aligned to allow slot elements of section member 30B to mate with the hook elements 654A. Stopper elements help align slotted rail 550B correctly with hooked rail 650A. A unique ball-like element 558B is located at an end of the curved protruding element 553B. This ball-like element is captured through a flexible but durable hook-like element 658A, which is located along hooked rail 650A. Once in this position, section members 30A and 30B can hinge open and closed, rotating upon the common axis created where hooked rail 650A and slotted rail of section member 30B join together.

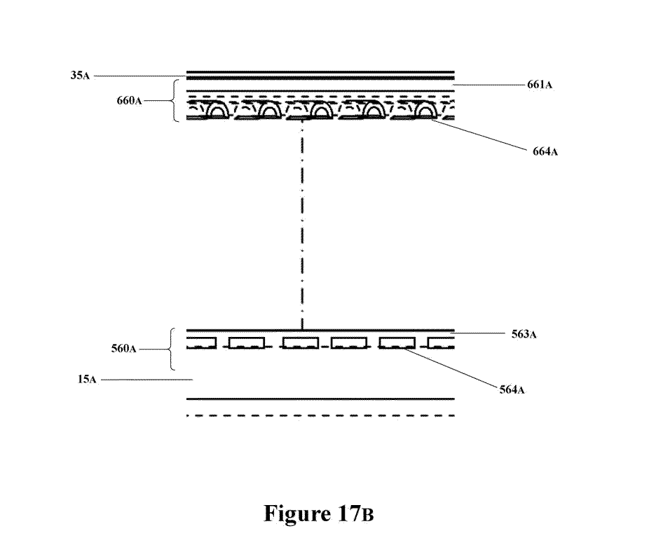

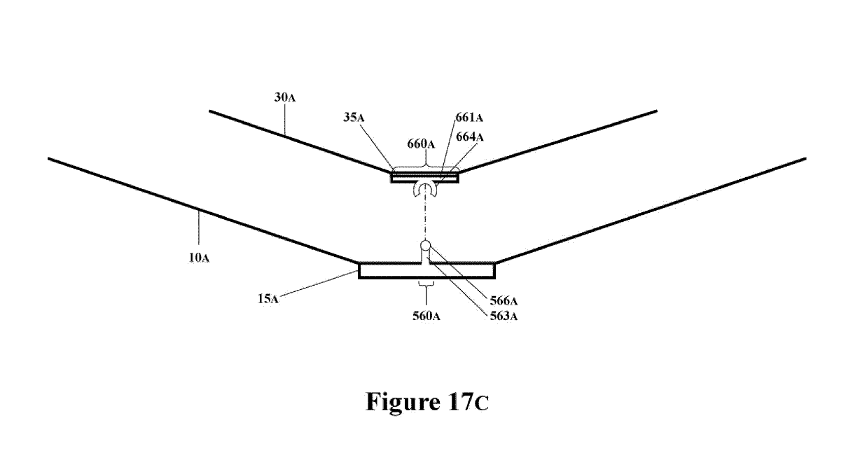

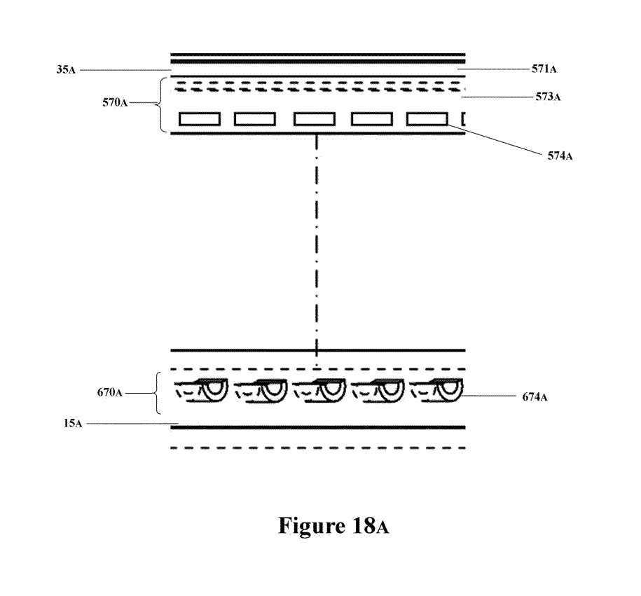

FIGS. 17 A, 17B, and 17C depict a hook-and-slot mechanism between section member 30A and book cover 10A, according to an exemplary embodiment of the present invention. In this embodiment, there is a support leg 661A containing hook elements 664A along the exterior of the spine region 35A of the section member 30A. A complimentary slot element is located along a protruding curved element 563A containing slot elements 564A along the interior of the spine region 15A of book cover 10A. This arrangement of complimentary hooks and slots allows the section member 30A to attach to and be retained by book cover 10A by inserting and/or sliding unique protruding element 563A into the complimentary unique hook elements 664A until properly aligned to allow slot elements 564A to mate with the hook elements 664A. Once in this position, section member 30A and book cover 10A can hinge open and closed, rotating upon the common axis created where hooked rail 660A and slotted rail 560A join together.

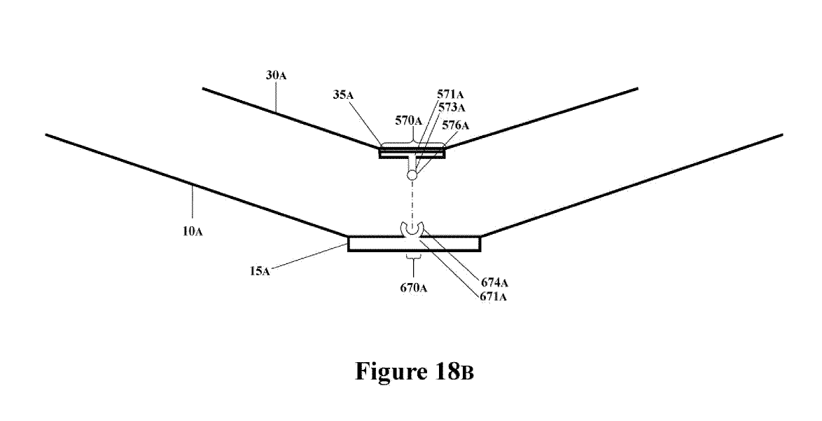

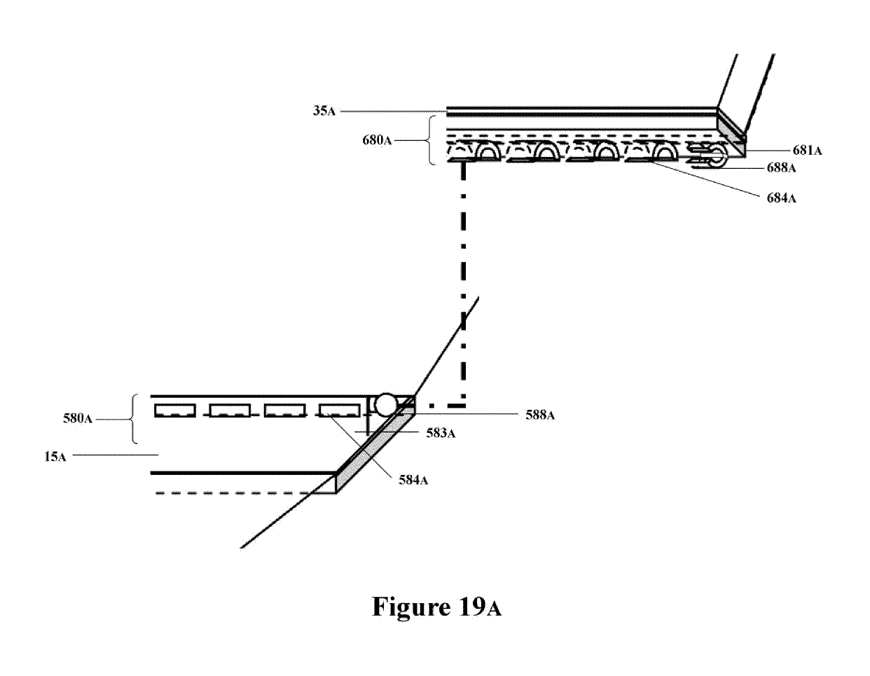

FIGS. 18 A and 18B depict a slot-and-hook mechanism between section member 30A and book cover 10A, according to an exemplary embodiment of the present invention. In this embodiment, there is a support leg 571A containing a protruding curved element 573A containing slot elements 574A. This slotted rail member is attached along the exterior of the spine region 35A of the section member 30A. A complimentary hooking element 674A is located along the interior of the spine region 15A of book cover 10A. This arrangement of complimentary hooks and slots allows the section member 30A to attach to and be retained by book cover 10A by inserting and/or sliding unique protruding element 573A into the complimentary unique hook elements 674A until properly aligned to allow slot elements 574A to mate with the hook elements 674A. Once in this position, section member 30A and book cover 10A can hinge open and closed, rotating upon the common axis created where hooked rail 670A and slotted rail 570A join together.

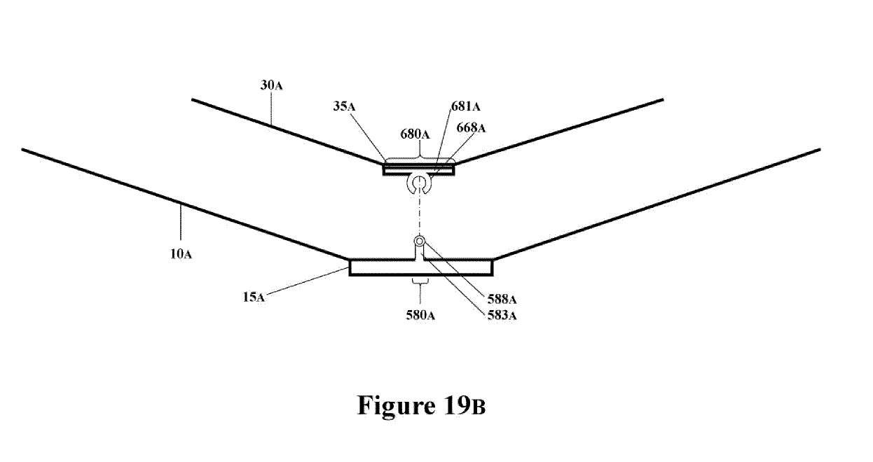

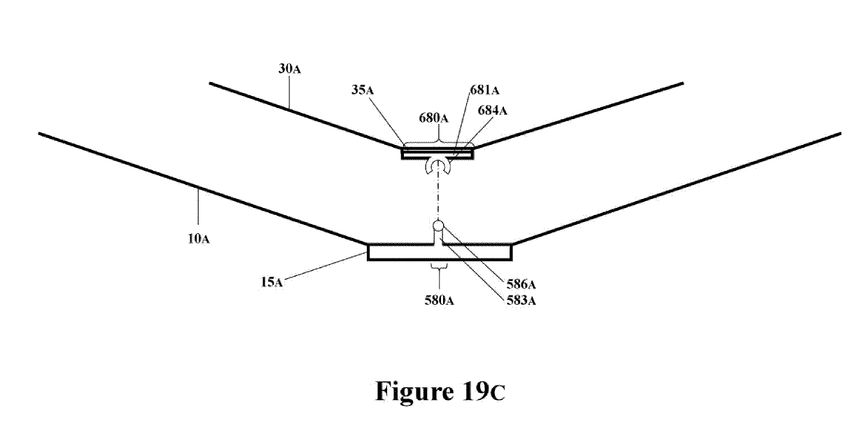

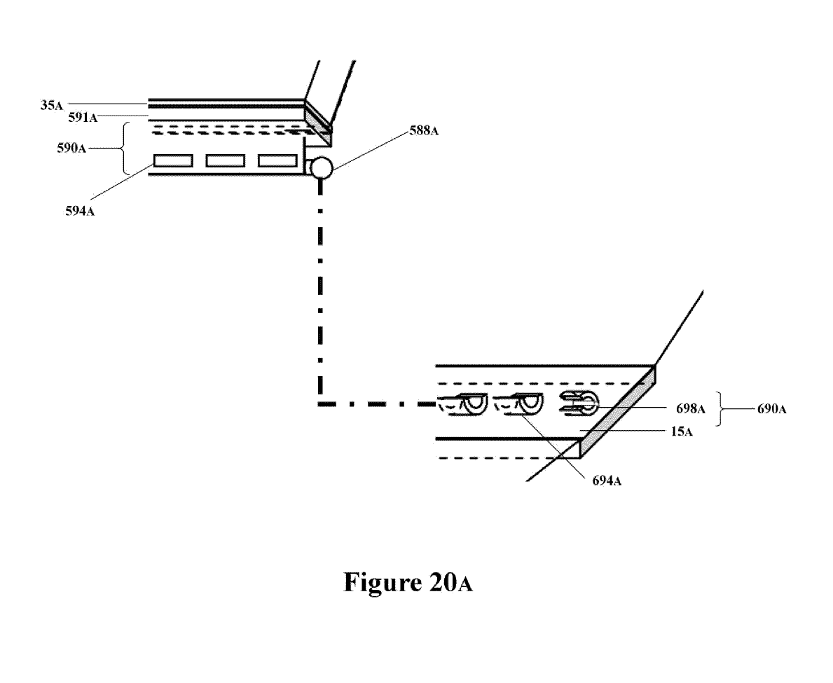

FIGS. 19A, 19B, and 19C depict a hook-and-slot mechanism with stopper elements between section member 30A and book cover 10A, according to an exemplary embodiment of the present invention. In this embodiment, there is a support leg 681A containing hook elements 684A along the exterior of the spine region 35A of the section member 30A. A complimentary slot element is located along a protruding curved element 583A containing slot elements 584A along the interior of the spine region 15A of book cover 10A. This arrangement of complimentary hooks and slots allows the section member 30A to attach to and be retained by book cover 10A by inserting and/or sliding unique protruding element 583A into the complimentary unique hook elements 684A until properly aligned to allow slot elements 584A to mate with the hook elements 684A. Stopper elements help align slotted rail 580A correctly with hooked rail 680A. A unique ball-like element 588B is located at an end of the curved protruding element 583A. Ball-like element 588B is captured through a flexible but durable hook-like element 688A, which is located along hooked rail 680A. Once in this position, section member 30A and book cover 10A can hinge open and closed, rotating upon the common axis created where hooked rail 680A and slotted rail 580A join together.

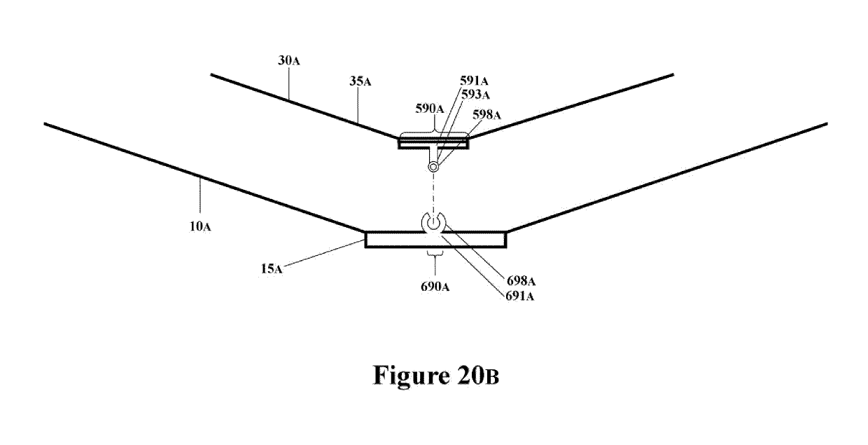

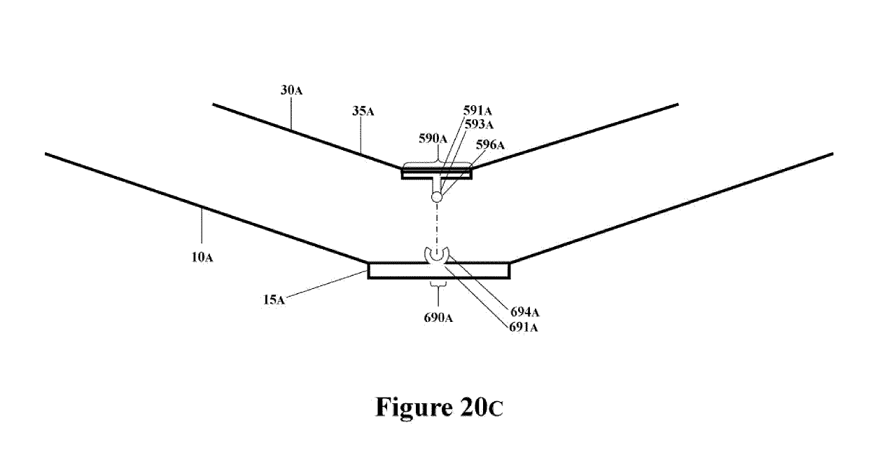

FIGS. 20A, 20B, and 20C depict a slot-and-hook mechanism with stopper elements between section member 30A and book cover 10A, according to an exemplary embodiment of the present invention. In this embodiment, there is a support leg 591A containing a protruding curved element 593A containing slot elements 594A. This slotted rail member 590A is attached along the exterior of the spine region 35A of the section member 30A. A complimentary hooking element 694A is located along the interior of the spine region 15A of book cover 10A. This arrangement of complimentary hooks and slots allows the section member 30A to attach to and be retained by book cover 10A by inserting and/or sliding unique protruding element 593A into the complimentary unique hook elements 694A until properly aligned to allow slot elements 594A to mate with the hook elements 694A. Stopper elements help align slotted rail 590A correctly with hooked rail 690A. A unique ball-like element 598A is located at an end of the curved protruding element 593A. This ball-like element is captured through a flexible but durable hook-like element 698A, which is located along hooked rail 690A. Once in this position, section member 30A and book cover 10A can hinge open and closed, rotating upon the common axis created where hooked rail 690A and slotted rail 590A join together.

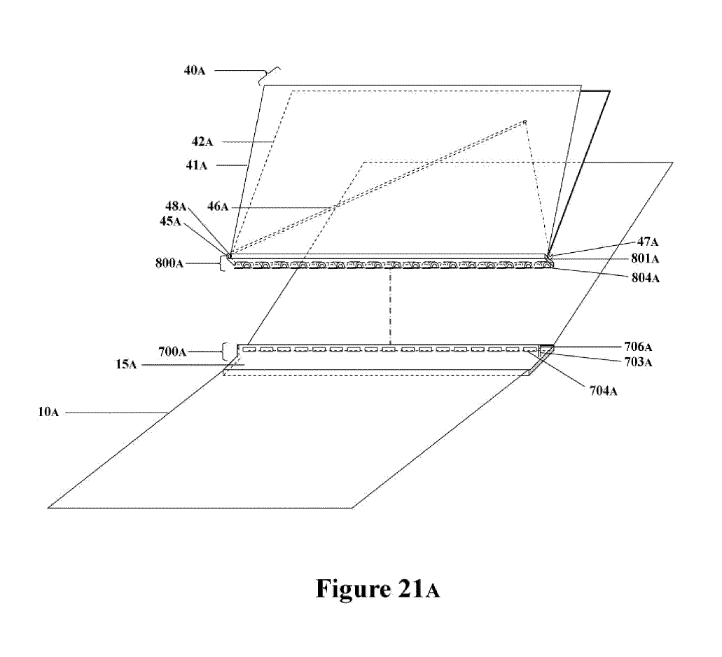

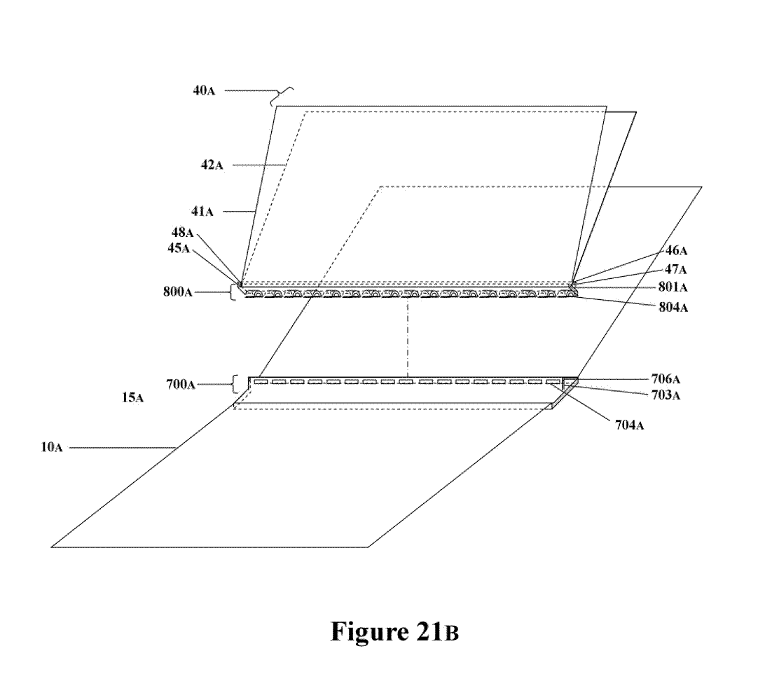

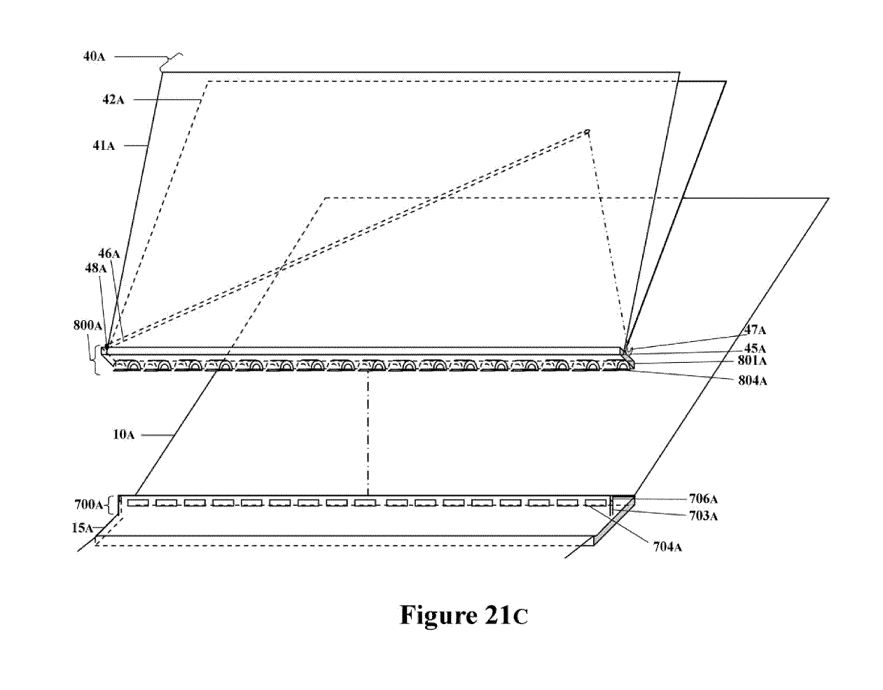

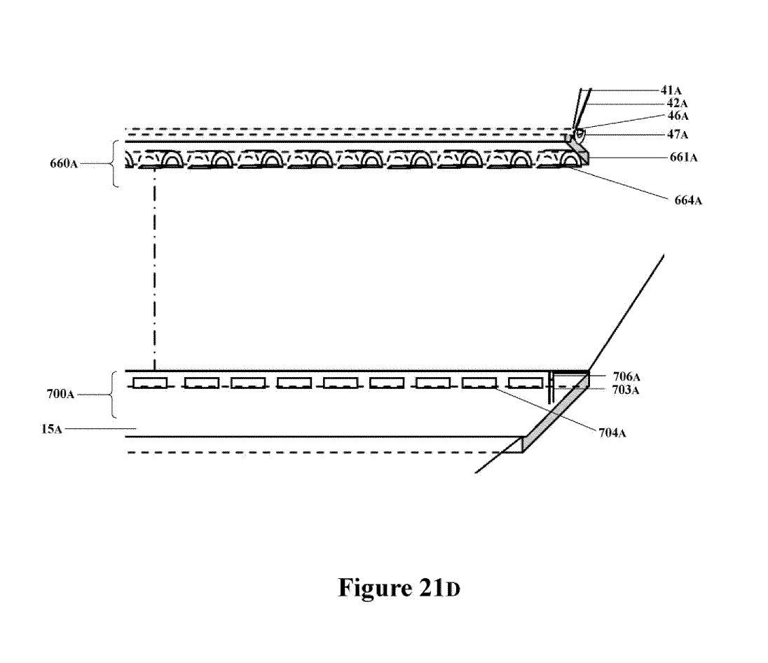

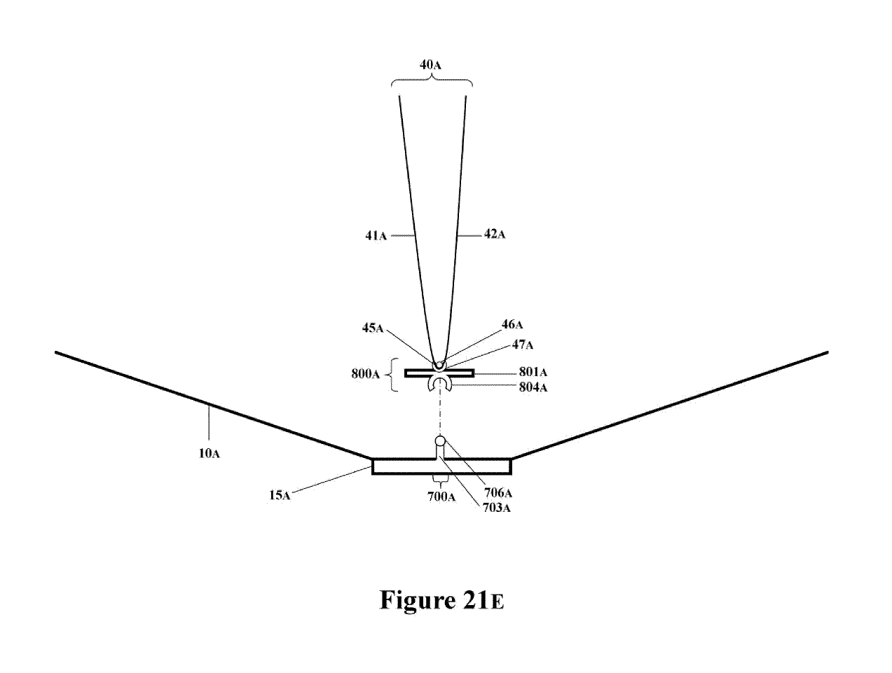

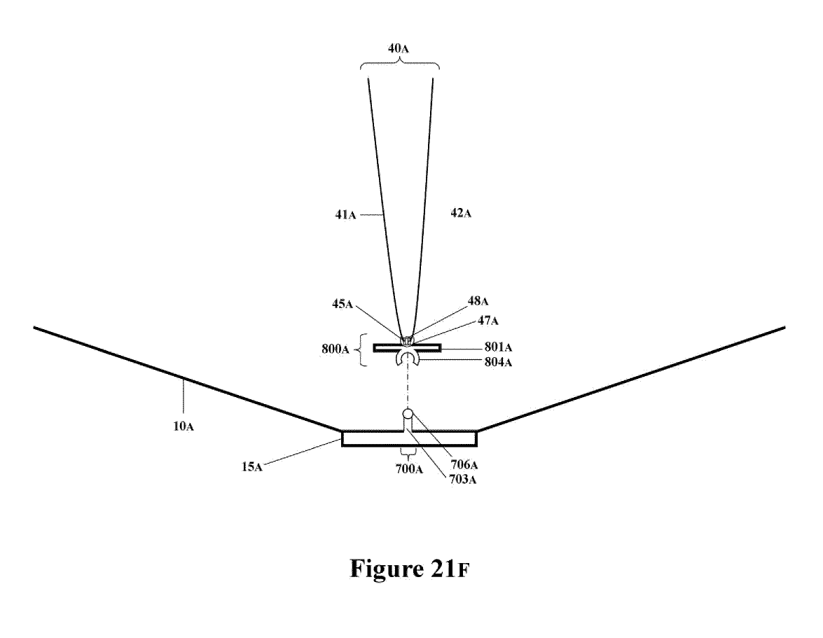

FIGS. 21A, 21B, 21C, 21D, 21E, and 21F depict a hook-and-slot mechanism between booklet member 40A and book cover 10A, according to an exemplary embodiment of the present invention. In this embodiment, there is a support leg 801A containing hook elements 804A. Support leg 801A is attached by a mechanical means along the exterior of the spine region 45A of the booklet member 40A. A cylindrical rod element 46A hinges at one end of the support leg 801A at hinge 48A and is captured at the other end through a flexible and durable hook-like element 47A. The rod travels in between booklet covers 41A and 42A, capturing the spine region 45A in the grip between cylindrical rod 46A and hooking rail support leg 801A. A complimentary slot element is located along a protruding curved element 703A containing slot elements 704A along the interior of the spine region 15A of book cover 10A. This arrangement of complimentary hooks and slots allows the booklet member 40A to attach to and be retained by book cover 10A by inserting and/or sliding unique protruding element 703A into the complimentary unique hook elements 804A until properly aligned to allow slot elements 704A to mate with the hook elements 804A. Once in this position, booklet member 40A and book cover 10A can hinge open and closed, rotating upon the common axis created where hooked rail 800A and slotted rail 700A join together.

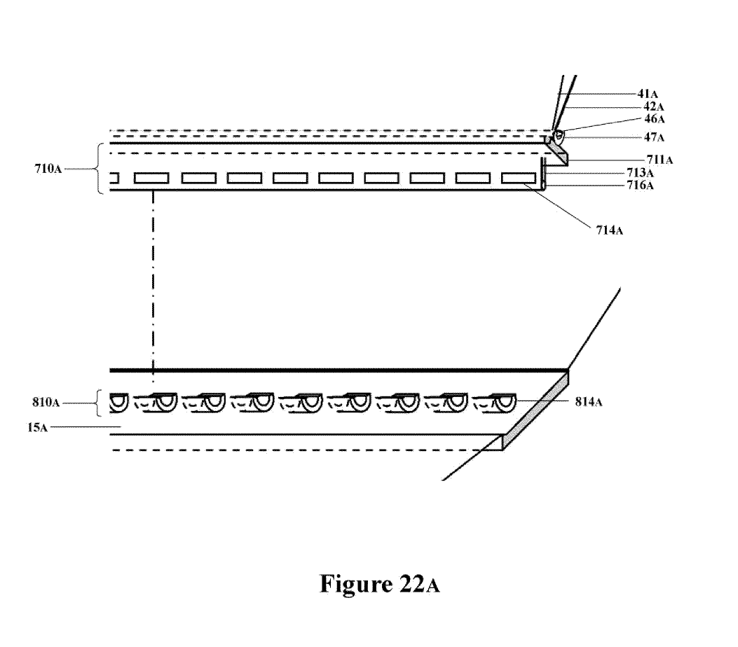

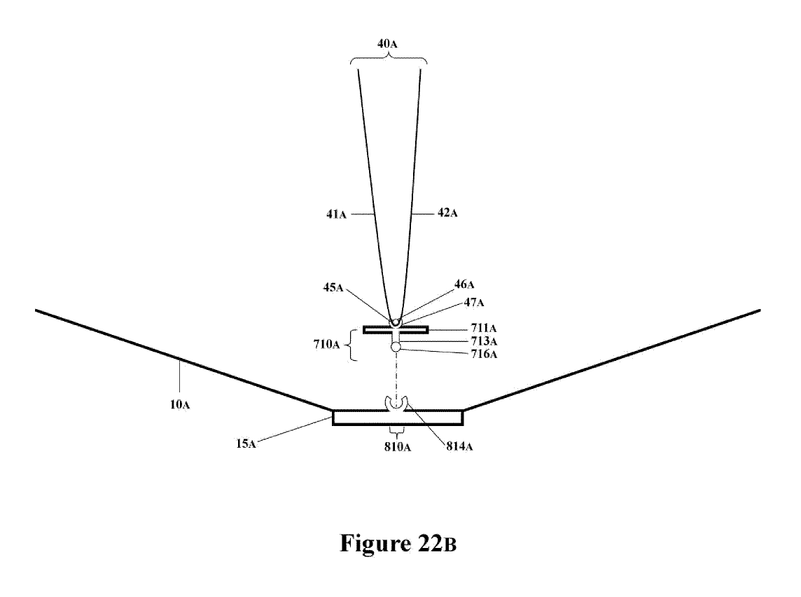

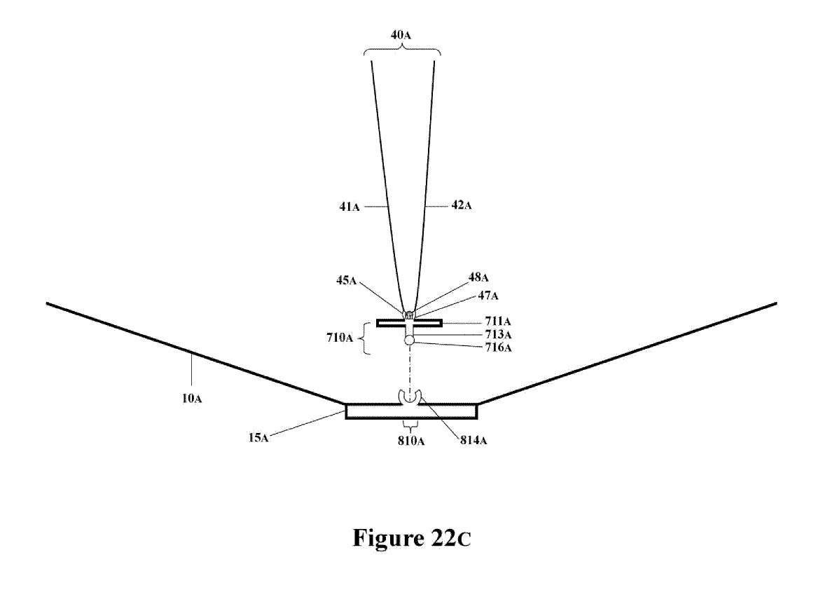

FIGS. 22 A, 22B, and 22C depict a slot-and-hook mechanism between booklet member 40A and book cover 10A, according to an exemplary embodiment of the present invention. In this embodiment, there is a support leg 811A containing hook elements 814A. Support leg 811A is attached by a mechanical means along the exterior of the spine region 45A of the booklet member 40A. A cylindrical rod element 46A hinges at one end of the support leg 811A at hinge 48A and is captured at the other end through a flexible and durable hook-like element 47A. The rod travels in between booklet covers 41A and 42A, capturing the spine region 45A in the grip between cylindrical rod 46A and hooking rail support leg 811A. A complimentary hooking element 814A is located along the interior of the spine region 15A of book cover 10A. This arrangement of complimentary hooks and slots allows the section member 30A to attach to and be retained by book cover 10A by inserting and/or sliding unique protruding element 713A into the complimentary unique hook elements 814A until properly aligned to allow slot elements 714A to mate with the hook elements 814A. Once in this position, booklet member 40A and book cover 10A can hinge open and closed, rotating upon the common axis created where hooked rail 810A and slotted rail 710A join together.

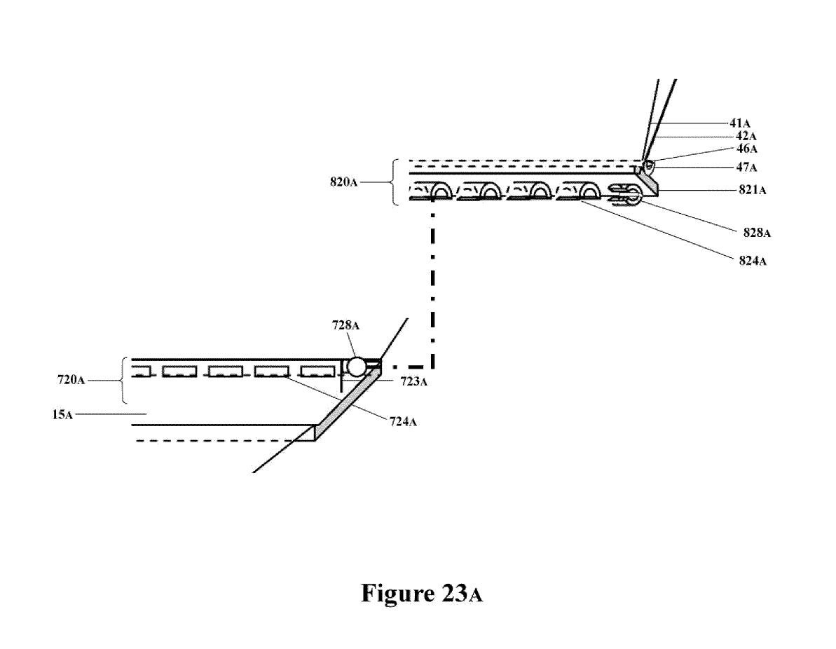

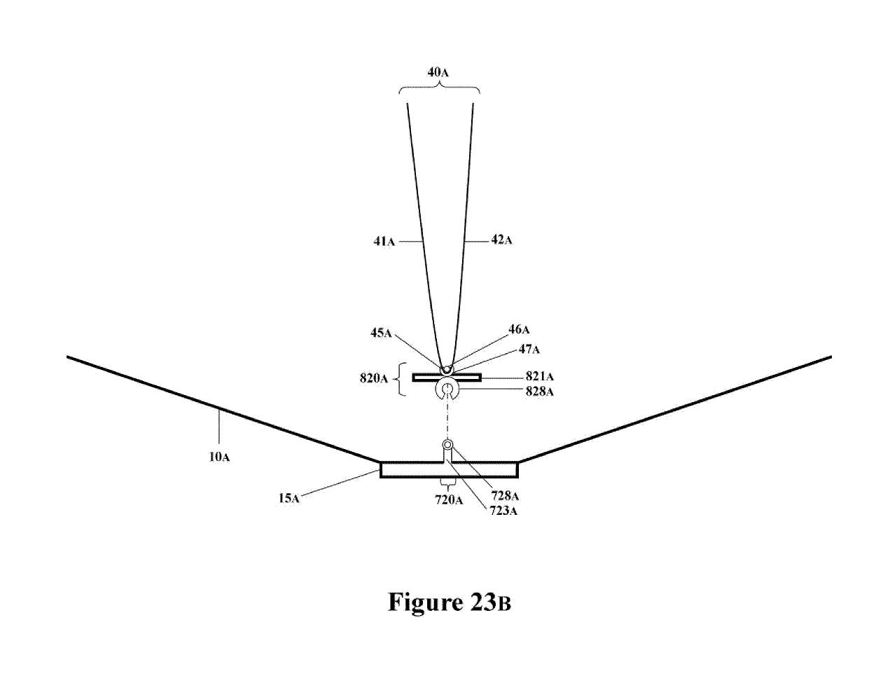

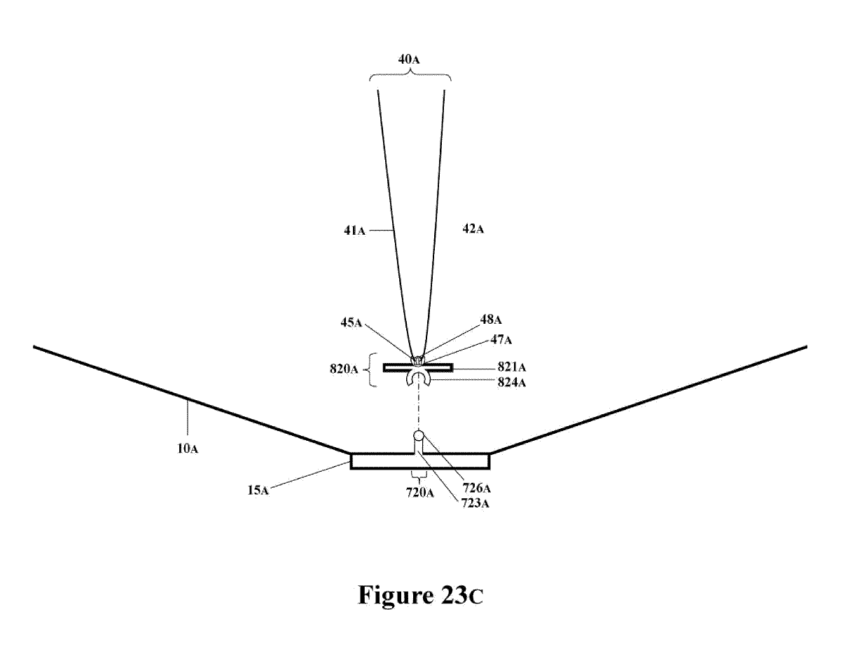

FIGS. 23A, 23B, and 23C depict a hook-and-slot mechanism with stopper elements between booklet member 40A and book cover 10A, according to an exemplary embodiment of the present invention. In this embodiment, there is a support leg 821A containing hook elements 824A. Support leg 821A is attached by a mechanical means along the exterior of the spine region 45A of the booklet member 40A. A cylindrical rod element 46A hinges at one end of the support leg 821A at hinge 48A and is captured at the other end through a flexible and durable hook-like element 47A. The rod travels in between booklet covers 41A and 42A, capturing the spine region 45A in the grip between cylindrical rod 46A and hooking rail support leg 821A. A complimentary slot element is located along a protruding curved element 723A containing slot elements 724A along the interior of the spine region 15A of book cover 10A. This arrangement of complimentary hooks and slots allows the section member 30A to attach to and be retained by book cover 10A by inserting and/or sliding unique protruding element 723A into the complimentary unique hook elements 824A until properly aligned to allow slot elements 724A to mate with the hook elements 824A. Stopper elements help align slotted rail 720A correctly with hooked rail 820A. A unique ball-like element 728A is located at an end of the curved protruding element 723A. This ball-like element is captured through a flexible but durable hook-like element 828A, which is located along hooked rail 820A. Once in this position, booklet member 40A and book cover 10A can hinge open and closed, rotating upon the common axis created where hooked rail 820A and slotted rail 720A join together.

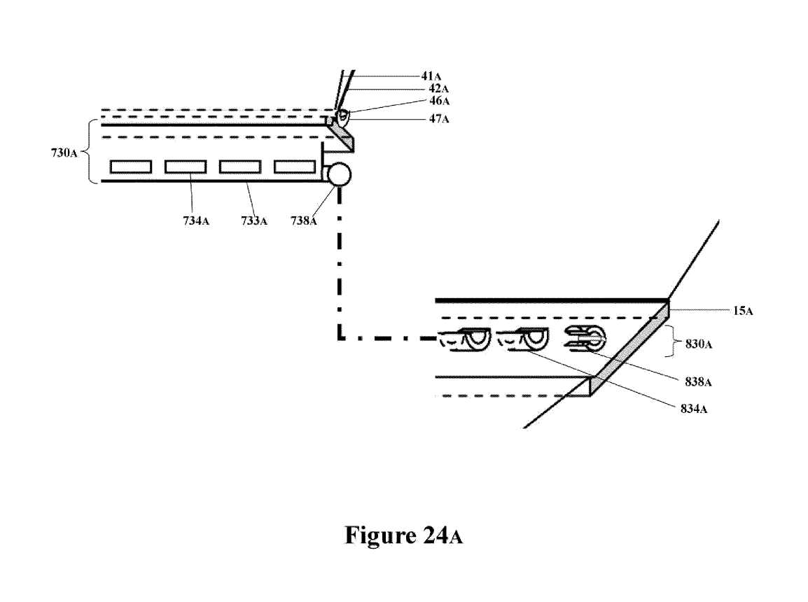

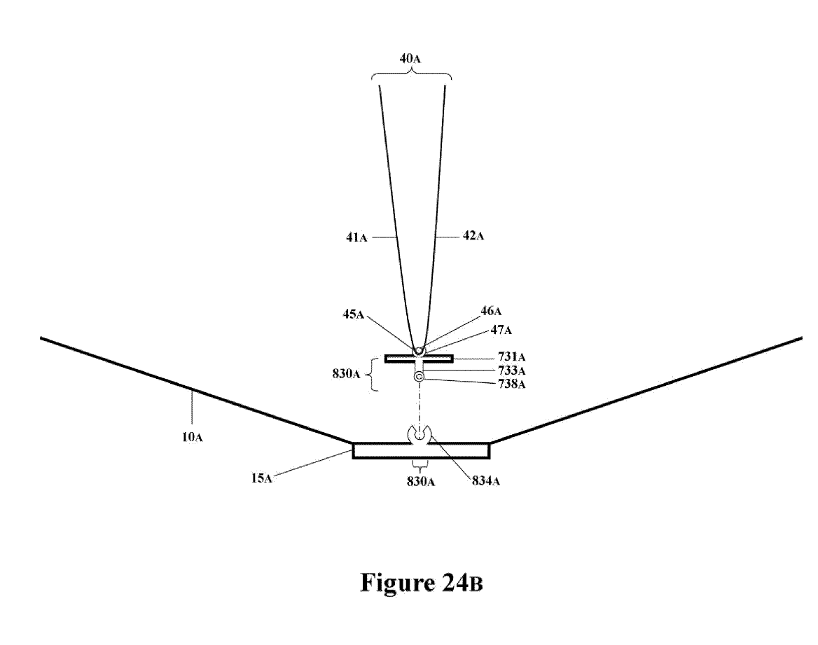

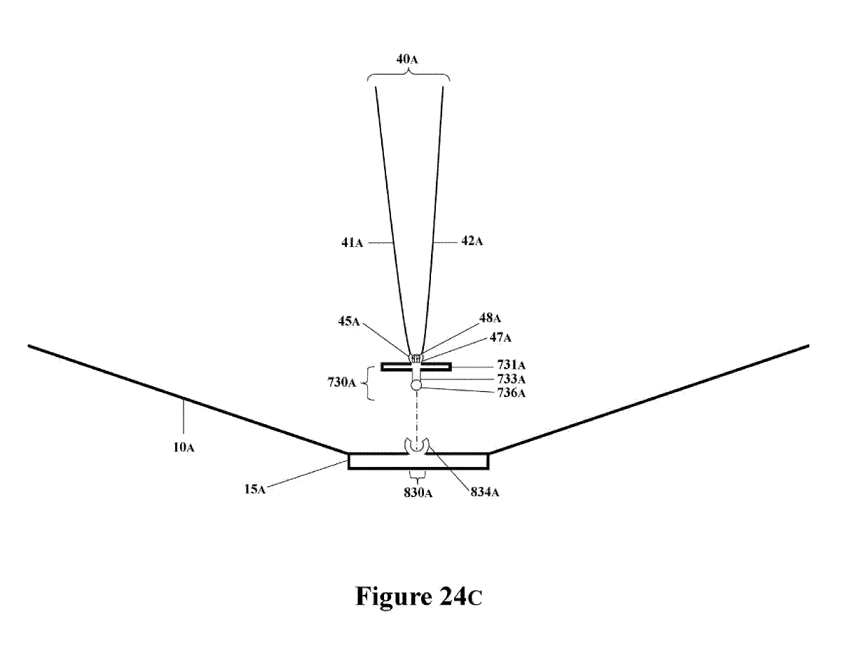

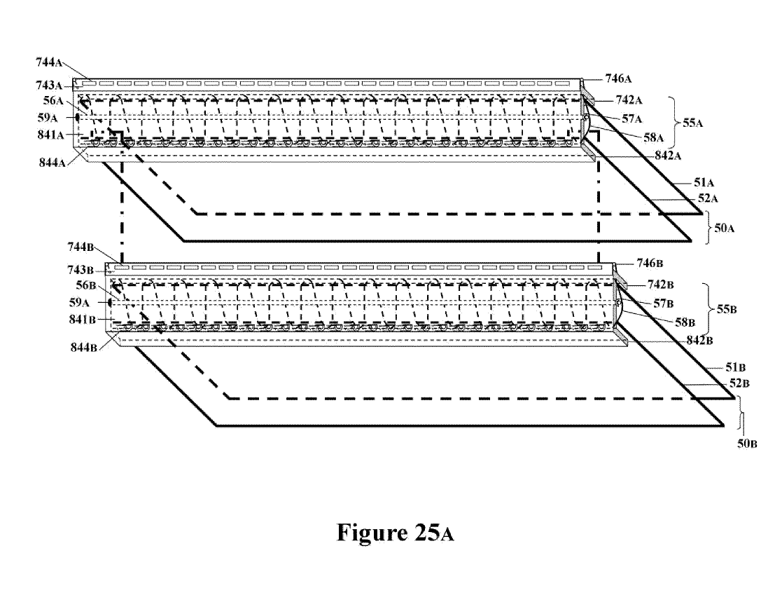

FIGS. 24A, 24B, and 24C depict a slot-and-hook mechanism with stopper elements between booklet member 40A and book cover 10A, according to an exemplary embodiment of the present invention. In this embodiment, there is a support leg 731A containing hook elements 834A. Support leg 731A is attached by a mechanical means along the exterior of the spine region 45A of the booklet member 40A. A cylindrical rod element 46A hinges at one end of the support leg 731A at hinge 48A and is captured at the other end through a flexible and durable hook-like element 47A. The rod travels in between booklet covers 41A and 42A, capturing the spine region 45A in the grip between cylindrical rod 46A and hooking rail support leg 731A. A complimentary hooking element 834A is located along the interior of the spine region 15A of book cover 10A. This arrangement of complimentary hooks and slots allows the booklet member 40A to attach to and be retained by book cover 10A by inserting and/or sliding unique protruding element 733A into the complimentary unique hook elements 834A until properly aligned to allow slot elements 734A to mate with the hook elements 834A. Stopper elements help align slotted rail 730A correctly with hooked rail 830A. A unique ball-like element 738B is located at an end of the curved protruding element 733A. This ball-like element is captured through a flexible but durable hook-like element 838A, which is located along hooked rail 830A. Once in this position, booklet member 40A and book cover 10A can hinge open and closed, rotating upon the common axis created where hooked rail 830A and slotted rail 730A join together.

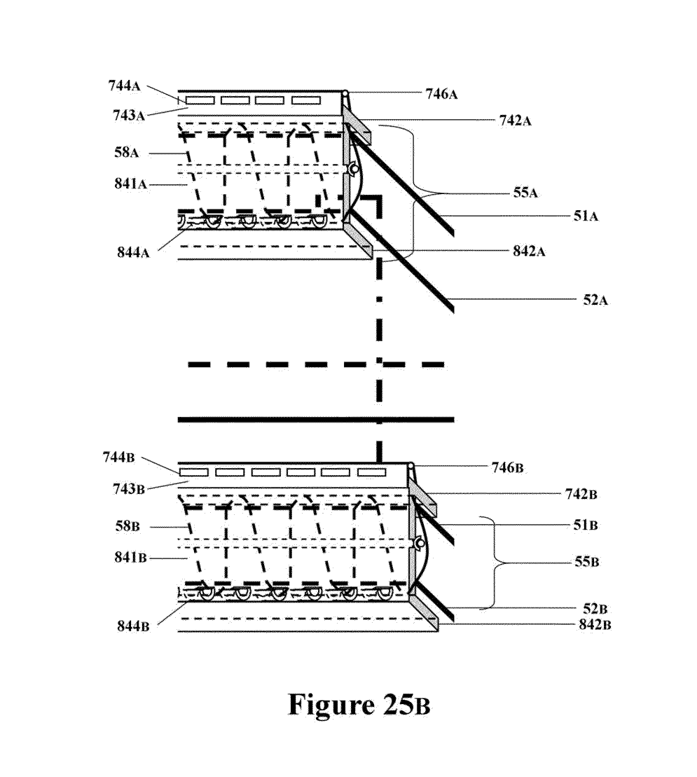

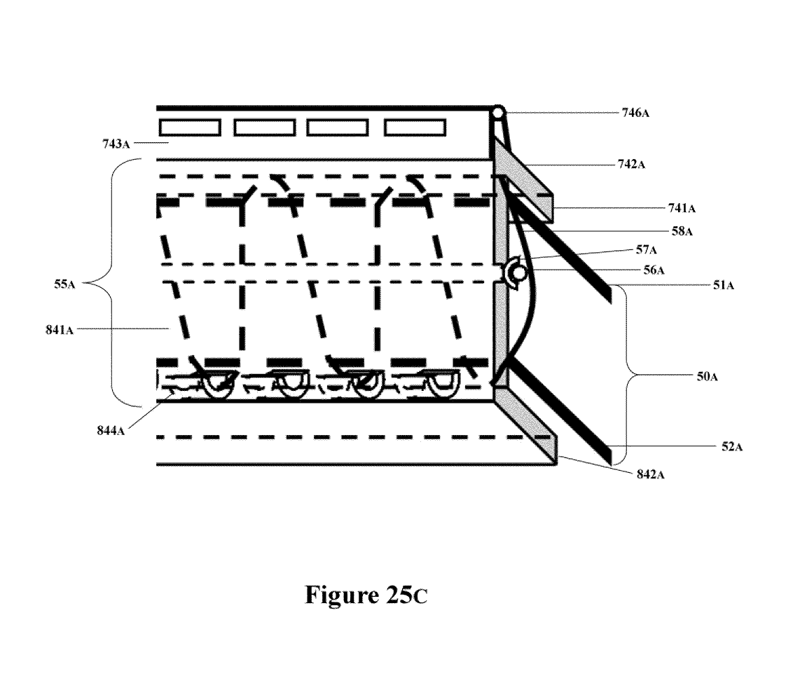

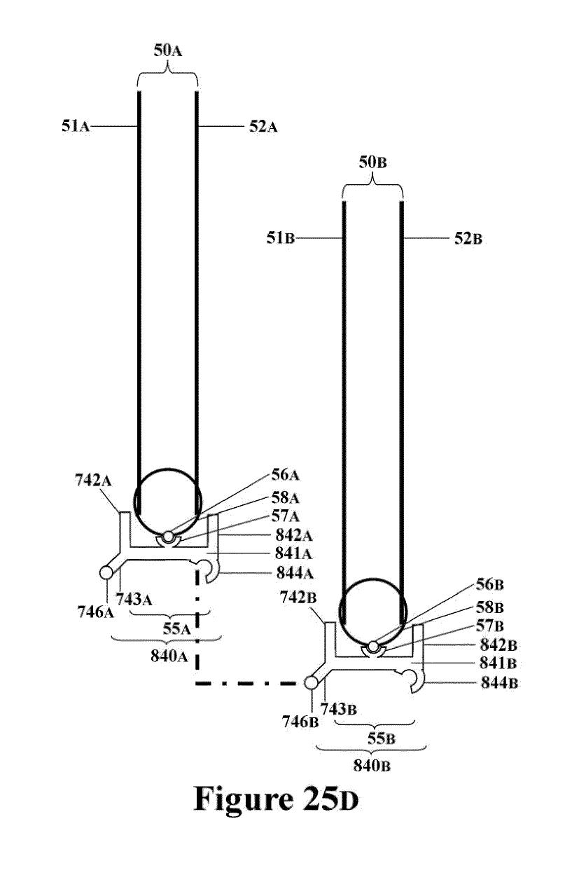

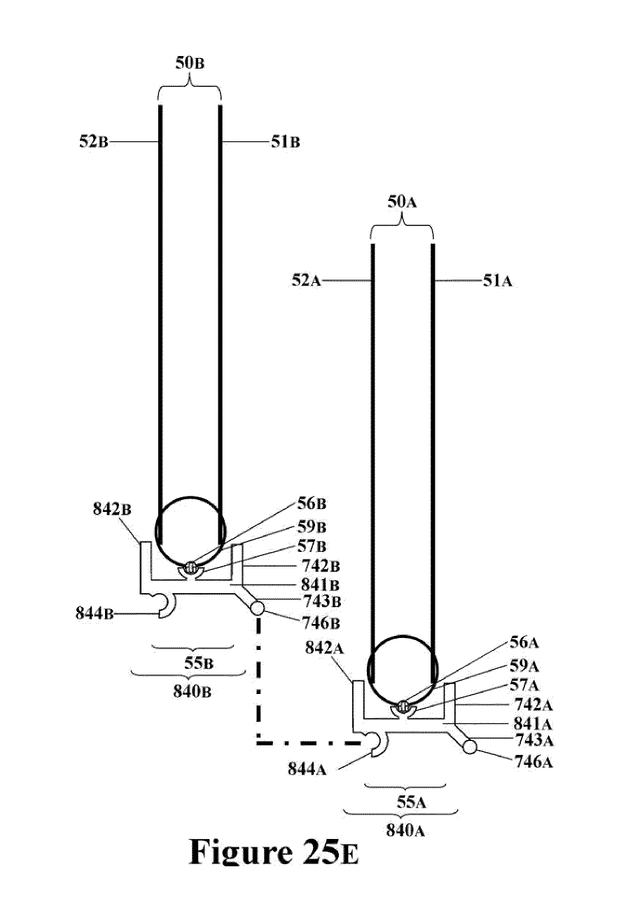

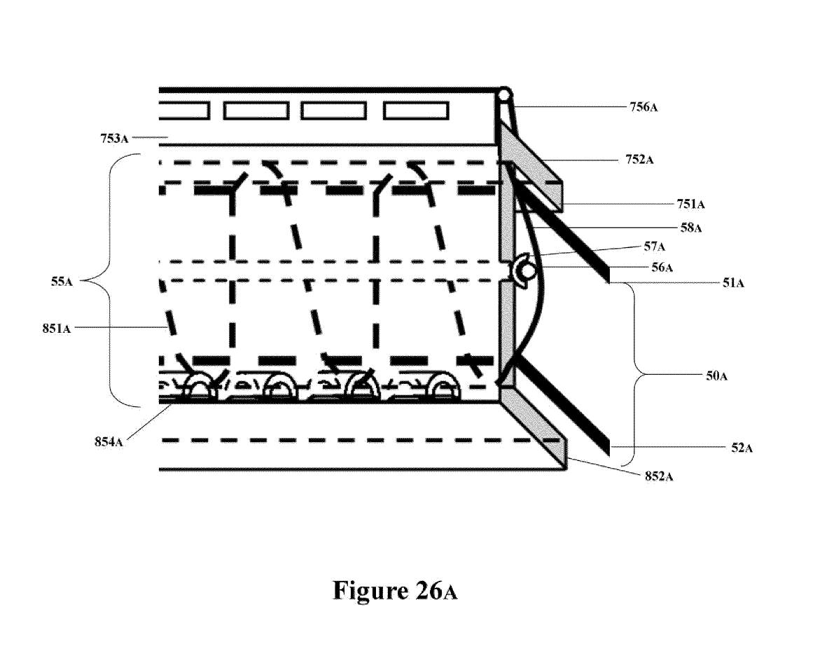

FIGS. 25A, 25B, 25C, 25D, and 25E depict a hook-and-slot mechanism between stitch-bound members 50A and 50B, according to an exemplary embodiment of the present invention. In this embodiment, there is a three-walled support leg 841A containing upward-facing hook elements 844A along one edge of the three-walled support leg 841A and slot elements 744A within the curved protrusion element 743A along the opposite edge of the three-walled support leg 841A. To limit interference between stitch-bound member 50A and 50B, support legs 742A and 842A anchor support leg 841A in a like manner to how support legs 742B and 842B anchor support leg 841B and cover the stitch elements 58B along stitch-bound member 50B. Attachment member 840A is secured to stitch-bound member 50A through a mechanical means. A cylindrical rod element 56A hinges at one end of the three-walled support leg 841A at hinge 59A and is captured at the other end through a flexible and durable hook-like element 57A. The rod travels in along the stitches 58A along the spine region 55A of stitch bound member 50A, capturing the spine region 55A in the grip between cylindrical rod 56A and hooking rail support leg 841A. The attachment member 840B containing like attachment elements 743B, 744B, and 844B is attached in a like manner to stitch-bound member 50B. This arrangement of complimentary hooks and slots allows the stitch-bound member 50A to attach to and be retained by stitch-bound member 50B by inserting and/or sliding unique protruding element 743B into the complimentary unique hook elements 844A until properly aligned to allow slot elements 744B to mate with the hook elements 844A. Once in this position, stitch-bound members 50A and 50B can hinge open and closed, rotating upon the common axis created where hooked rail 840A and slotted rail 740B join together.

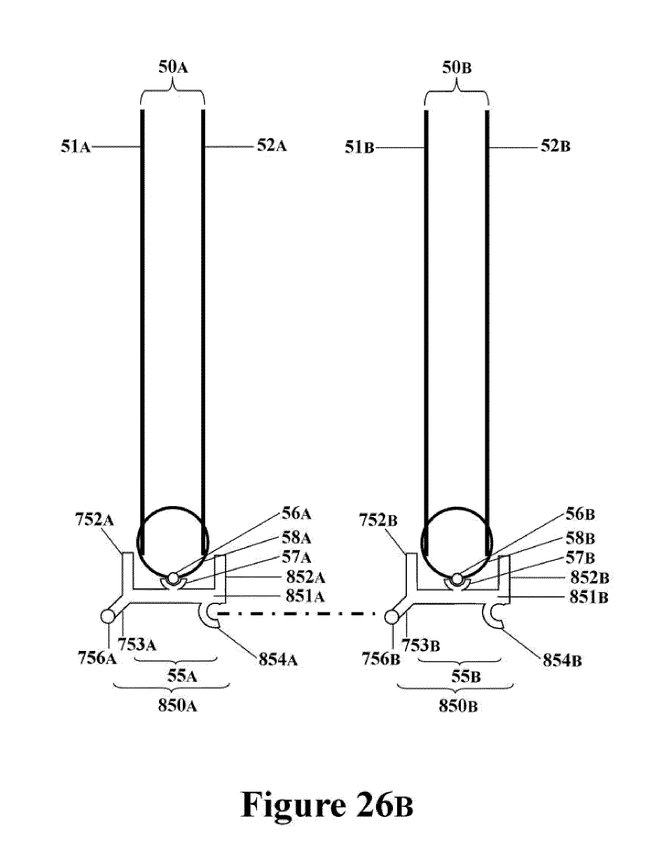

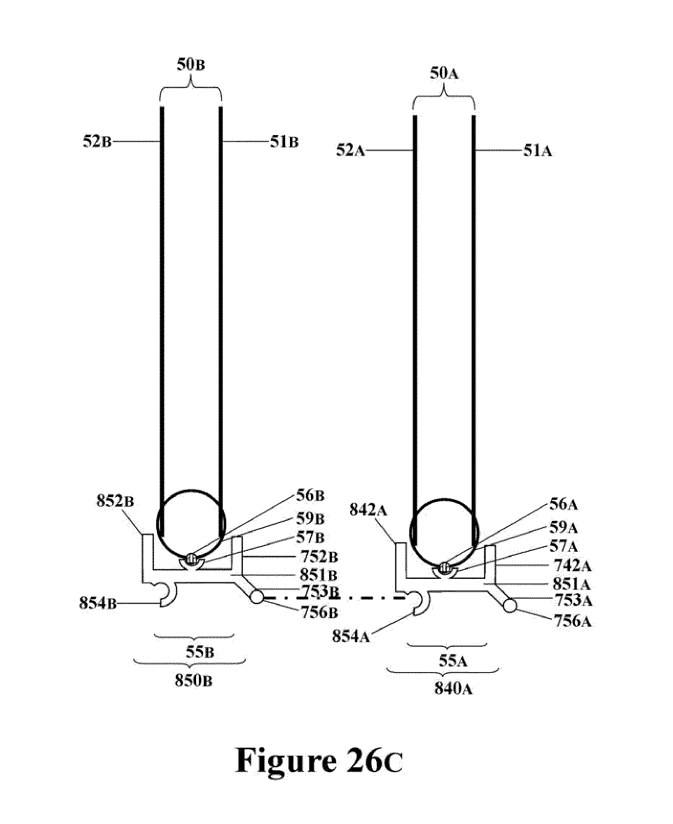

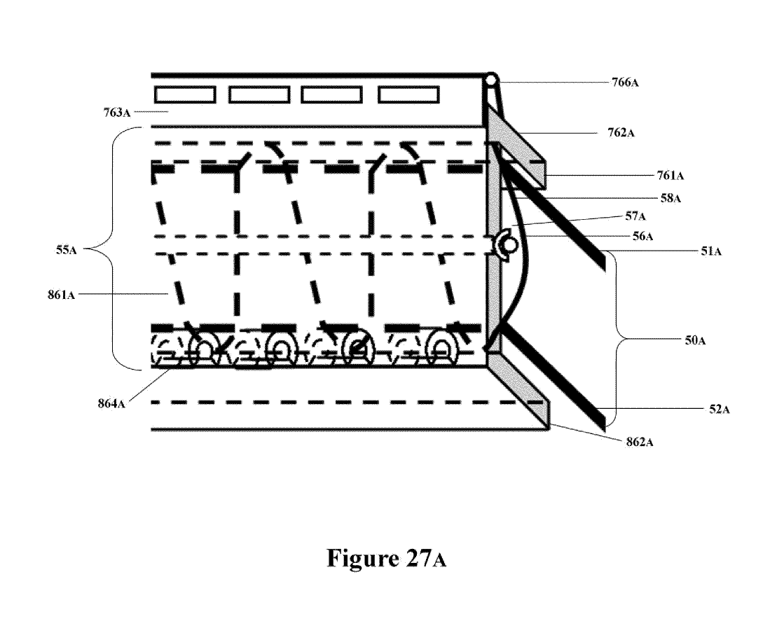

FIGS. 26A, 26B, and 26C depict another hook-and-slot mechanism between stitch-bound members 50A and 50B, according to an exemplary embodiment of the present invention. In this embodiment, there is a three-walled support leg 851A containing downward-facing hook elements 854A along one edge of the three-walled support leg 851A and slot elements 754A within the curved protrusion element 753A along the opposite edge of the three-walled support leg 851A. To limit interference between stitch-bound member 50A and 50B, support legs 752A and 852A anchor support leg 851A in a like manner to how support legs 752B and 852B anchor support leg 851B and cover the stitch elements 58B along stitch-bound member 50B. Attaching member 850A is secured to stitch-bound member 50A through a mechanical means. A cylindrical rod element 56A hinges at one end of the three-walled support leg 851A at hinge 59A and is captured at the other end through a flexible and durable hook-like element 57A. The rod travels in along the stitches 58A along the spine region 55A of stitch bound member 50A, capturing the spine region 55A in the grip between cylindrical rod 56A and hooking rail support leg 851A. Attachment member 850B contains like attachment elements 753B, 754B, and 854B is secured in a like manner to stitch-bound member 50B. This arrangement of complimentary hooks and slots allows the stitch-bound member 50A to attach to and be retained by stitch-bound member 50B by inserting and/or sliding unique protruding element 753B into the complimentary unique hook elements 854A until properly aligned to allow slot elements 754B to mate with the hook elements 854A. Once in this position, stitch-bound members 50A and 50B can hinge open and closed, rotating upon the common axis created where hooked rail 850A and slotted rail 750B join together.

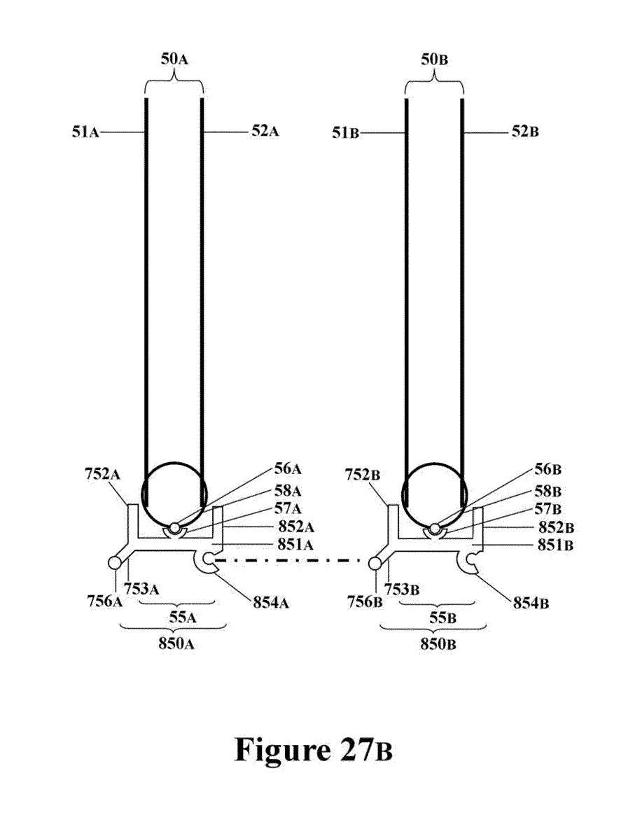

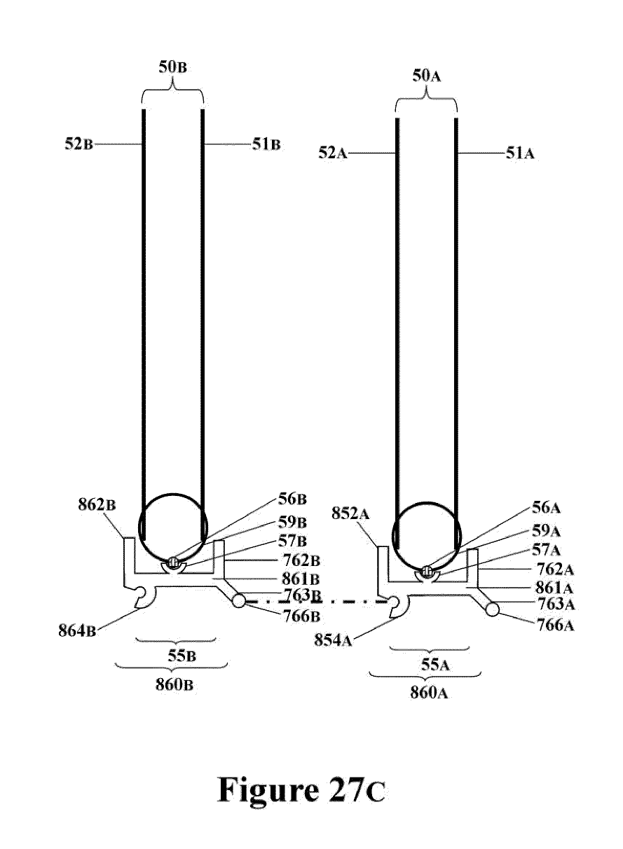

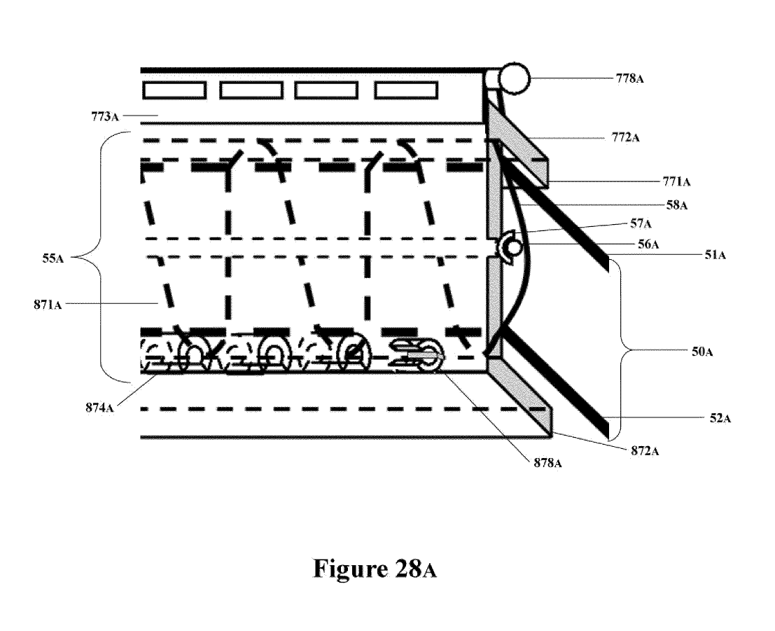

FIGS. 27A, 27B, and 27C depict a different hook-and-slot mechanism between stitch-bound members 50A and 50B, according to an exemplary embodiment of the present invention. In this embodiment, there is a three-walled support leg 861A containing extended and downward-facing hook elements 864A along one edge of the three-walled support leg 861A and slot elements 764A within the curved protrusion element 763A along the opposite edge of the three-walled support leg 861A. The geometry of these extended hook elements 864A make an even more defined channel through which the slotted rail 763B can slide through, aiding in the ease of use and zip-like attachment technique. To limit interference between stitch-bound member 50A and 50B, support legs 762A and 862A anchor support leg 861A in a like manner to how support legs 762B and 862B anchor support leg 861B and cover the stitch elements 58B along stitch-bound member 50B. Attachment member 860A is secured to stitch-bound member 50A through a mechanical means. A cylindrical rod element 56A hinges at one end of the three-walled support leg 861A at hinge 59A and is captured at the other end through a flexible and durable hook-like element 57A. The rod travels in along the stitches 58A along the spine region 55A of stitch bound member 50A, capturing the spine region 55A in the grip between cylindrical rod 56A and hooking rail support leg 861A. Attachment member 860B contains like attachment elements 763B, 764B, and 864B is secured in a like manner to stitch-bound member 50B. This arrangement of complimentary hooks and slots allows the stitch-bound member 50A to attach to and be retained by stitch-bound member 50B by inserting and/or sliding unique protruding element 763B into the complimentary unique hook elements 864A until properly aligned to allow slot elements 764B to mate with the hook elements 864A. Once in this position, stitch-bound members 50A and 50B can hinge open and closed, rotating upon the common axis created where hooked rail 860A and slotted rail 760B join together.

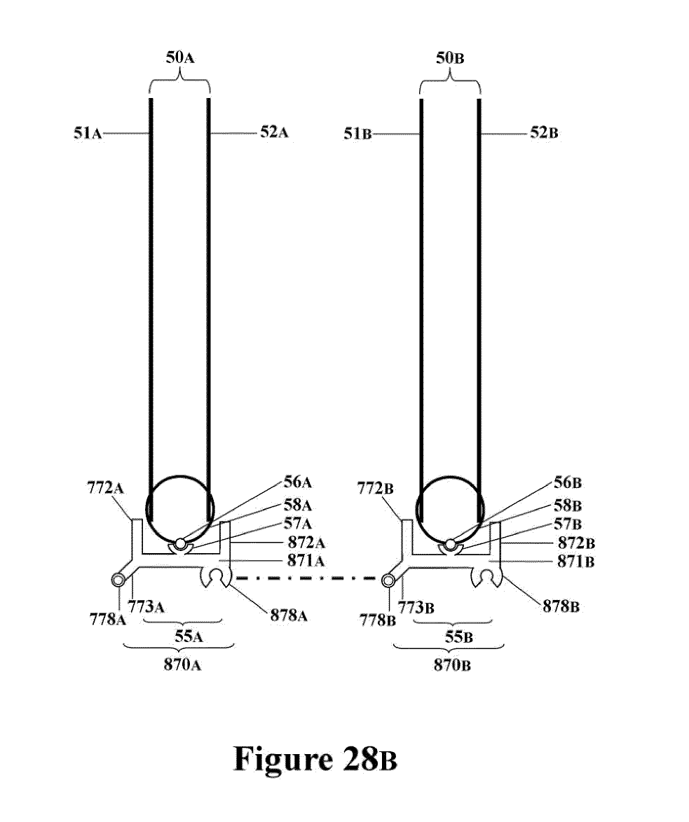

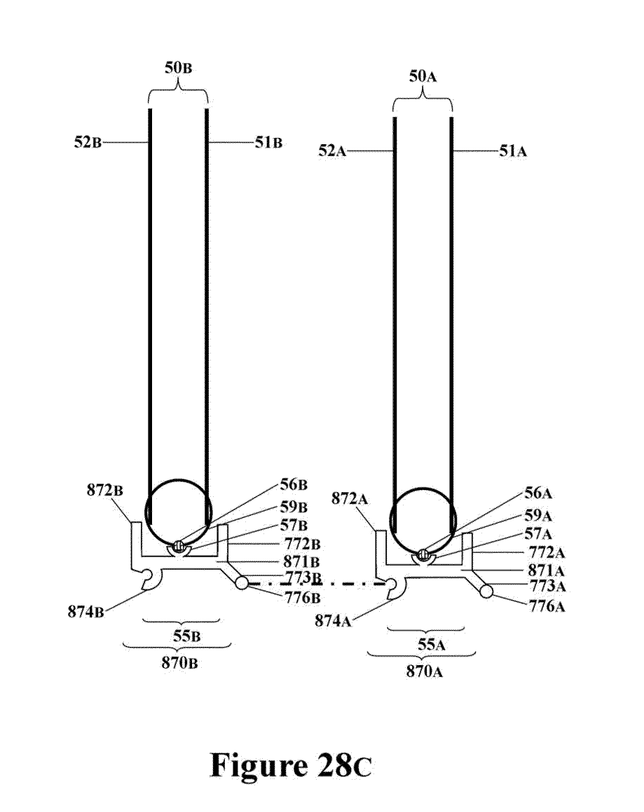

FIGS. 28A, 28B, and 28C depict a hook-and-slot mechanism with stopper elements between stitch-bound members 50A and 50B, according to an exemplary embodiment of the present invention. In this embodiment, there is a three-walled support leg 871A containing extended and downward-facing hook elements 874A along one edge of the three-walled support leg 871A and slot elements 774A within the curved protrusion element 773A along the opposite edge of the three-walled support leg 871A. The geometry of these extended hook elements 874A make an even more defined channel through which the slotted rail 773B can slide through, aiding in the ease of use and zip-like attachment technique. To limit interference between stitch-bound member 50A and 50B, support legs 772A and 872A anchor support leg 871A in a like manner to how support legs 772B and 872B anchor support leg 861B and cover the stitch elements 58B along stitch-bound member 50B. Attachment member 870A is secured to stitch-bound member 50A through a mechanical means. A cylindrical rod element 56A hinges at one end of the three-walled support leg 871A at hinge 59A and is captured at the other end through a flexible and durable hook-like element 57A. The rod travels in along the stitches 58A along the spine region 55A of stitch bound member 50A, capturing the spine region 55A in the grip between cylindrical rod 56A and hooking rail support leg 871A. Attachment member 870B contains like attachment elements 773B, 774B, and 874B is secured in a like manner to stitch-bound member 50B. This arrangement of complimentary hooks and slots allows the stitch-bound member 50A to attach to and be retained by stitch-bound member 50B by inserting and/or sliding unique protruding element 773B into the complimentary unique hook elements 874A until properly aligned to allow slot elements 774B to mate with the hook elements 874A. Stopper elements help align attachment members 870B and 870A. A unique ball-like element 778B is located at an end of the curved protruding element 773B. This ball-like element is captured through a flexible but durable hook-like element 878A, which is located along attachment member 870A. Once in this position, stitch-bound members 50A and 50B can hinge open and closed, rotating upon the common axis created where hooked rail 870A and slotted rail 770B join together.

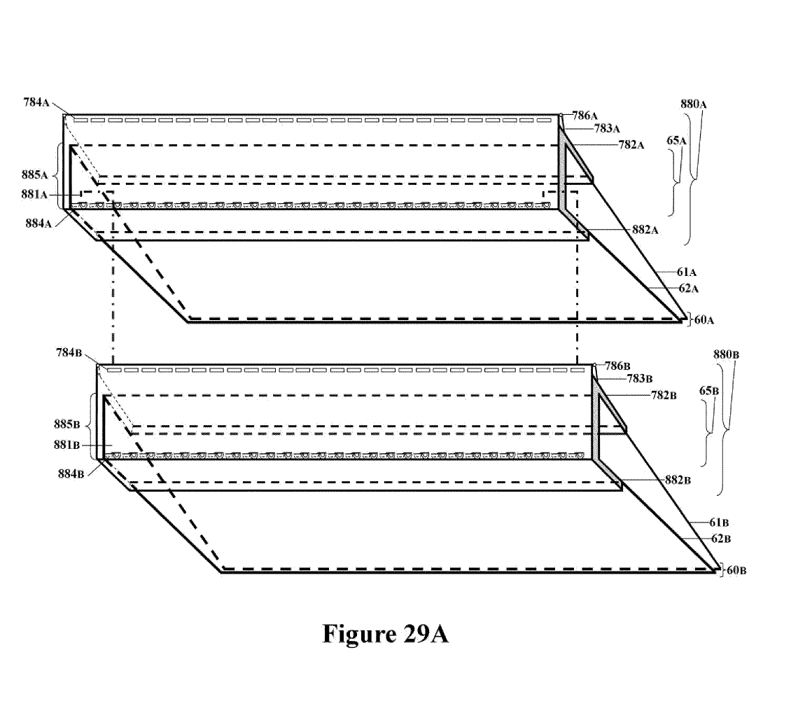

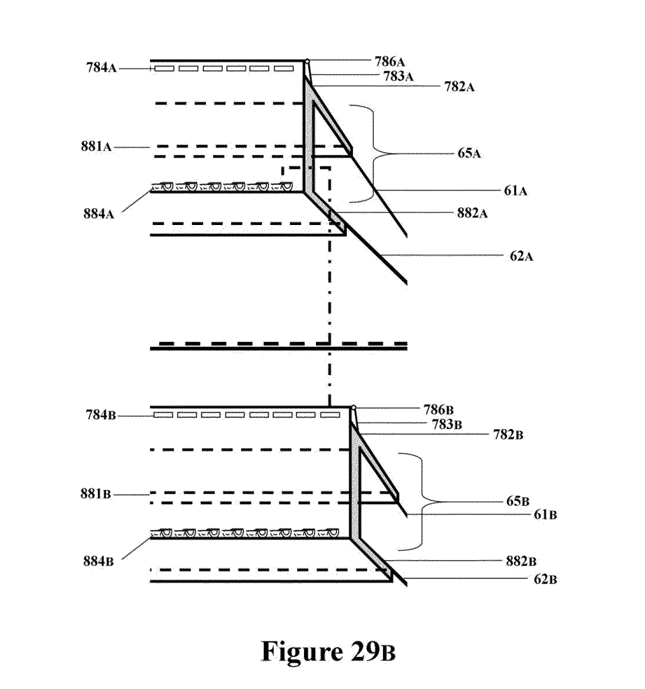

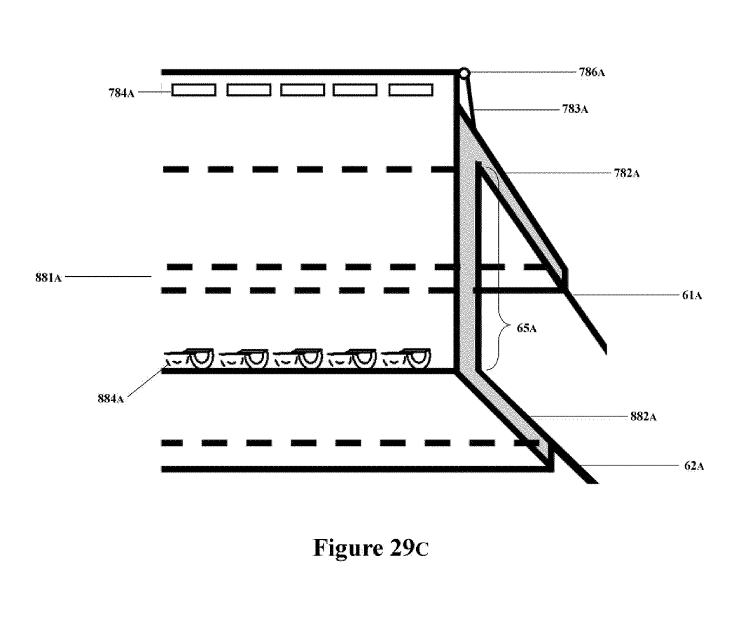

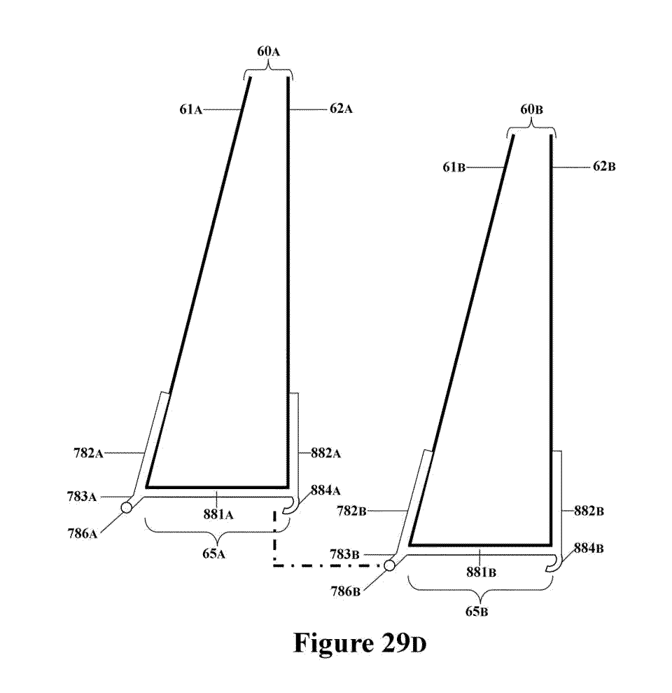

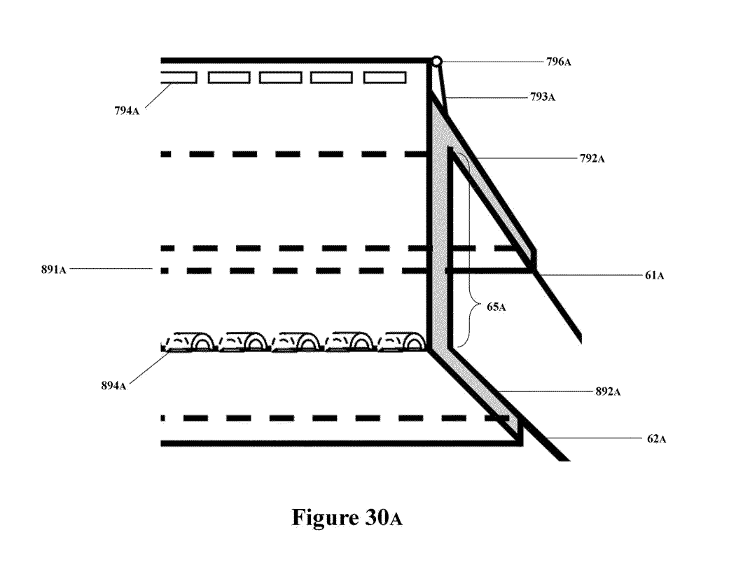

FIGS. 29A, 29B, 29C, and 29D depict a hook-and-slot mechanism between unbound print members 60A and 60B, according to an exemplary embodiment of the present invention. In this embodiment, there is a three-walled tension support leg 881A containing upward-facing hook elements 884A along one edge of support leg 881A and slot elements 784A within the curved protrusion element 783A along the opposite edge of support leg 881A. Unbound member 60A is inserted and/or slid through the support legs 782A and 882A, creating a tension along the spine region 65A of unbound print member 60A. This tension non-permanently secures attachment member 880A to 60A. Attachment member 880B contains like attachment elements 783B, 784B, and 884B and is secured in a like manner to unbound print member 60B. This arrangement of complimentary hooks and slots allows the unbound member 60A to attach to and be retained by unbound member 60B by inserting and/or sliding unique protruding element 783B into the complimentary unique hook elements 884A until properly aligned to allow slot elements 784B to mate with the hook elements 884A. Once in this position, stitch-bound members 60A and 60B can hinge open and closed, rotating upon the common axis created where hooked rail 880A and slotted rail 780B join together.

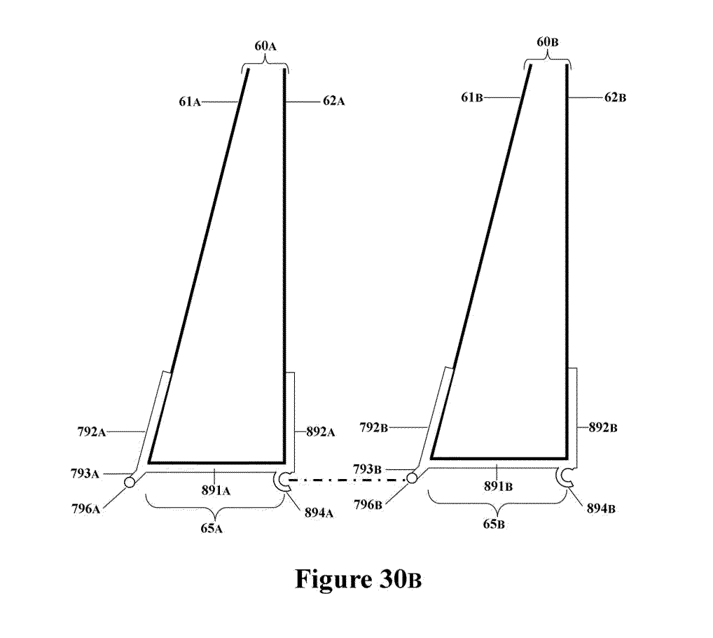

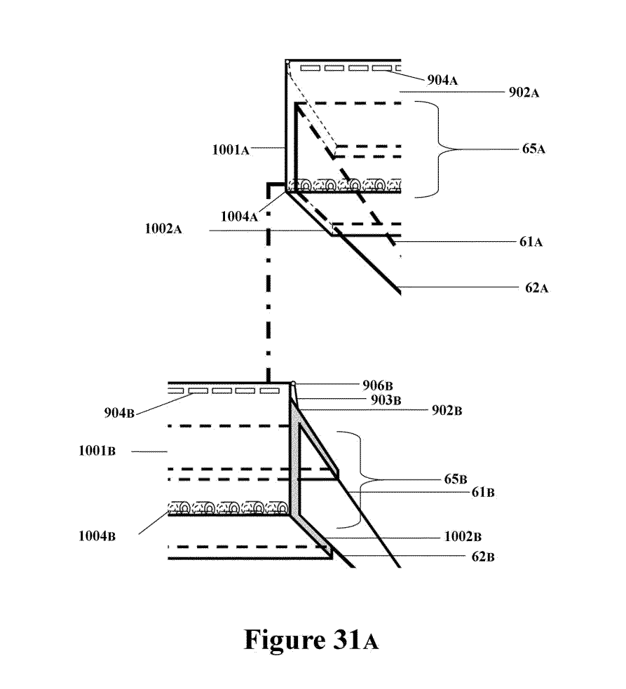

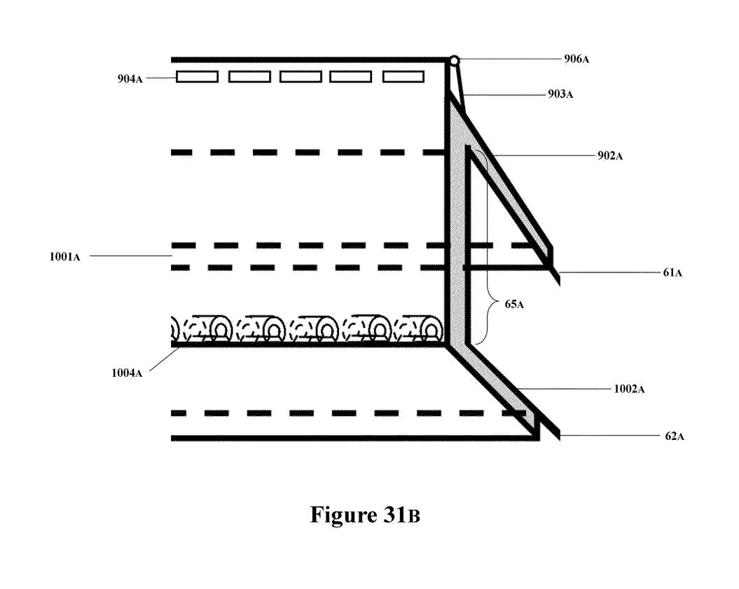

FIGS. 30A and 30B depict another hook-and-slot mechanism between unbound print members 60A and 60B, according to an exemplary embodiment of the present invention. In this embodiment, there is a three-walled tension support leg 891A containing downward-facing hook elements 894A along one edge of support leg 891A and slot elements 794A within the curved protrusion element 793A along the opposite edge of support leg 891A. Unbound member 60A is inserted and/or slid through the support legs 792A and 892A, creating a tension along the spine region 65A of unbound print member 60A. This tension non-permanently secures attachment member 890A to 60A, as seen in FIG. 29A. Attachment member of unbound member 60B contains like attachment elements 793B, 794B, and 894B and is secured in a like manner to unbound print member 60B. This arrangement of complimentary hooks and slots allows the unbound member 60A to attach to and be retained by unbound member 60B by inserting and/or sliding unique protruding element 793B into the complimentary unique hook elements 894A until properly aligned to allow slot elements of unbound member 60B to mate with the hook elements 894A. Once in this position, stitch-bound members 60A and 60B can hinge open and closed, rotating upon the common axis created where hooked rail 890A and slotted rail of unbound member 60B join together.

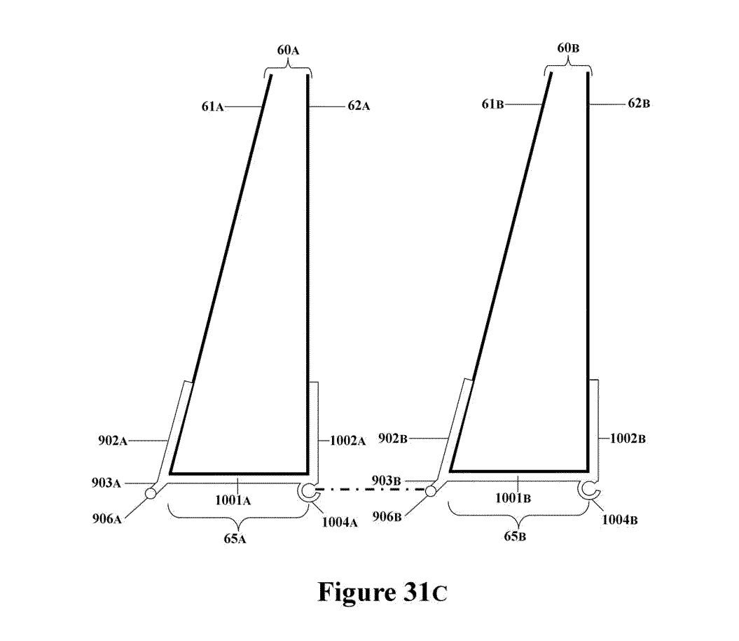

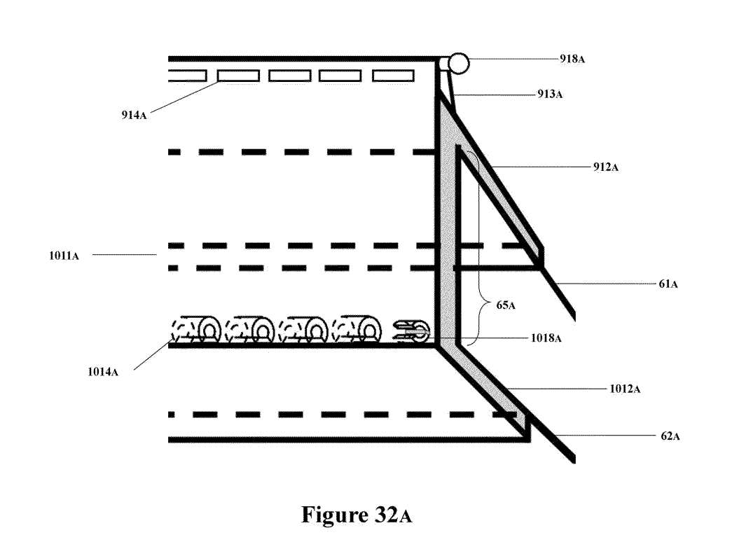

FIGS. 31A, 31B and 31C depict a different hook-and-slot mechanism between unbound print members 60A and 60B, according to an exemplary embodiment of the present invention. In this embodiment, there is a three-walled tension support leg 1001A containing extended downward-facing hook elements 1004A along one edge of support leg 1001A and slot elements 904A within the curved protrusion element 903A along the opposite edge of support leg 901A. The geometry of these extended hook elements 1004A make an even more defined channel through which the slotted rail 903B can slide through, aiding in the ease of use and zip-like attachment technique. Unbound member 60A is inserted and/or slid through the support legs 902A and 1002A, creating a tension along the spine region 65A of unbound print member 60A. This tension non-permanently secures attachment member of unbound member 60A to unbound member 60A. Attachment member of unbound member 60B contains like attachment elements 903B, 904B, and 1004B and is secured in a like manner to unbound print member 60B. This arrangement of complimentary hooks and slots allows the unbound member 60A to attach to and be retained by unbound member 60B by inserting and/or sliding unique protruding element 903B into the complimentary unique hook elements 1004A until properly aligned to allow slot elements of unbound member 60B to mate with the hook elements 1004A. Once in this position, stitch-bound members 60A and 60B can hinge open and closed, rotating upon the common axis created where hooked rail 1000A and slotted rail of unbound member 60B join together.

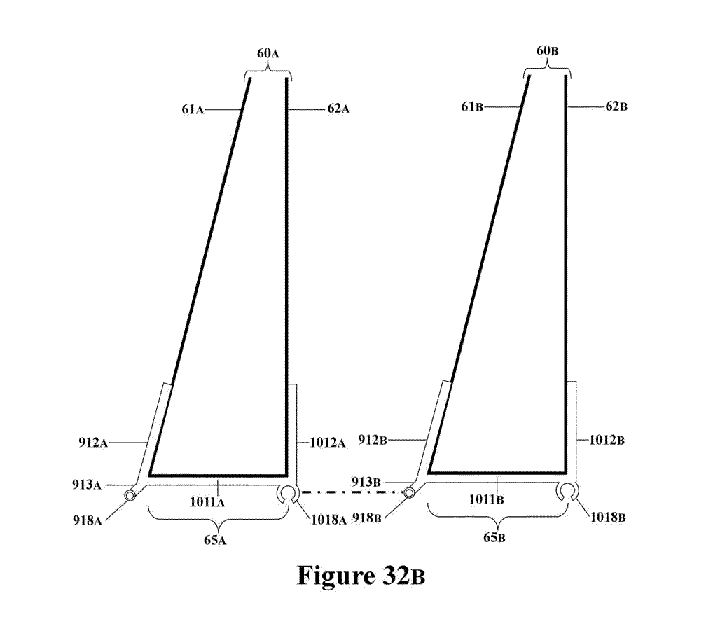

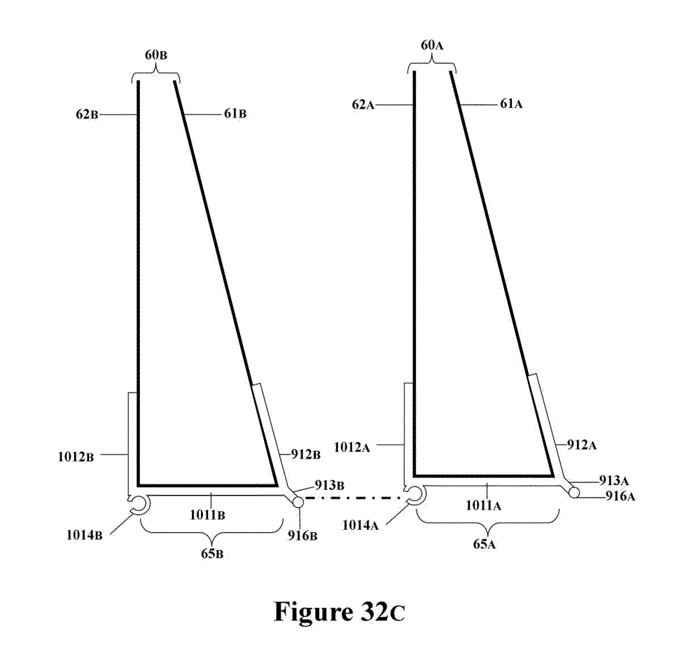

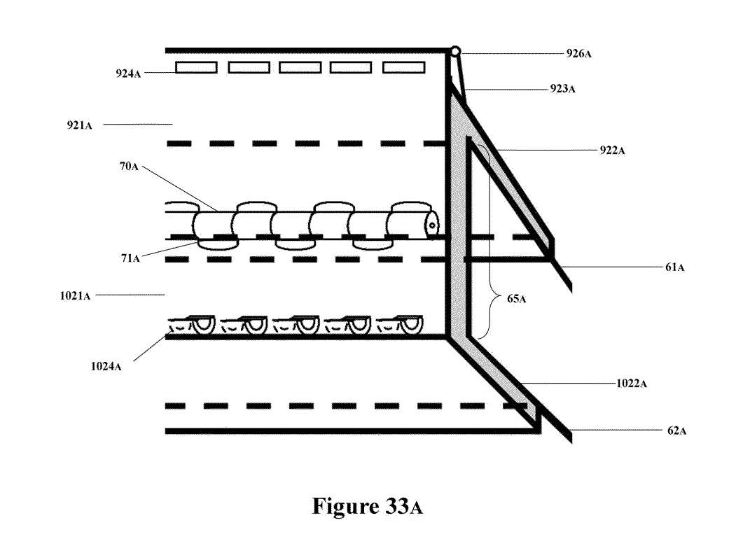

FIGS. 32A, 32B and 32C depict a hook-and-slot mechanism with stopper elements between unbound print members 60A and 60B, according to an exemplary embodiment of the present invention. In this embodiment, there is a three-walled tension support leg 1011A containing extended downward-facing hook elements 1014A along one edge of support leg 1011A and slot elements 914A within the curved protrusion element 913A along the opposite edge of support leg 911A. The geometry of these extended hook elements 1014A make an even more defined channel through which the slotted rail 913B can slide through, aiding in the ease of use and zip-like attachment technique. Unbound member 60A is inserted and/or slid through the support legs 912A and 1012A, creating a tension along the spine region 65A of unbound print member 60A. This tension non-permanently secures attachment member of unbound member 60A to 60A. Attachment member of unbound member 60B contains like attachment elements 913B, slot elements comparable to 914A, and hook elements comparable to 1014A and is secured in a like manner to unbound print member 60B. This arrangement of complimentary hooks and slots allows the unbound member 60A to attach to and be retained by unbound member 60B by inserting and/or sliding unique protruding element 913B into the complimentary unique hook elements 1014A until properly aligned to allow slot elements of unbound member 60B to mate with the hook elements 1014A. Stopper elements help align attachment members of unbound member 60B to those of unbound member 60A. A unique ball-like element 918B is located at an end of the curved protruding element 913B. This ball-like element is captured through a flexible but durable hook-like element 1018A, which is located along attachment member of unbound member 60A. Once in this position, stitch-bound members 60A and 60B can hinge open and closed, rotating upon the common axis created where hooked rail of unbound member 60A and slotted rail of unbound member 60B join together.

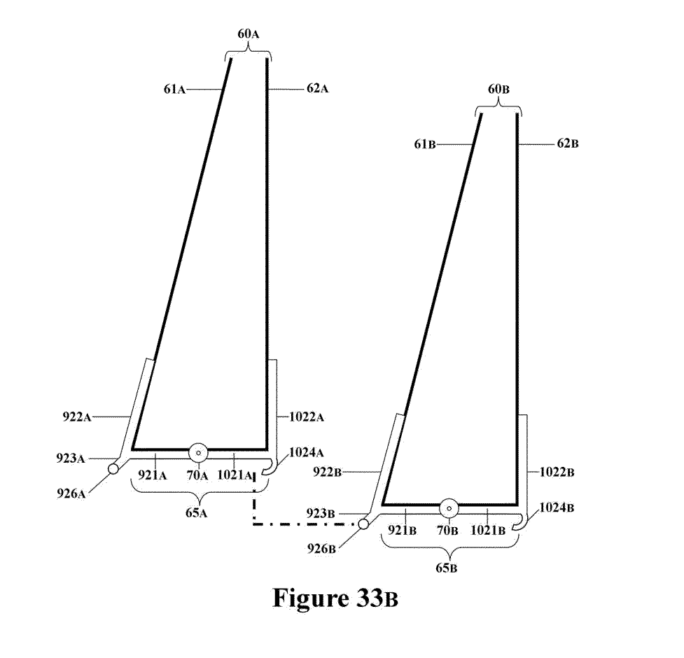

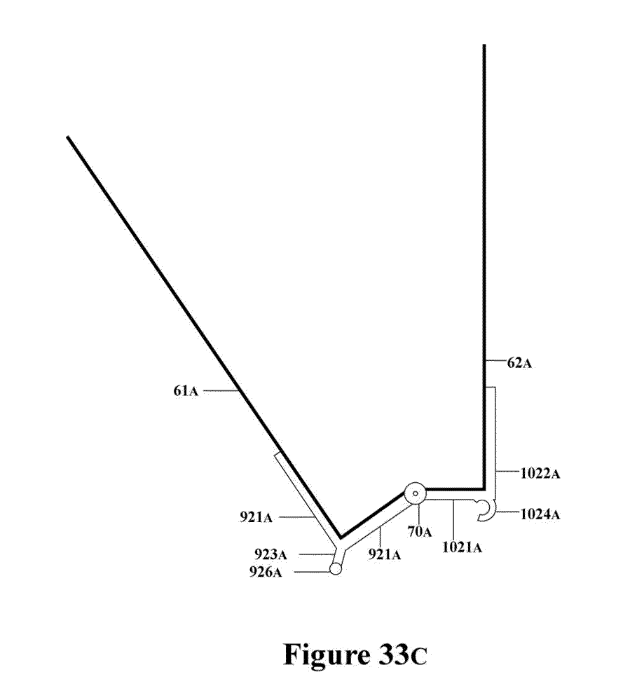

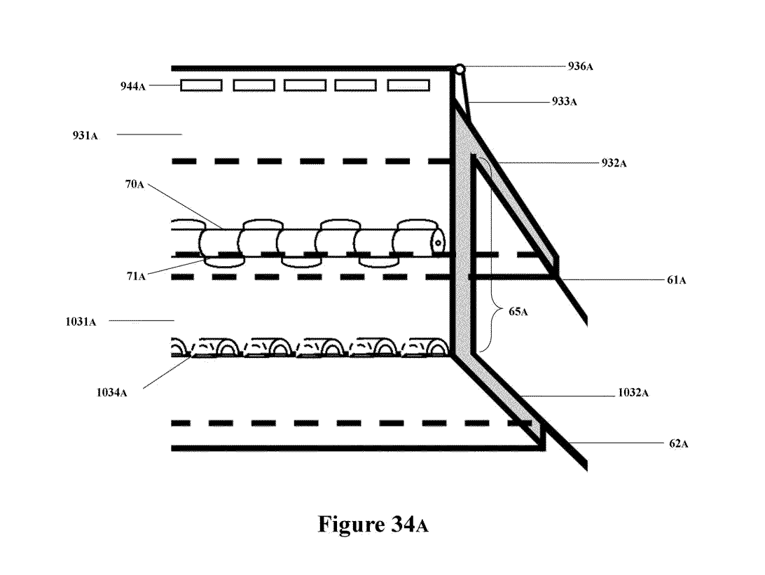

FIGS. 33A, 33B, and 33C depict an alternative hook-and-slot mechanism between unbound print members 60A and 60B, according to an exemplary embodiment of the present invention. In this embodiment, hinge 70A attaches to support legs 921A and 1021A via the hinge wings 71A. Support leg 1021A contains upward-facing hook elements 1024A. Support leg 921A contains complimentary slot elements 924A within the curved protrusion element 923A. Unbound member 60A is inserted and/or slid through the support legs 922A and 1022A, creating a tension along the spine region 65A of unbound print member 60A. This tension non-permanently secures attachment member of unbound member 60A to unbound member 60A. Alternatively, one can hinge support leg 922A to an angle that makes it easier to place spine region 65A of unbound print member 60A within the open area between support legs 922A and 1022A. Unbound print member 60B is secured in a like manner between hinging support legs 922B and 1022B. Support leg 922B contains attaching elements 923B, a slot element comparable to 924A, and support leg 1022B contains hook elements 1024B. This arrangement of complimentary hooks and slots allows the unbound member 60A to attach to and be retained by unbound member 60B by inserting and/or sliding unique protruding element 923B into the complimentary unique hook elements 1024A until properly aligned to allow slot elements of unbound member 60B to mate with the hook elements 1024A. Once in this position, stitch-bound members 60A and 60B can hinge open and closed, rotating upon the common axis created where hooked rail of unbound member 60A and slotted rail of unbound member 60B join together.

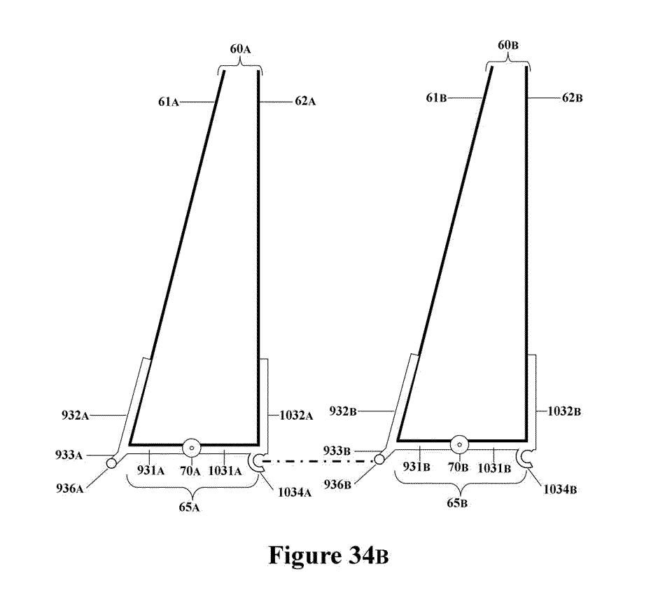

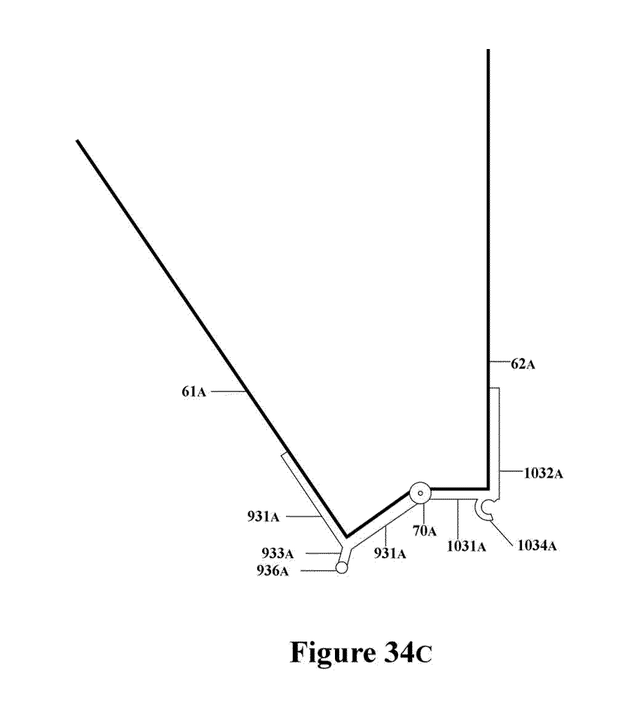

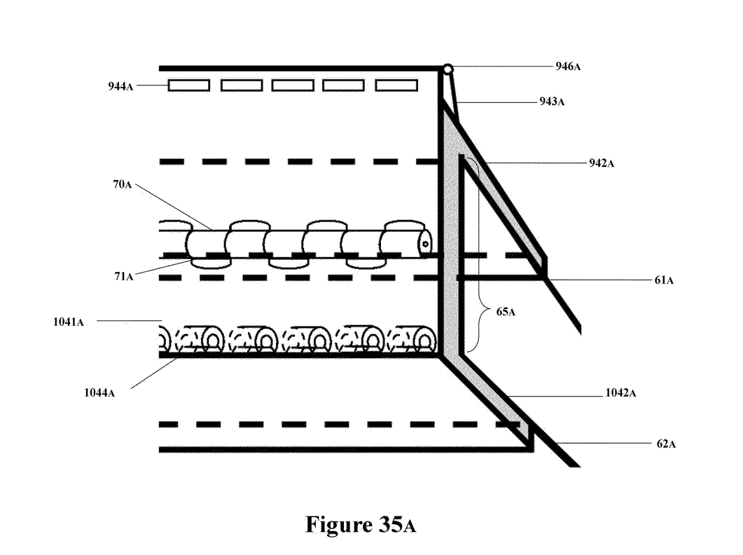

FIGS. 34A, 34B and 34C depict another hook-and-slot mechanism between unbound print members 60A and 60B, according to an exemplary embodiment of the present invention. In this embodiment, hinge 70A attaches to support legs 931A and 1031A via the hinge wings 71A. Support leg 1031A contains downward-facing hook elements 1034A. Support leg 931A contains complimentary slot elements 944A within the curved protrusion element 933A. Unbound member 60A is inserted and/or slid through the support legs 932A and 1032A, creating a tension along the spine region 65A of unbound print member 60A. This tension non-permanently secures attachment member of unbound member 60A to unbound member 60A. Alternatively, one can hinge support leg 932A to an angle that makes it easier to place spine region 65A of unbound print member 60A within the open area between support legs 932A and 1032A. Unbound print member 60B is secured in a like manner between hinging support legs 932B and 1032B. Support leg 932B contains attaching elements 933B, slot elements comparable to 944A, and support leg 1032B contains hook elements 1034B. This arrangement of complimentary hooks and slots allows the unbound member 60A to attach to and be retained by unbound member 60B by inserting and/or sliding unique protruding element 933B into the complimentary unique hook elements 1034A until properly aligned to allow slot elements of unbound member 60B to mate with the hook elements 1034A. Once in this position, stitch-bound members 60A and 60B can hinge open and closed, rotating upon the common axis created where hooked rail of unbound member 60A and slotted rail of unbound member 60B join together.

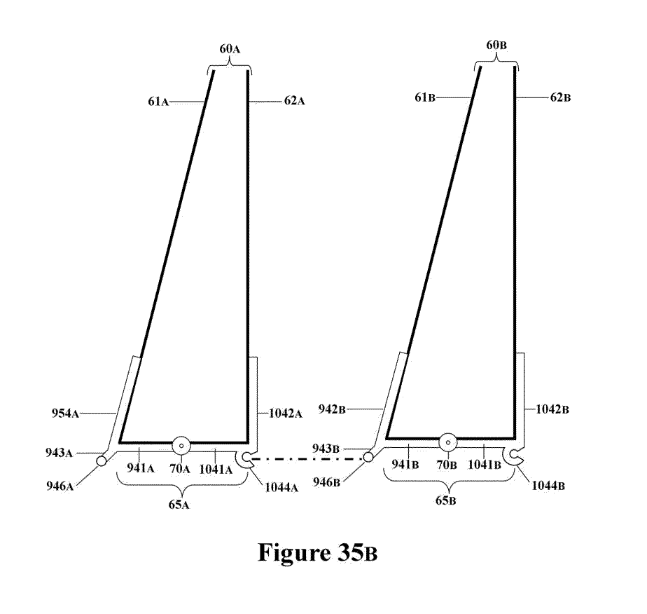

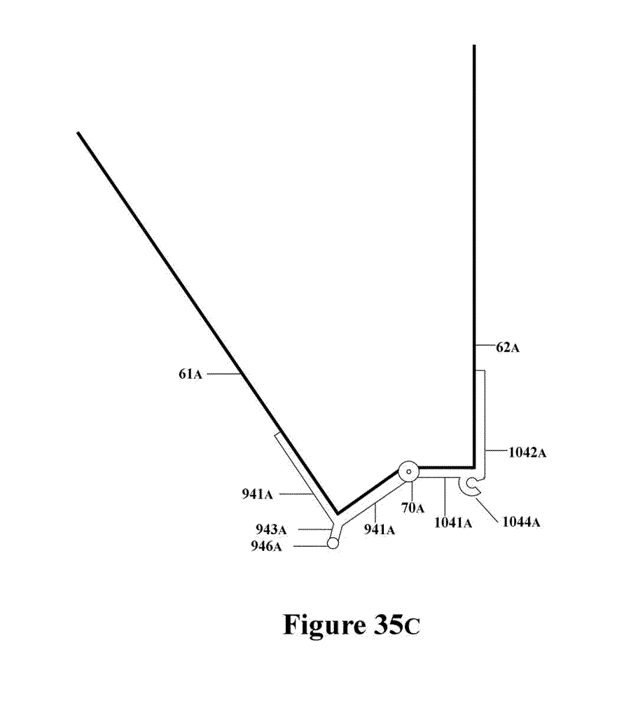

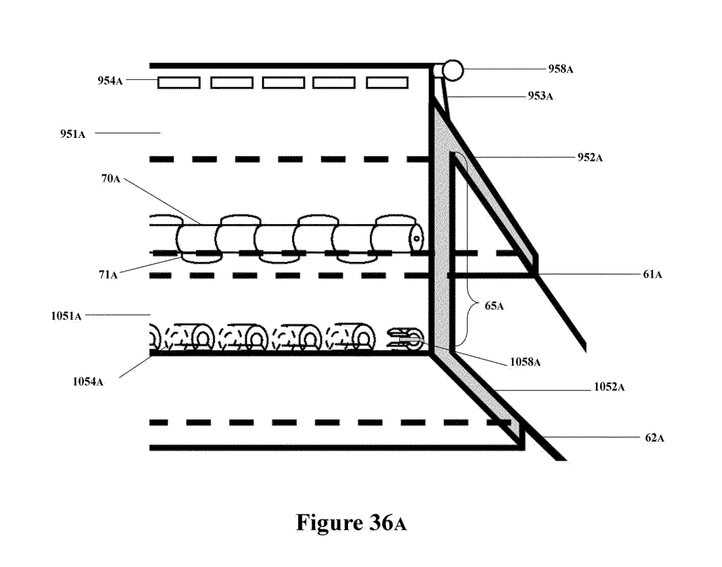

FIGS. 35A, 35B and 35C depict a different hook-and-slot mechanism between unbound print members 60A and 60B, according to an exemplary embodiment of the present invention. In this embodiment, hinge 70A attaches to support legs 941A and 1041A via the hinge wings 71A. Support leg 1041A contains extended and downward-facing hook elements 1044A. Support leg 941A contains complimentary slot elements 944A within the curved protrusion element 943A. The geometry of these extended hook elements 1044A make an even more defined channel through which the slotted rail 943B can slide through, aiding in the ease of use and zip-like attachment technique. Unbound member 60A is inserted and/or slid through the support legs 942A and 1042A, creating a tension along the spine region 65A of unbound print member 60A. This tension non-permanently secures attachment member of unbound member 60A to unbound member 60A. Alternatively, one can hinge support leg 942A to an angle that makes it easier to place spine region 65A of unbound print member 60A within the open area between support legs 942A and 1042A. Unbound print member 60B is secured in a like manner between hinging support legs 942B and 1042B. Support leg 942B contains attaching elements 943B, slot elements comparable to 944A, and support leg 1042B contains hook elements 1044B. This arrangement of complimentary hooks and slots allows the unbound member 60A to attach to and be retained by unbound member 60B by inserting and/or sliding unique protruding element 943B into the complimentary unique hook elements 1044A until properly aligned to allow slot elements of unbound member 60B to mate with the hook elements 1044A. Once in this position, stitch-bound members 60A and 60B can hinge open and closed, rotating upon the common axis created where hooked rail of unbound member 60A and slotted rail of unbound member 60B join together.

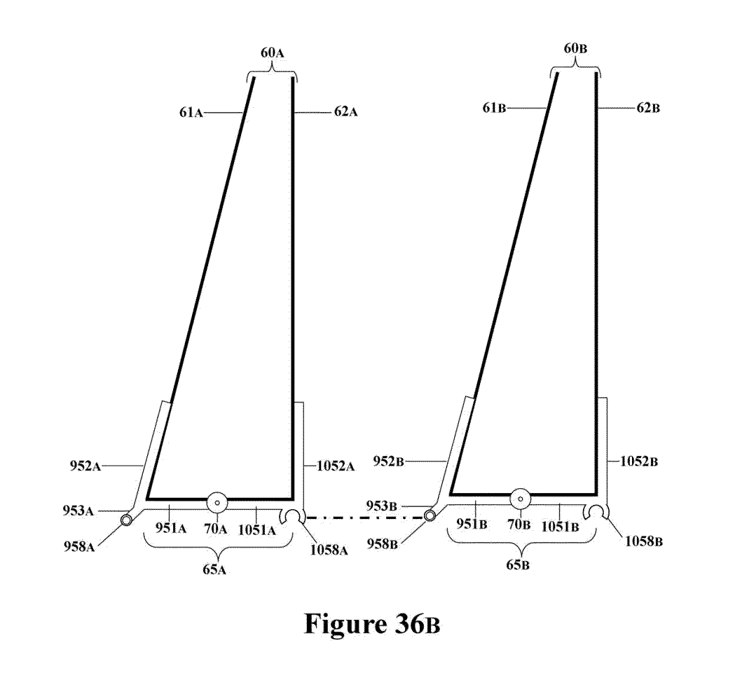

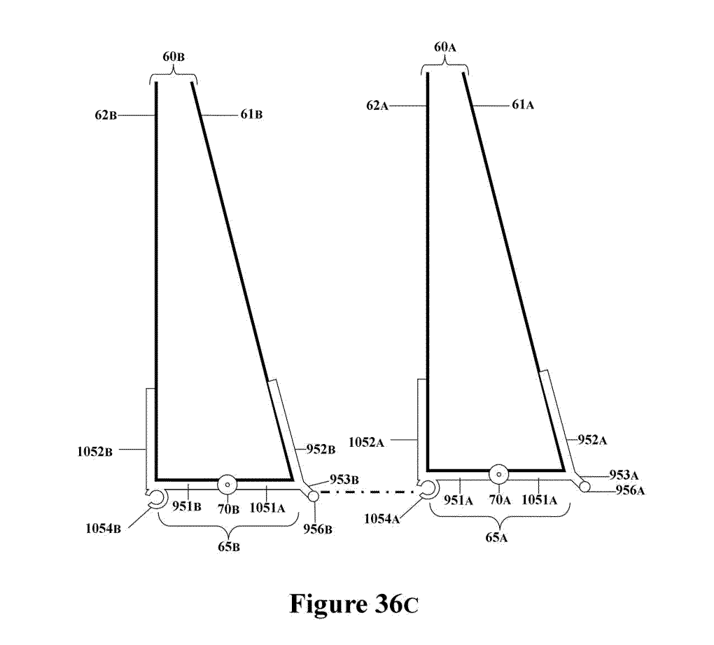

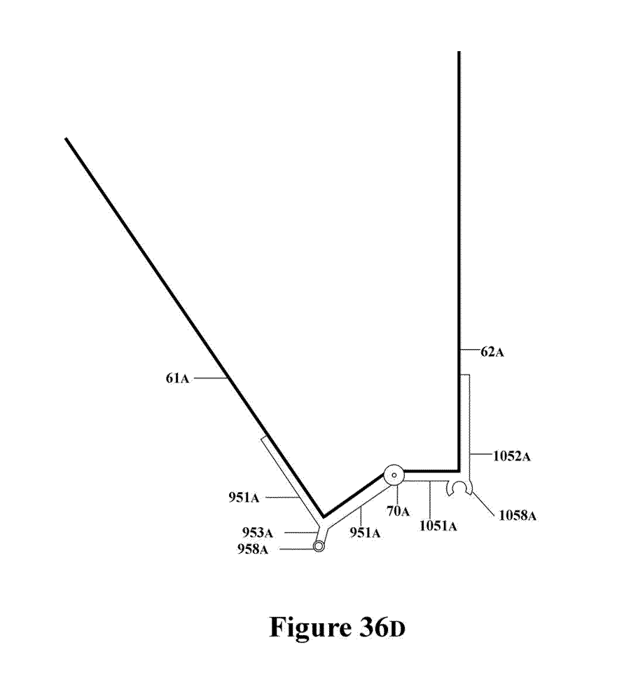

FIGS. 36A, 36B, 36C, and 36D depict a hook-and-slot mechanism with stopper elements between unbound print members 60A and 60B, according to an exemplary embodiment of the present invention. In this embodiment, hinge 70A attaches to support legs 951A and 1051A via the hinge wings 71A. Support leg 1051A contains extended and downward-facing hook elements 1054A. Support leg 951A contains complimentary slot elements 954A within the curved protrusion element 953A. The geometry of these extended hook elements 1054A make an even more defined channel through which the slotted rail 953B can slide through, aiding in the ease of use and zip-like attachment technique. Unbound member 60A is inserted and/or slid through the support legs 952A and 1052A, creating a tension along the spine region 65A of unbound print member 60A. This tension non-permanently secures attachment member of unbound member 60A to unbound member 60A. Alternatively, one can hinge support leg 952A to an angle that makes it easier to place spine region 65A of unbound print member 60A within the open area between support legs 952A and 1052A. Unbound print member 60B is secured in a like manner between hinging support legs 952B and 1052B. Support leg 952B contains attaching elements 953B, slot elements comparable to 954A, and support leg 1052B contains hook elements 1054B. This arrangement of complimentary hooks and slots will allow the unbound member 60A to unbound member 60B by inserting and/or sliding unique protruding element 953B into the complimentary unique hook elements 1054A until properly aligned to allow slot elements of unbound member 60B to mate with the hook elements 1054A. Stopper elements help align attachment members of unbound member 60B with those of unbound member 60A. A unique ball-like element 958B is located at an end of the curved protruding element 953B. This ball-like element is captured through a flexible but durable hook-like element 1058A, which is located along attachment member of unbound member 60A. Once in this position, stitch-bound members 60A and 60B can hinge open and closed, rotating upon the common axis created where hooked rail of unbound member 60A and slotted rail of unbound member 60B join together.

One of the many uses of the present invention is for books that are traditionally bulky and heavy, and which may require updates and additional versions to be reprinted in an effort to contain the most current information. Sections of the book may be republished with the most up-to-date material. Users of the book may also choose to separate sections of the text from the whole by detaching the sections from the book cover. The sections may be removed by sliding and/or pulling the individually-bound section members from another section member and/or book cover.

As previously mentioned in the present disclosure, variations in the above embodiments include a plurality of the adjoining members described for each embodiment. Each of the above mechanisms depicted in a unique drawing is merely exemplary of the invention as described herein and claimed within the scope of the present application.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for reversibly attaching a book, the system comprising:
a first module member including a first support leg, the first support leg including a plurality of hook elements;
a second module member including a second support leg, the second support leg including a plurality of slot elements;
wherein the first support leg is attached to the second support leg such that the plurality of hook elements mates with the plurality of slot elements so that the first module member hinges open and closed with respect to the second module member.

2. The system in claim 1, wherein each hook element and slot element is modularly detachable to adjust the height of each support leg.

3. The system in claim 1, wherein the first support leg includes a hook-like element at one or more of a first and second end of the first support leg.

4. The system in claim 3, wherein the second support leg includes a ball-like element at one or more of a first and second end of the second support leg.

5. The system in claim 1, wherein the first and second module members each have the first and second support leg allowing attachment to more module members.

6. The system in claim 5, wherein the first and second support legs of each module member are connected by a third support leg.

7. The system in claim 1, further comprising a book cover including a cover support leg, the cover support leg including a plurality of one of hook and slot elements.

8. The system in claim 1, further comprising a booklet member including
a booklet support leg along the exterior of the booklet member, the booklet support leg including a plurality of one of hook and slot elements, and
a rod element along the interior of the booklet member, the rod element hinged at a first end of the booklet support leg and removably attachable to the second end of the booklet support leg.

9. A reversibly attachable book comprising:
a book cover having a spine and a cover support leg along the interior of the spine, the cover support leg including a plurality of one of hook and slot elements;
a first module member having a first support leg along the exterior of the first module member, the first support leg including a plurality of hook elements on a first side and a plurality of slot elements one a second side;
wherein the book cover reversibly attaches to the first module member such that one of the plurality of hook elements of the cover support leg mates with the plurality of slot elements on the second side of the first support leg, and the plurality of slot elements of the cover support leg mates with the plurality of hook elements on the first side of the section support leg.

10. The book in claim 9, wherein each hook element and slot element is modularly detachable to adjust the height of each support leg.

11. The book in claim 9, wherein the first support leg includes a hook-like element at one or more of a first and second ends of the first support leg.

12. The book in claim 11, wherein the cover support leg includes a ball-like element at one or more of a first and second ends of the cover support leg.

13. The book in claim 9, further comprising a second module member having a second support leg along the exterior of the second module member, the second support leg including a plurality of hook elements on a first side and a plurality of slot element one a second side.

14. The book in claim 9, further comprising a booklet member including
a booklet support leg along the exterior of the booklet member, the booklet support leg including a plurality of one of hook and slot elements, and
a rod element along the interior of the booklet member, the rod element hinged at a first end of the booklet support leg and removably attachable to the second end of the booklet support leg.

15. A method of reversibly attaching a book, the method comprising:
attaching a first module member to a second module member, the first module member including a first support leg, the first support leg including a plurality of hook elements, the second module member including a second support leg, the second support leg including a plurality of slot elements;
wherein the first support leg is attached to the second support leg such that the plurality of hook elements mates with the plurality of slot elements so that the first module member hinges open and closed with respect to the second module member.

16. The method in claim 15, further comprising attaching a book cover to one of the first and second module members, the book cover including a cover support leg, the cover support leg including a plurality of one or more of hook and slot elements.

17. The method in claim 15, further comprising attaching a booklet member to one of the first module member, the second module member, and the cover, the booklet member including
a booklet support leg along the exterior of the booklet member, the booklet support leg including a plurality of one of hook and slot elements, and
a rod element along the interior of the booklet member, the rod element hinged at a first end of the booklet support leg and removably attachable to the second end of the booklet support leg.

18. The method in claim 15, further comprising detaching the first module member from the second module member.

19. The method in claim 15, wherein the attaching further includes inserting a ball-like element at one or more of a first and second ends of the second support leg into a hook-like element at one of a first and second ends of the first support leg.

20. The method in claim 15, further comprising adjusting the height of each support leg by one of adding and removing an individual modular hook and slot element.
